(19) United States
(12) Patent Application Publication
(10) Pub. No.: US 2025/0351194 A1
(43) Pub. Date: Nov. 13, 2025

(54) Random Access for Internet-of-Thing Devices

(71) Applicant: Ofinno, LLC, Reston, VA (US)

(72) Inventors: Hyoungsuk Jeon, Centreville, VA (US); Ryan Keating, Chicago, IL (US); Esmael Hejazi Dinan, McLean, VA (US); Hua Zhou, Vienna, VA (US); Ali Cagatay Cirik, Chantilly, VA (US); Taehun Kim, Fairfax, VA (US); Hsin-Hsi Tsai, Reston, VA (US); Kyungmin Park, Vienna, VA (US); Gautham Prasad, Herndon, VA (US); SungDuck Chun, Fairfax, VA (US); Muhammad Ali Kazmi, Reston, VA (US)

(21) Appl. No.: 19/203,076

(22) Filed: May 8, 2025

Related U.S. Application Data
(60) Provisional application No. 63/645,077, filed on May 9, 2024.

(51) Int. Cl. H04W 74/0836; H04B 17/318

(52) U.S. Cl. CPC H04W 74/0836; H04B 17/318

(57) ABSTRACT

A wireless device receives, from a reader, a first message comprising one or more fields indicating: a first frequency associated with a first type of inventory procedure, and a second frequency associated with a second type of inventory procedure. The wireless device selects, based on a received signal strength of the first message, the first type of inventory procedure among the first type of inventory procedure and the second type of inventory procedure. The wireless device transmits, via the first frequency associated with the first type of inventory procedure, a second message comprising an identifier of the wireless device.

### CROSS-REFERENCE TO RELATED APPLICATIONS

This application claims the benefit of U.S. Provisional Application No. 63/645,077, filed May 9, 2024, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an aspect of an example embodiment according to the present disclosure.

FIG. 18 illustrates an aspect of an example embodiment according to the present disclosure.

FIG. 19 illustrates an aspect of an example embodiment according to the present disclosure.

FIG. 20 illustrates an aspect of an example embodiment according to the present disclosure.

FIG. 21A, FIG. 21B, FIG. 21C, FIG. 21D, and FIG. 21E illustrate aspects of example embodiments according to the present disclosure.

FIG. 22 illustrates an aspect of an example embodiment according to the present disclosure.

FIG. 23 illustrates an aspect of an example embodiment according to the present disclosure.

FIG. 24 illustrates an aspect of an example embodiment according to the present disclosure.

FIG. 25 illustrates an aspect of an example embodiment according to the present disclosure.

FIG. 26 illustrates an aspect of an example embodiment according to the present disclosure.

FIG. 27 illustrates an aspect of an example embodiment according to the present disclosure.

FIG. 28 illustrates an aspect of an example embodiment according to the present disclosure.

FIG. 29 illustrates an aspect of an example embodiment according to the present disclosure.

FIG. 30 illustrates an aspect of an example embodiment according to the present disclosure.

FIG. 31 illustrates an aspect of an example embodiment according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

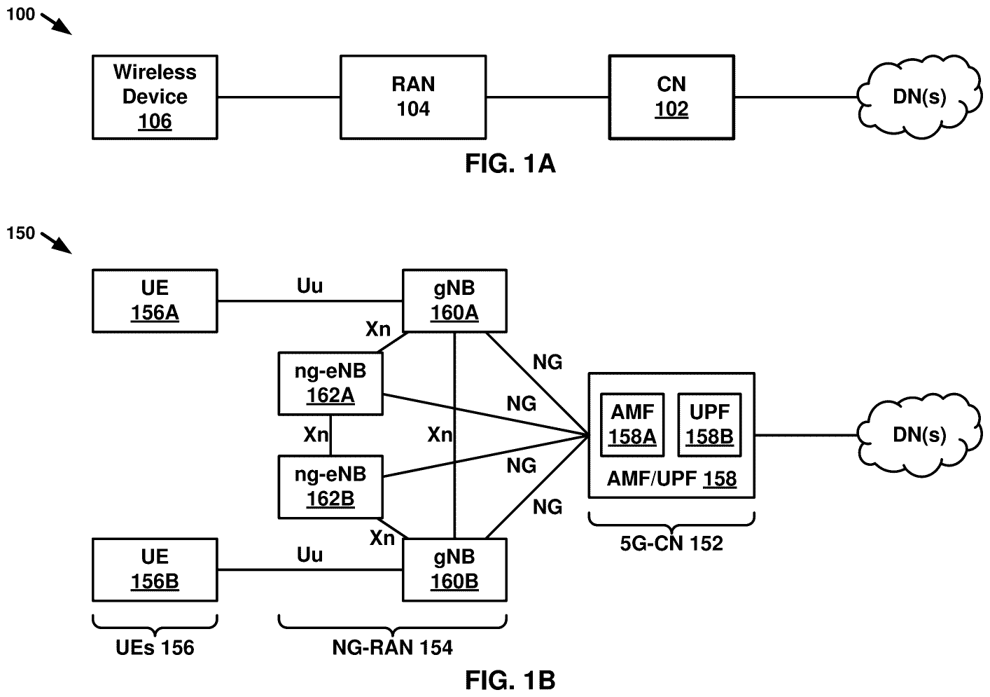

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QOS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

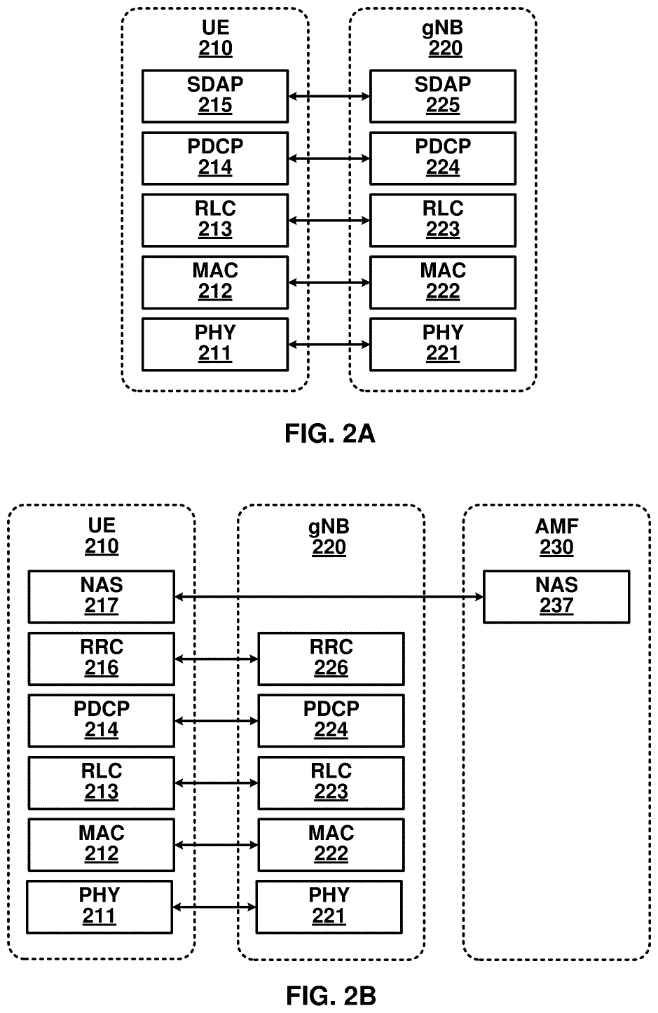

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

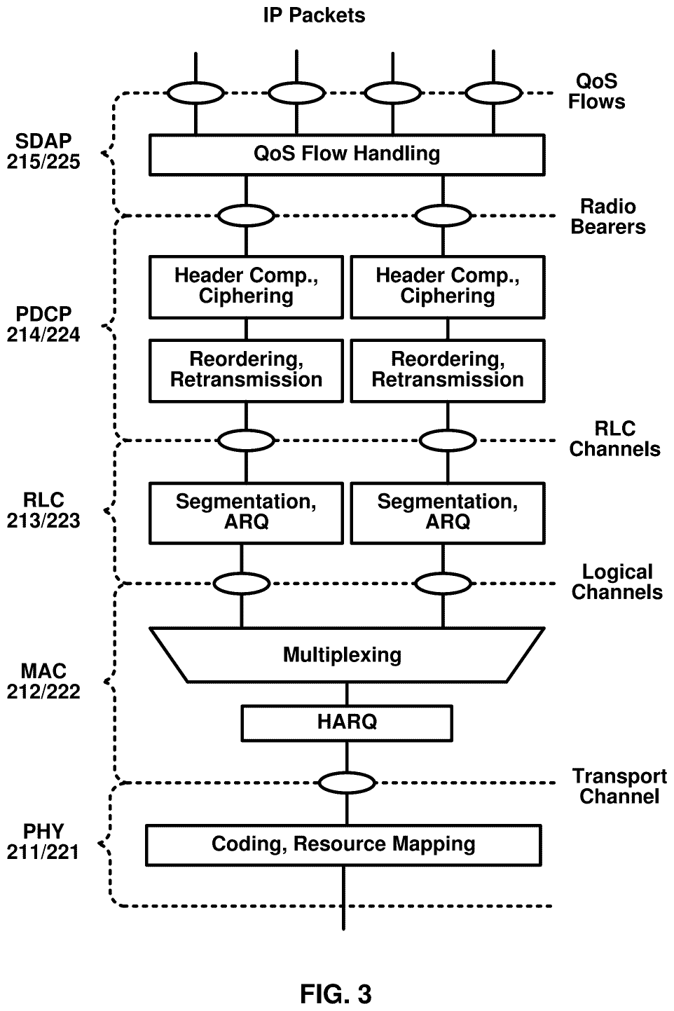

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

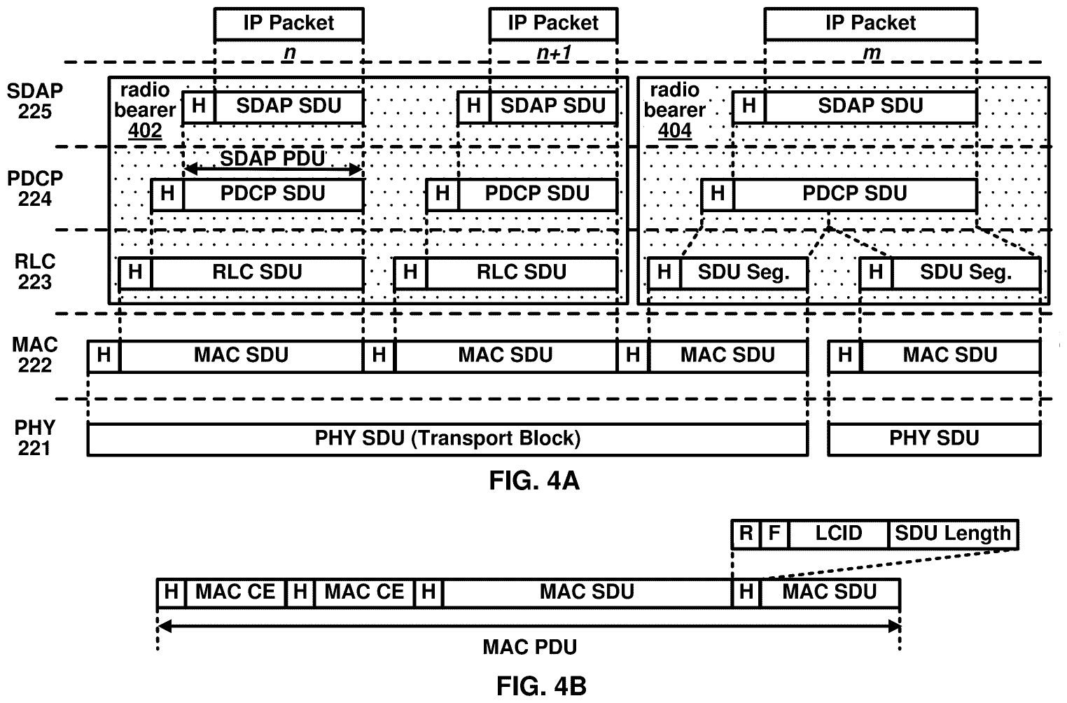

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 212 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

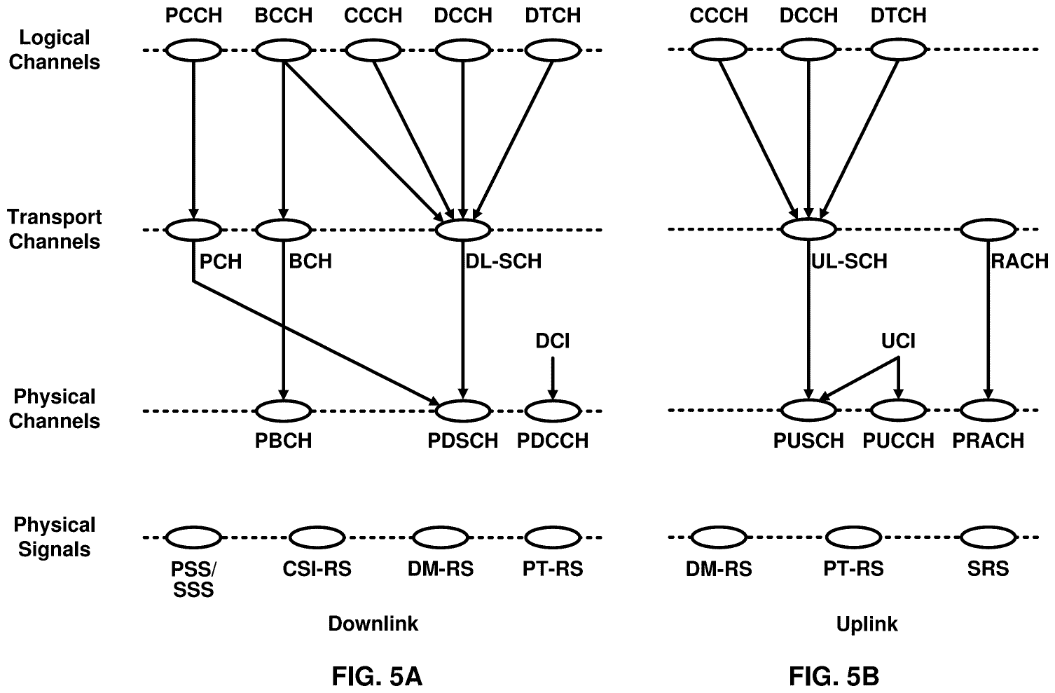

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

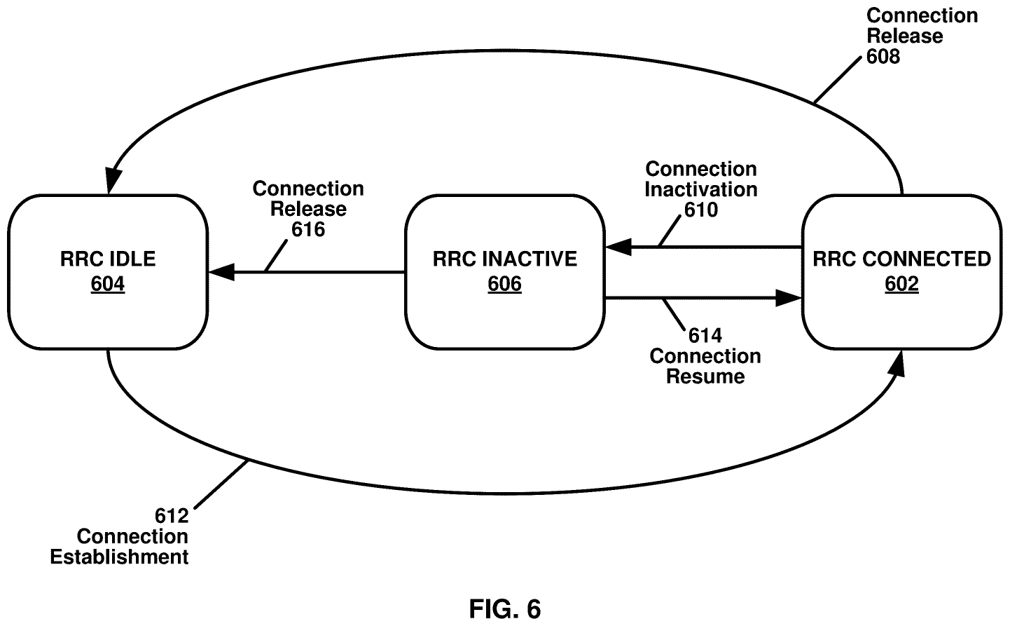

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

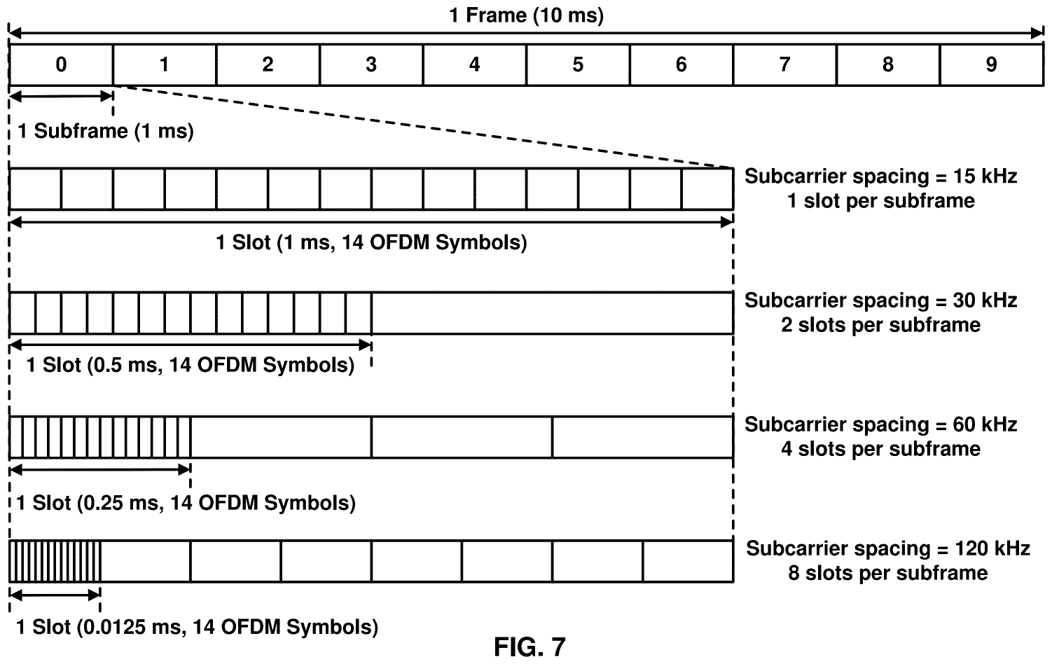

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHZ up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 KHz/4.7 μs; 30 KHz/2.3 μs; 60 KHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

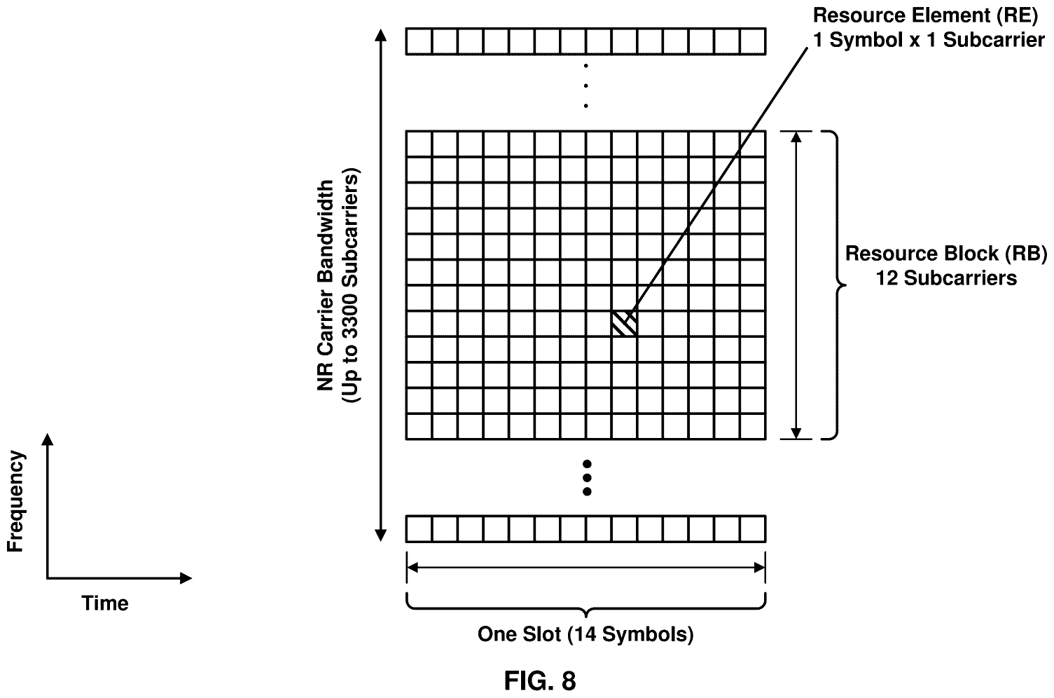

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

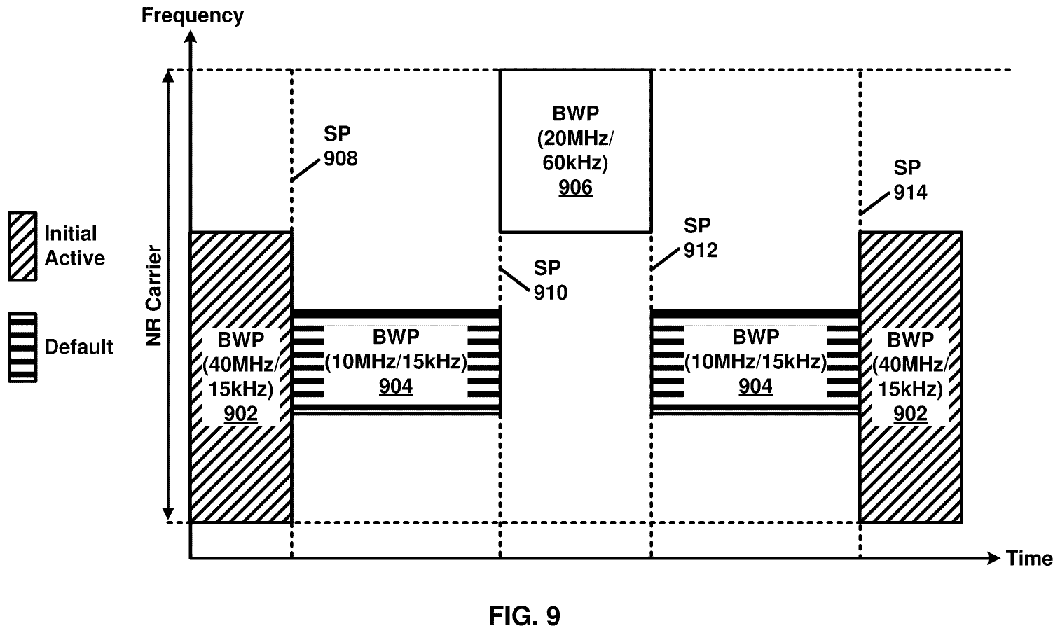

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

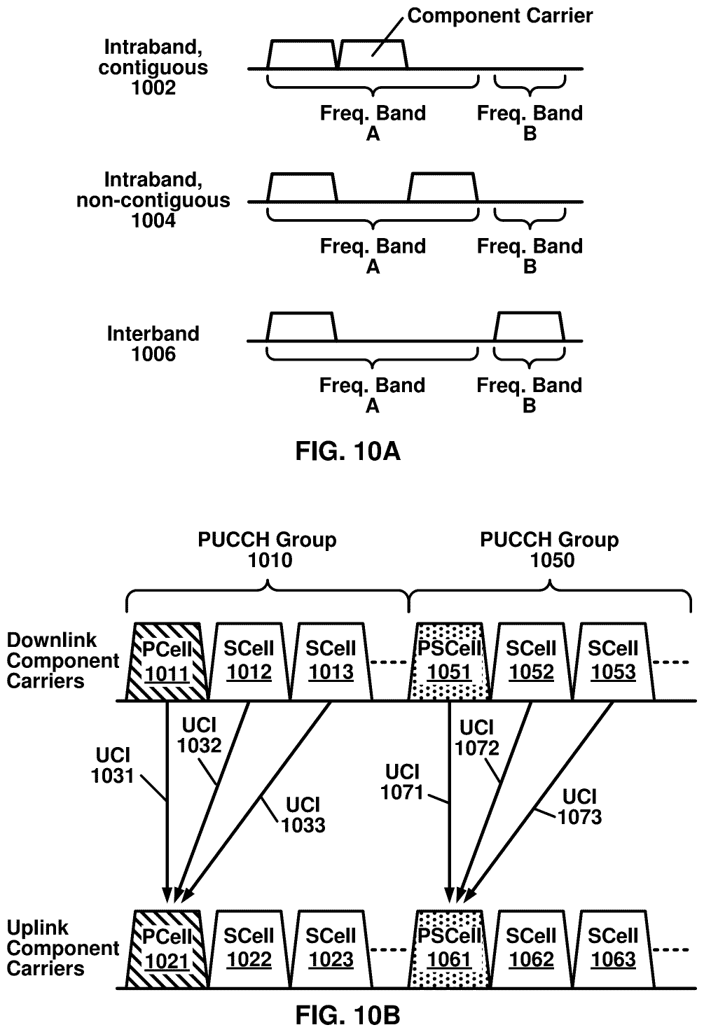

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

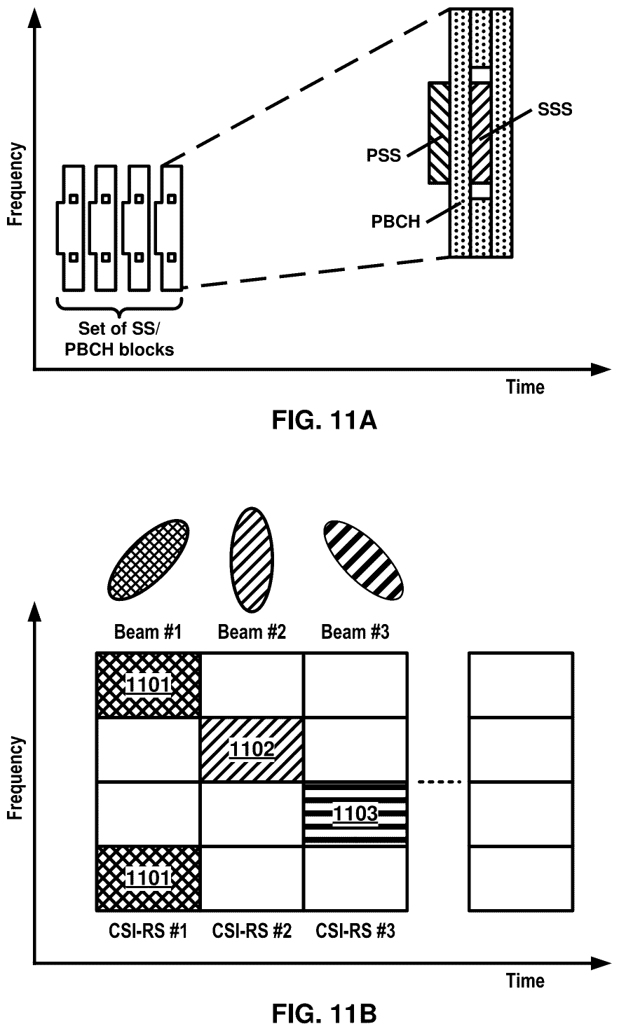

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

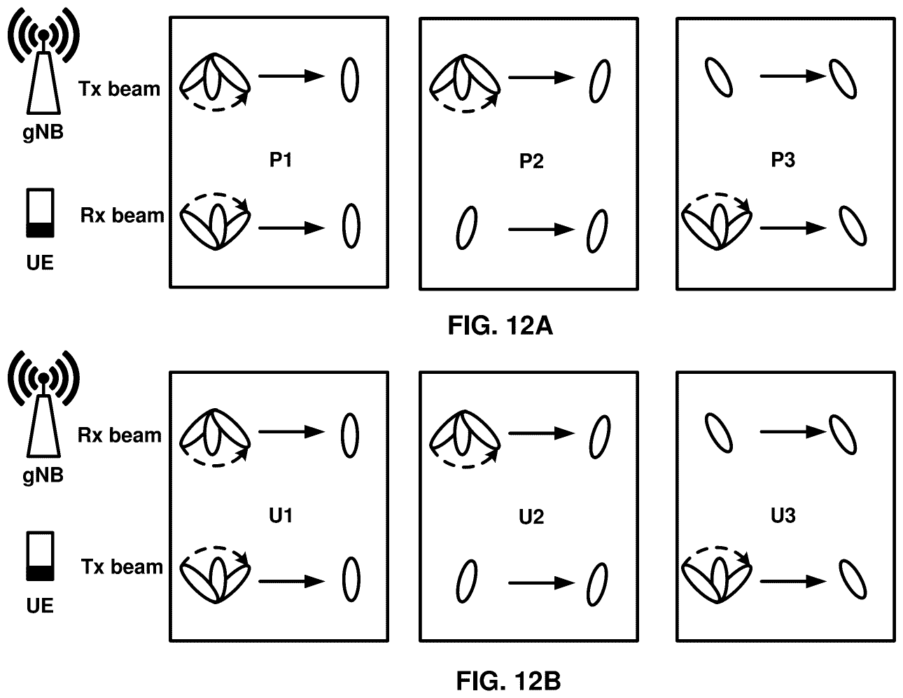

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

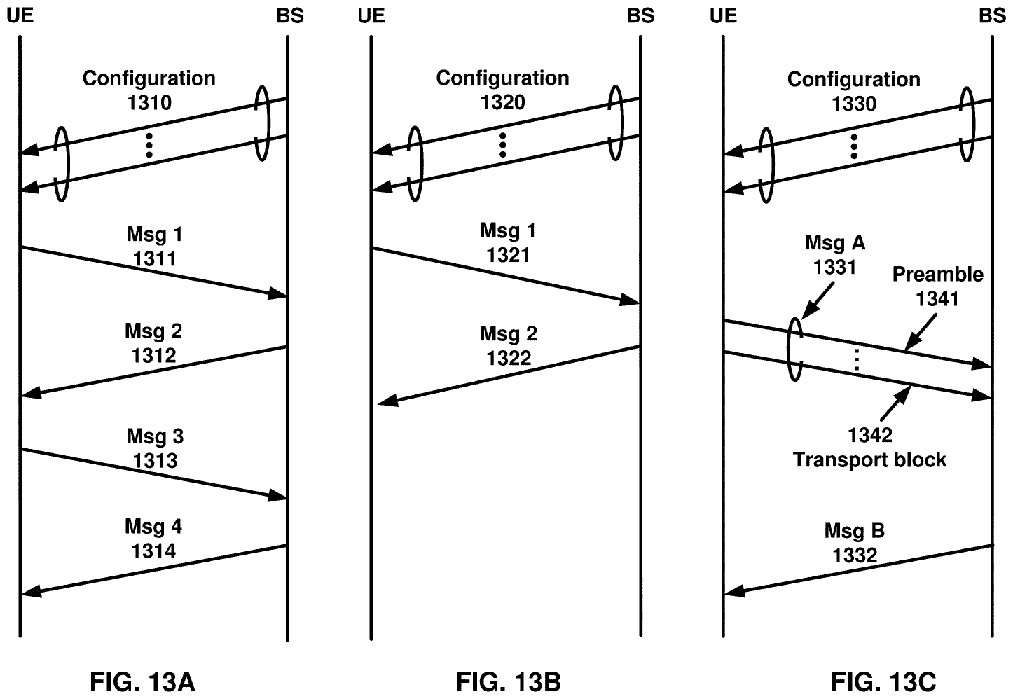

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80× f_id+14× 80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

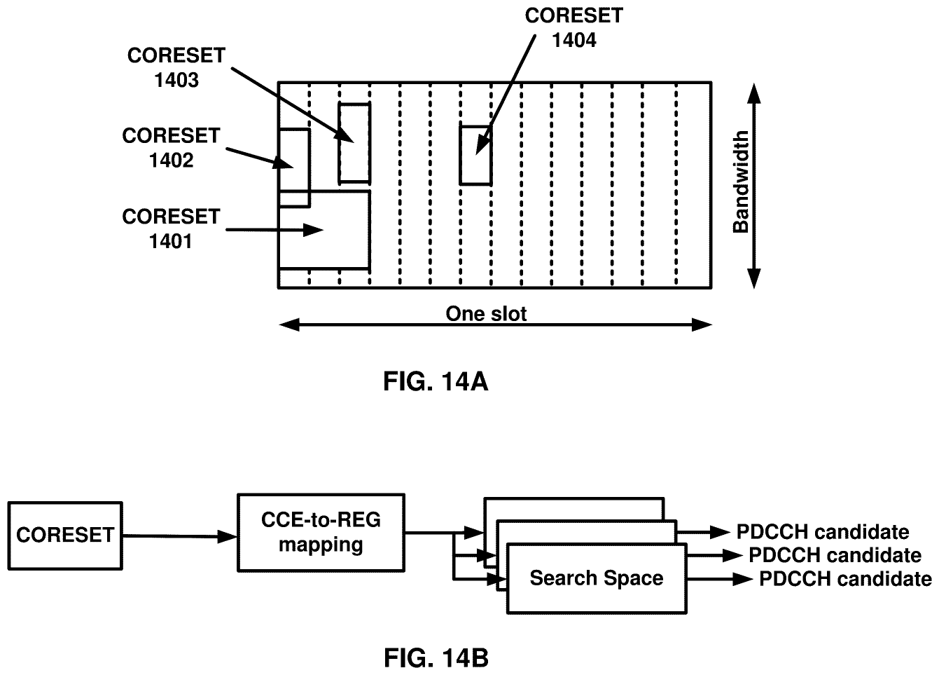

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

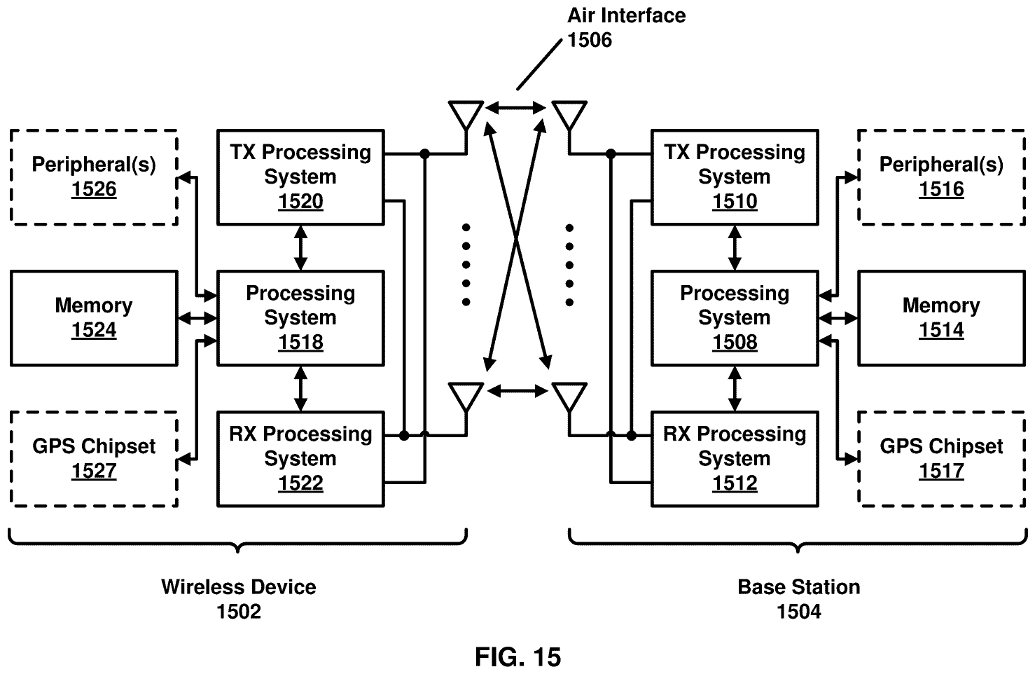

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 maybe associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

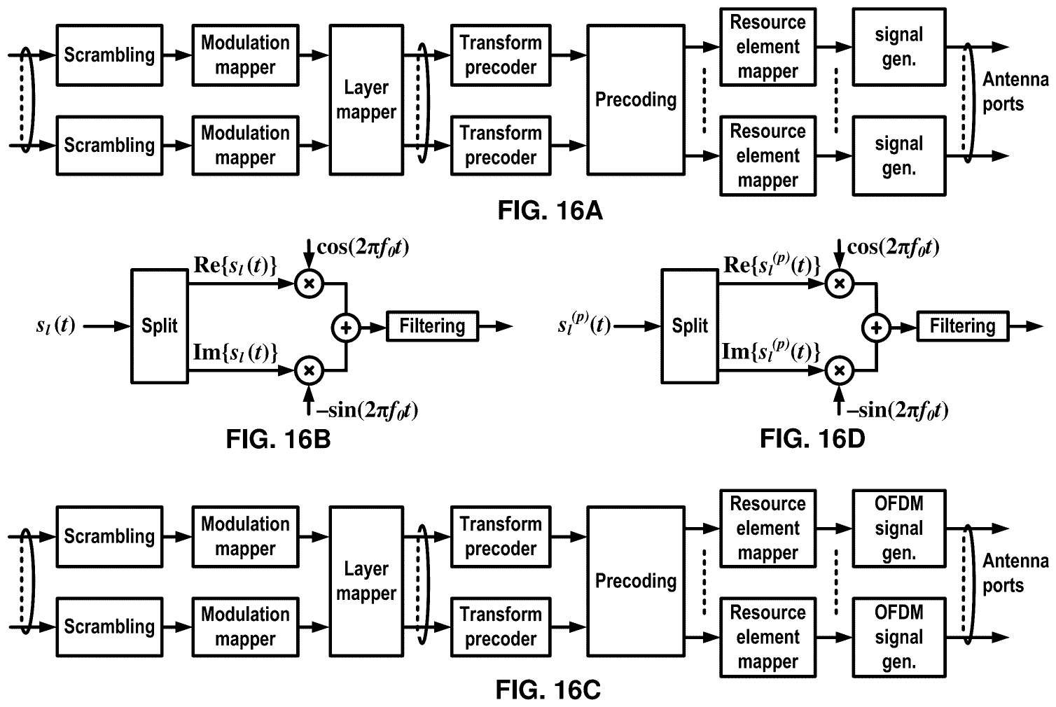

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

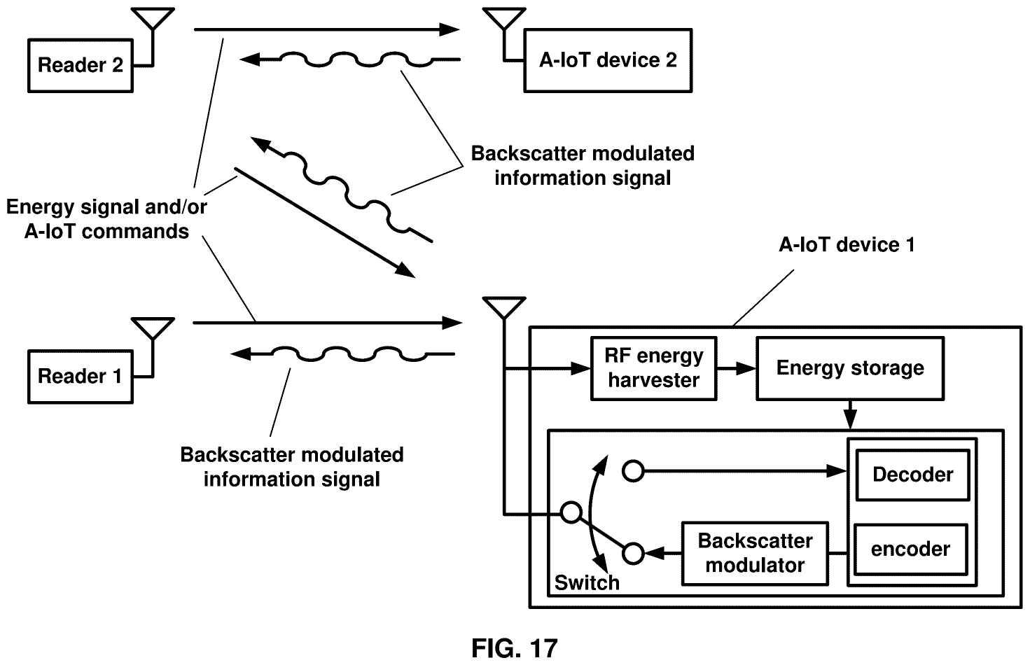

FIG. 17 illustrates an example of ambient internet-of-thing (A-IoT) communications as per an aspect of an embodiment of the present disclosure. The A-IoT communications may comprise communication(s) between a reader and an A-IoT device.

The reader may comprise a base station (RAN 104 in FIG. 1A, gNB 160A in FIG. 1B, and/or gNB 160B in FIG. 1B). The reader may comprise a wireless device (e.g., Wireless device 106 in FIG. 1A, UE 156A in FIG. 1B, and/or UE 156B in FIG. 1B).

An A-IoT device may refer to a device (e.g., wireless device) and/or a thing with sensors, processing ability, software and other technologies that connect and exchange data with other devices and systems (e.g., reader) over communications networks (e.g., RAN 104, CN 102). An A-IoT device may be low-cost and self-powered device.

An A-IoT device may be referred to as an ambient intelligence device, an ambient power-enabled IoT device, an ambient computing device, and/or the like. The A-IoT device may comprise a hardware, e.g., a sensor, actuator, gadget, appliance, or machine, that may be programmed for certain applications. The A-IoT device may be a smart watch, smart eyewear, smart refrigerator, smart door lock, and so on. The A-IoT device may be battery-free based on energy harvested from ambient sources.

In the A-IoT communications, multiple readers may communicate with one or more A-IoT devices. For example, in FIG. 17, Reader 1 and Reader 2 communicate with A-IoT device 1. In the A-IoT communications, a reader may communicate with one or more A-IoT devices. For example, in FIG. 17, Reader 2 communicates with A-IoT device 1 and A-IoT device 2.

A communication channel from a reader to an A-IoT device may be referred to as a reader-to-device channel (e.g., R2D channel), A-IoT downlink channel, a sidelink channel from a reader to an A-IoT device, a R2D sidelink channel, and/or the like. In the present disclosure, for a sake of simplicity, a communication channel from a reader to an A-IoT device may be referred to as a reader-to-device channel and/or an R2D channel.

A communication channel from an A-IoT device to a reader may be referred to as a device-to-reader channel (e.g., D2R channel), A-IoT uplink channel, a sidelink channel from an A-IoT device to a reader, a D2R channel, and/or the like. In the present disclosure, for a sake of simplicity, a communication channel from an A-IoT device to a reader may be referred to as a device-to-reader channel and/or a D2R channel.

An A-IoT device may refer to a device primarily or substantially powered by harvesting energy from one or more viable ambient IoT energy sources. The A-IoT device may be battery-less or with limited energy storage capability (e.g., using a capacitor). The one or more viable ambient IoT energy sources may comprise radio waves (e.g., radio frequency (RF) wave). The one or more viable ambient IoT energy sources may comprise light, motion, heat, or any other suitable power sources.

An A-IoT device may harvest the energy from radio waves. The A-IoT device may receive, from a reader or energy source (e.g., RF emitter), a radio wave (e.g., carrier wave). The A-IoT device may harvest an energy from the radio wave. The A-IoT device may store the harvested energy in an energy storage. The A-IoT device may use the harvested energy for transmitting a signal to the reader via D2R channel(s). For example, the A-IoT device may transmit, to the reader, a reflected (e.g., backscatter) signal using the power converted from the harvested energy.

An A-IoT device may employ, use, transmit, trigger, initiate, and/or perform a transmission of a backscatter signal. The backscatter signal or backscatter transmission may be referred to as ambient backscatter, bistatic communication, and/or the like. Transmitting a backscatter signal may comprise reflecting, by the A-IoT device, waves, particles, or signals back in the direction from which they were detected. The backscatter signal may be a backscatter (or backscattered) information signal and/or a backscatter (or backscattered) modulated information signal. For example, the A-IoT device may modify and/or reflect the received signal with encoded data by using the power converted from the harvested energy. The encoded data may include a response to a command. Antennas on other devices (e.g., a reader) may, in turn, detect the signal reflected by the A-IoT device.

In an example, the backscatter may be a method of communication in which an A-IoT device without a battery (or without any internal power source) receives energy from a reader's (e.g., RF emitter's) transmission and uses at least a portion of the received energy to send back a reply. The A-IoT device may receive the energy via electromagnetic waves propagated from the reader/antenna. Once the waves reach the A-IoT device, the energy may travel through the A-IoT device's internal antenna, and activates the chip, or integrated circuit (IC). The remaining energy may be modulated with the chip's data and flows back via the A-IoT device's antenna to the reader's antenna in the form of electromagnetic waves.

Harvesting an energy from radio (e.g., RF) wave may be used for data decoding, signal filtering operation, data reception, data encoding, and/or data transmission. A purpose of harvesting the energy may be to energize the A-IoT device and/or to charge a battery of the A-IoT device. The A-IoT device may perform the one or more tasks using the harvested energy. The A-IoT device may the one or more tasks based at least in part on an accumulation of harvested energy over a period of time.

The harvested energy may be derived from a radio wave (e.g., RF signals) transmitted by a network (e.g., base station) and/or by a wireless device (e.g., UE) connected to the network. The A-IoT device may communicate with the network using the harvested energy. For example, RF energy harvesting may lead to a longer battery lifespan of the A-IoT device with a battery. RF energy harvesting may lead to a battery-less IoT device, such as a medical sensor or an implanted sensor.

An amount of energy that the A-IoT device harvests from the radio wave may depend on one or more parameters. For example, the one or more parameters comprise a frequency of the radio wave and a distance traveled by the radio wave. For example, the one or more parameters comprise a transmission power of the radio wave. For example, the one or more parameters comprise a received power (e.g., received signal strength, RSRP, and/or the like) of the radio wave. The signal source of the radio wave may be a network entity (or node) such as a base station (e.g., RAN 104) in FIG. 1A (and/or gNB 160A, gNB 160B, ng-eNB 162A, ng-eNB 162B, and/or NG-RAN 154 in FIG. 1B) and/or another device, such as a wireless device connected to the wireless device 106 in FIG. 1A (and/or UE 156A, UE 156B in FIG. 1B).

The A-IoT device may perform the energy harvesting from various energy sources, such as solar, vibration, thermal, laser or light, and/or RF. Energy harvesting from a solar source may use photovoltaic cells, may provide a relatively high power density, and/or may require exposure to light (not implantable). Energy harvesting from a vibration source may use piezoelectric, electrostatic, and/or electromagnetic techniques. Energy harvesting from a vibration source may be implantable and/or may suffer from material physical limitations. Energy harvesting from a thermal source may use thermoelectric or pyroelectric techniques. Energy harvesting from a thermal source may provide a relatively high power density. Energy harvesting from a thermal source may be implantable, and/or may produce excess heat. Energy harvesting from RF (a radio wave) may use an antenna may be implantable. Energy harvesting from RF (a radio wave) may provide a relatively low power density where an efficiency is inversely proportional to a distance.

Referring to FIG. 17, a transmitter of an energy signal may transmit, to an A-IoT device, an energy signal to energize the A-IoT device. The transmitter may be a reader. For example, the reader comprises the transmitter. The transmitter may not be a reader. The transmitter may be a network entity or node deployed separately from the reader. The energy signal may be a continuous waveform and/or continuous wave. The energy signal may be an unmodulated signal. The reader may transmit, to an A-IoT device, one or more A-IoT commands. For example, the transmitter may transmit the energy signal prior to the one or more A-IoT commands. For example, a channel via which the transmitter transmits the energy signal may be referred to as a CW-to-Device (CW2D) channel. For example, a channel via which the transmitter transmits the energy signal may be a R2D channel. For example, the R2D channel may comprise the CW2D channel. For example, the CW2D channel may comprise the R2D channel.

Referring to FIG. 17, an A-IoT device may receive, from a reader and via CW2D channel, an energy signal. The A-IoT device may comprise an RF energy harvester. For example, the RF energy harvester may comprise a rectifier performing RF signal alternating current (AC) to direct current (DC) conversion. The A-IoT device may comprise an energy storage (e.g., capacitor). The energy storage may store harvested energy from the RF energy harvester. The A-IoT device may supply the harvested energy to active component blocks (e.g., decoder, encoder, backscatter modulator, and/or the like) of the A-IoT device.

Referring to FIG. 17, an A-IoT device may receive, from the reader and via R2D channel, one or more A-IoT commands. The A-IoT device may transmit, to the reader and via D2R channel, a backscatter modulated information signal using the transmit power determined based on the amount of harvested energy. The backscatter modulated information signal may comprise one or more responses respective to the one or more A-IoT commands. The backscatter modulated information signal may be referred to as a backscatter signal, a backscattering signal, and/or the like.

The A-IoT device may comprise an antenna shared for the RF energy harvester and receiver/transmitter. The A-IoT device may comprise at least one first antenna and/or at least one second antenna. The at least one first antenna may be dedicated for the RF energy harvester. The at least one second antenna may be dedicated for receiver to receiving the energy signal and/or A-IoT commands. The at least one second antenna may be dedicated for transmitter to transit the backscatter modulated information signal.

An A-IoT device may be categorized based on its capability of energy storage, a transmitting signal generation, and/or amplification of transmitting signal.

For example, an A-IoT device may be referred to as Device 1 (or Device A). The A-IoT device categorized as Device 1 may have (or support) peak power consumption less than or equal to 1 μW peak power consumption. The A-IoT device categorized as Device 1 may have energy storage. The A-IoT device categorized as Device 1 may have initial sampling frequency offset (SFO) up to 10^{X} ppm. The A-IoT device categorized as Device 1 may have neither DL nor UL amplification in the device. The UL transmission of the A-IoT device categorized as Device 1 may be backscattered on a carrier wave provided externally.

For example, an A-IoT device may be referred to as Device 2a (or Device B). The A-IoT device categorized as Device 2a may have (or support) peak power consumption less than or equal to a few hundred μW peak power consumption. The A-IoT device categorized as Device 2a may have (or support) energy storage. The A-IoT device categorized as Device 2a may have (or support) initial sampling frequency offset (SFO) up to 10^{X} ppm. The A-IoT device categorized as Device 2a may have (or support) both DL and/or UL amplification in the device. The UL transmission of the A-IoT device categorized as Device 2a may be backscattered on a carrier wave provided externally.

For example, an A-IoT device may be referred to as Device 2b (or Device C). The A-IoT device categorized as Device 2b may have (or support) peak power consumption less than or equal to a few hundred μW peak power consumption. The A-IoT device categorized as Device 2b may have (or support) energy storage. The A-IoT device categorized as Device 2b may have (or support) initial sampling frequency offset (SFO) up to 10^{X} ppm. The A-IoT device categorized as Device 2b may have (or support) both DL and/or UL amplification in the device. The UL transmission of the A-IoT device categorized as Device 2b may be generated internally by the A-IoT device.

A (e.g., maximum) message size of the A-IoT device may be approximately 1000 bits to be received by the A-IoT device. A (e.g., maximum) message size of the A-IoT device may be approximately 1000 bits to be transmitted from the A-IoT device. The one-way end-to-end (e.g., maximum) latency (e.g., including query/triggering time) of the A-IoT device may be from 1 second to 10 seconds. The (e.g., maximum) connection density of the A-IoT communications may be about 150 A-IoT devices per 100 m² for indoor scenarios. The (e.g., maximum) connection density of the A-IoT communications may be about 20 A-IoT devices per 100 m² for outdoor scenarios. The A-IoT device may be a fixed or static (not moving) device. The A-IoT device may have a moving speed of 10 km/h, e.g., at least for indoor scenarios.

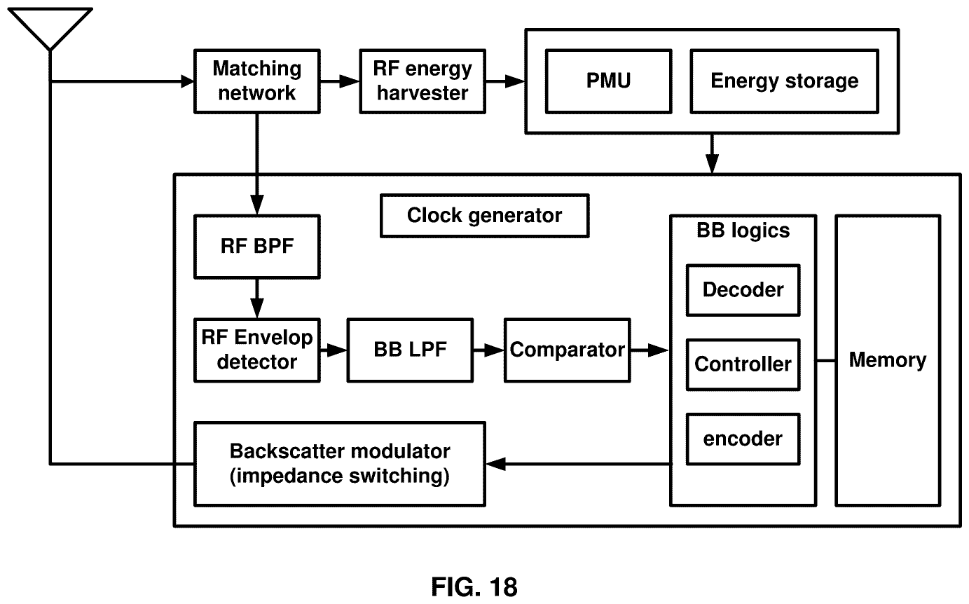

FIG. 18 illustrates an example of A-IoT device architecture as per an aspect of an embodiment of the present disclosure. The block diagrams in FIG. 18 may be an example A-IoT device architecture of Device 1. For example, the A-IoT device may comprise one or more antennas. The one or more antenna may be either shared or separate for RF energy harvester and receiver/transmitter. For example, the A-IoT device may comprise a block for a matching network. The matching network may be to match impedance between antenna and other components (including RF energy harvester and receiver related blocks). For example, the A-IoT device may comprise an RF energy harvester. The RF energy harvester may comprise rectifier performing RF signal (AC) to DC conversion. For example, the A-IoT device may comprise an energy storage (e.g., capacitor). The energy storage may store harvested energy from RF energy harvester. For example, the A-IoT device may comprise a power management unit (PMU). The PMU may manage storing energy to energy storage from energy harvester and supplying power to active component blocks which needs power supply.

In FIG. 18, the A-IoT device may comprise a digital baseband (BB) logic. The digital BB logic may include functional blocks like encoder, decoder, controller, etc. For example, the A-IoT device may comprise a memory. The memory may comprise at least one of Non-Volatile Memory (NVM) and/or registers. For example, the NVM may comprise an Erasable Programmable Read-Only Memory (EEPROM), e.g., for permanently storing device ID, etc. For example, the registers may be for temporarily keeping information for its operation, e.g., while energy is available for the operation in energy storage. For example, the A-IoT device may comprise a clock generator. The clock generator may provide clock signal(s).

In FIG. 18, the A-IoT device may comprise reception related blocks. For example, the A-IoT device may comprise RF band-pass filter (BPF), e.g., for improving selectivity. The RF BPF may be optional to be implemented in the A-IoT device. For example, the A-IoT device may comprise an RF envelope detector. The RF envelop detector may convert RF signal to baseband. For example, the A-IoT device may comprise a BB low-pass filter (LPF). The BB LPF may filter out harmonics and high frequency components to improve input signal quality to comparator. The BB LPF may be optional to be implemented in the A-IoT device. For example, the A-IoT device may comprise a comparator that determines high/low of input signal.

In FIG. 18, the A-IoT device may comprise transmission related blocks. For example, the A-IoT device may comprise a backscatter modulator. The backscatter modulator may switch impedance to modulate backscattered signal with Tx signal from BB logics.

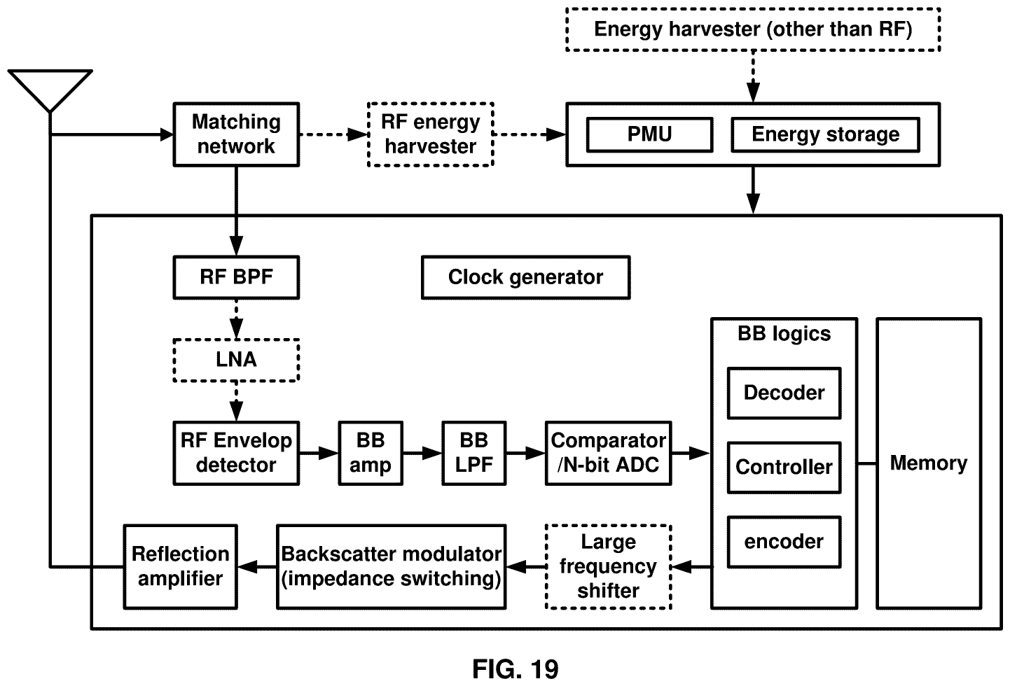

FIG. 19 illustrates an example of A-IoT device architecture as per an aspect of an embodiment of the present disclosure. The block diagrams in FIG. 19 may be an example A-IoT device architecture of Device 2a. Comparing with the A-IoT device architecture in FIG. 18, the A-IoT device architecture in FIG. 19 may further comprise one or more additional blocks. The one or more additional blocks may comprise an LNA. The LNA may improve a signal strength and sensitivity of receiver. The one or more additional blocks a BB amplifier. The BB amplifier may amplify a BB signal to improve signal strength. The one or more additional blocks a reflection amplifier. The reflection amplifier may amplify reflected backscattered signal. The one or more additional blocks a large frequency shifter. The large frequency shifter (e.g., tens of MHZ) may shift a backscattered signal from one frequency (e.g., FDD-DL frequency) to another frequency (e.g., FDD-UL frequency).

In FIG. 19, the A-IoT device may comprise an N-bit analog-to-digital converter (ADC), e.g., instead of the comparator. The A-IoT device may have one or more energy source. For example, the A-IoT device may comprise an RF energy harvester for harvesting an energy from an RF signal (e.g., radio wave). The RF energy harvester may include rectifier performing RF signal (AC) to DC conversion. The A-IoT device may comprise an energy harvester (other than the RF energy harvester) for energy harvesting from energy source(s) other than the RF signal.

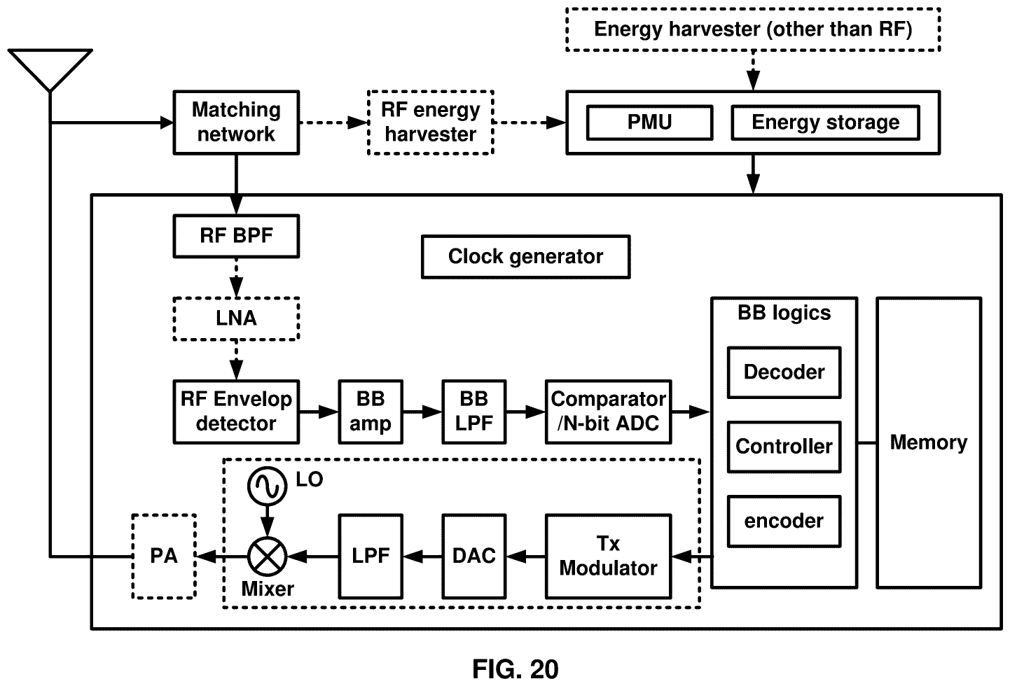

FIG. 20 illustrates an example of A-IoT device architecture as per an aspect of an embodiment of the present disclosure. The block diagrams in FIG. 20 may be an example A-IoT device architecture of Device 2b. Comparing with the A-IoT device architectures in FIG. 18 and/or FIG. 19, the A-IoT device architecture in FIG. 20 may further comprise one or more additional blocks. The one or more additional blocks may comprise a Tx Modulator, e.g., where baseband bits are modulated according to modulation scheme. The Tx Modulator block may be a part of BB logic. The one or more additional blocks may comprise a digital to analog converter (DAC) that converts digital signal to analog signal. The one or more additional blocks may comprise a low pass filter (LPF) for filtering out undesired signal. The one or more additional blocks may comprise a mixer that performs up-converting baseband signal to RF range. The one or more additional blocks may comprise a local oscillator (LO) for carrier frequency generation. The block diagrams in FIG. 20 may comprise a phase locked loop (PLL) and/or a frequency locked loop (FLL) that are used to generate frequencies suitable for the LO in a respective frequency range. The one or more additional blocks may comprise a power amplifier (PA) that amplifies TX signal, if present.

In FIG. 17, FIG. 18, FIG. 19, and/or FIG. 20, the RF energy harvester may function in a simultaneous manner with the reception related blocks. For example, an RF energy harvester of the A-IoT device may receive RF signals from a first set of antennas. For example, a reception related blocks of the A-IoT device may receive RF signals from a second set of antennas.

In FIG. 17, FIG. 18, FIG. 19, and/or FIG. 20, the A-IoT device may comprise common antenna(s) shared between the energy harvester and the reception related blocks. For example, the common antenna(s) between the energy harvester and the reception related blocks may receive RF signals. The received RF signals may be split into two streams for the energy harvester and the reception related blocks. For example, a power of the received RF signals may be split between the energy harvester and the reception related blocks. For example, the A-IoT device may switch the antenna(s) between the RF energy harvester and the reception related blocks using time switching. For example, RF signals received at the antenna(s) may be directed to the energy harvester when a path is switched to be directed to the energy harvester. The RF signals received at the antenna(s) may be directed to the reception related blocks, e.g., when a path is switched to be directed to the reception related blocks.

The A-IoT communications may comprise one or more topologies. The one or more topologies may comprise at least one of: a topology for an A-IoT direct network communication, a topology for an A-IoT Indirect network communication, and/or a topology for an A-IoT device to UE direct communication.

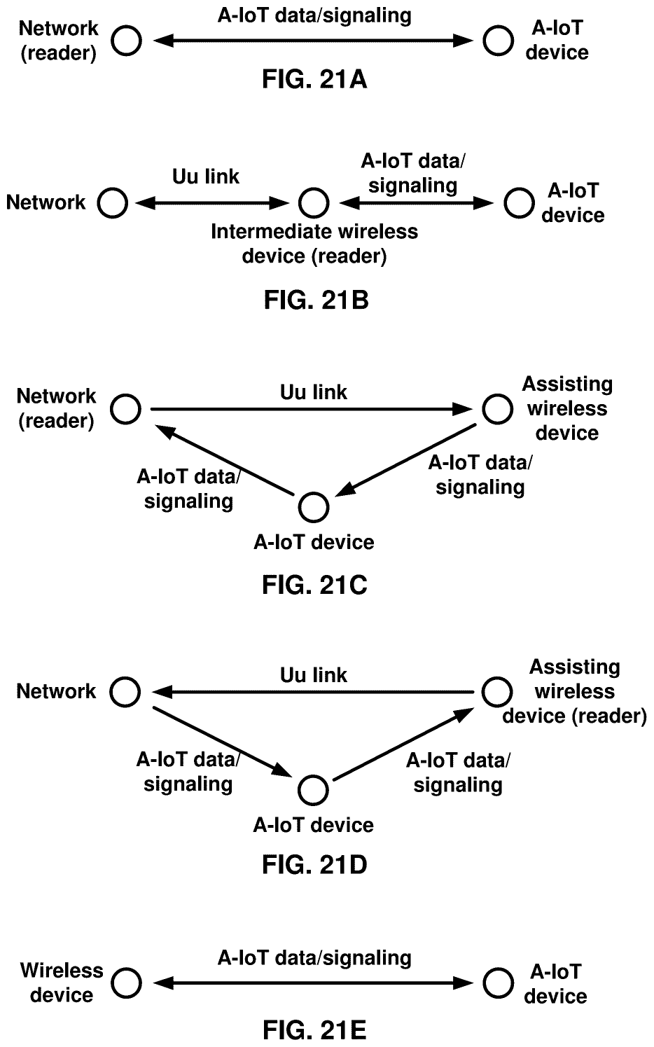

FIG. 21A illustrates an aspect of an example embodiment according to the present disclosure. The topology in FIG. 21A may be an example of an A-IoT direct network communication. For example, the A-IoT direct network communication comprises an A-IoT device and a network node (Network in FIG. 21A). The topology for the A-IoT direct network communication may comprise a direct link between the network node and the A-IoT device.

In an A-IoT direct network communication, the A-IoT device may directly and/or bidirectionally communicates, via the direct link, with the network node. The communication between the network node and the A-IoT device may include A-IoT data and/or signalling.

The topology in FIG. 21A may comprise a second direct link between the A-IoT device and a second network node. For example, the network node transmits, to the A-IoT device and via a first direct link, one or more signal and/or A-IoT data. The A-IoT device may transmit, to the second network node and via the second direct link, one or more second signals and/or a second A-IoT data. For example, the network node transmitting to the A-IoT device may be a different from the second network node receiving from the A-IoT device.

In the A-IoT direct network communication, the direct link may comprise and/or referred to as a downlink, an uplink, a sidelink, an A-IoT link, and/or the like. The direct link from the network node to the A-IoT device may comprise an R2D channel. The direct link from the A-IoT device to the network node may comprise a D2R channel.

FIG. 21B, FIG. 21C, and FIG. 21D illustrate an aspect of example embodiments according to the present disclosure. The topologies in FIG. 21B, FIG. 21C, and FIG. 21D may be examples of an A-IoT device communication comprising an indirect link. For example, a topology for an A-IoT indirect network communication comprises an A-IoT device, a network node (Network in FIG. 21A), and/or a wireless device. The wireless device may be Intermediate wireless device in FIG. 21B and/or Assisting wireless device in FIG. 21C and/or in FIG. 21D. The A-IoT indirect network communication may comprise communication(s) between the A-IoT device and the network. In the A-IoT indirect network communication, there is a wireless device that helps in conveying information between the A-IoT device and the network. For example, the wireless device may be referred to as an intermediate (wireless) device, an assisting (wireless) device, and/or the like. In FIG. 21B, FIG. 21C, and FIG. 21D, Network may comprise at least one of: a base station, a cell, a transmission-reception point (TRP), a repeater, a relay, and/or an integrated access and backhaul (IAB) node.

FIG. 21B illustrates an aspect of an example embodiment according to the present disclosure. The A-IoT indirect network communication in FIG. 21B may not comprise a direct link between the A-IoT device and the network. The communications between the A-IoT device and the network may be via a wireless device (e.g., Intermediate wireless device in FIG. 21B). The wireless device may relay and/or convey control information (A-IoT signaling) and/or A-IoT data generated/transmitted by the network to the A-IoT device. The wireless device may relay and/or convey control information and/or A-IoT data/signaling generated/transmitted by the A-IoT device to the network.

For example, the wireless device in FIG. 21B may be referred to as an intermediate wireless device (e.g., an intermediate device and/or an intermediate node). The intermediate wireless device may be referred to as a reader, an interrogator, and/or the like.

The intermediate wireless device may receive, from the network (e.g., base station) and via a downlink channel (e.g., PDCCH and/or PDSCH), A-IoT data and/or a control signal. For example, the intermediate wireless device may transmit, to the A-IoT device, the A-IoT data and/or a control signal.

The intermediate wireless device may receive, from the A-IoT device, A-IoT data/signaling. For example, the intermediate wireless device may transmit, e.g., via an uplink channel (e.g., PUCCH and/or PUSCH), to the network, the A-IoT device, A-IoT data/signaling. The link between the intermediate wireless device and the network may comprise an uplink (e.g., PUCCH and/or PUSCH). The link between the intermediate wireless device and the network may comprise downlink (e.g., PDCCH and/or PDSCH). The link between the intermediate wireless device and the A-IoT device may comprise a sidelink, A-IoT link and/or the like.

The intermediate wireless device may comprise a wireless device, relay, IAB node, a second cell, a second base station, a reader, an interrogator, an access point, and/or the like. The intermediate wireless device may transmit, to the A-IoT device, an RF signal (e.g., energy signal and/or wireless energy transmission). The A-IoT device may harvest, from the RF signal, an energy to be used for A-IoT communication(s).

FIG. 21C and FIG. 21D illustrate an aspect of example embodiments according to the present disclosure. The topologies in FIG. 21C and in FIG. 21D may comprise an A-IoT indirect network communication between the A-IoT device and the network node (Network in FIG. 21C and/or in FIG. 21D). The topologies in FIG. 21C and in FIG. 21D may comprise a direct link between the A-IoT device and the network node. The communications between the A-IoT device and the network may be via a wireless device (e.g., Assisting wireless device in FIG. 21C and/or in FIG. 21D). Between the A-IoT device and the network, there are a direct link (e.g., Uu link in FIG. 21C and/or FIG. 21D) and an indirect link.

For example, the direct link in FIG. 21C may be for transmission between the network and the A-IoT device. For example, the direct link may be for transmission from the A-IoT device to the network. For example, the indirect link may be for transmission from the network to the A-IoT device. For example, the direct link may comprise a link between Network and A-IoT device in FIG. 21C. For example, the indirect link (e.g., Uu link and/or downlink) may comprise a link between the network and Assisting wireless device in FIG. 21C. For example, the indirect link (e.g., R2D link or channel) may comprise a link between A-IoT device and Assisting wireless device in FIG. 21C.

In FIG. 21C, the network may transmit a control signal (e.g., A-IoT signaling) and/or A-IoT data to the wireless device via an Uu link. The Uu link may comprise a downlink, PDSCH, PBCH, PDCCH, and/or a sidelink. The wireless device may convey (relay, forward, and/or transmit), to the A-IoT device and via R2D channel, the control signal and/or the A-IoT data that the wireless device receives from the network. The A-IoT device may transmit a second control signal and/or second A-IoT data to the network via the direct link. The direct link may comprise a D2R link (or channel), uplink, and/or sidelink. The second control signal and/or second A-IoT data may comprise the response to the received control signal and/or A-IoT data from the wireless device.

For example, the direct link in FIG. 21D may be for transmission between the network and the A-IoT device. For example, the direct link may be for transmission from the network to the A-IoT device. For example, the indirect link may be for transmission from the A-IoT device to the network. For example, the direct link may comprise a link between Network and A-IoT device in FIG. 21D. For example, the indirect link (e.g., Uu link and/or uplink) may comprise a link between the network and Assisting wireless device in FIG. 21D. For example, the indirect link (e.g., D2R link or channel) may comprise a link between A-IoT device and Assisting wireless device in FIG. 21D.

In FIG. 21D, the network may transmit a control signal (e.g., A-IoT signaling) and/or A-IoT data to A-IoT device via a direct link. The direct link may comprise a downlink, PDSCH, PBCH, PDCCH, and/or an R2D link (or channel). The A-IoT device may transmit a second control signal and/or second A-IoT data to the network via the indirect link. For example, the A-IoT device may transmit the second control signal and/or second A-IoT data to the wireless device via a link between the A-IoT device and the wireless device. The link between the A-IoT device and the wireless device may comprise an uplink, a sidelink and/or a D2R link (or channel). The wireless device may convey (relay, forward, and/or transmit), to the network and via Uu link, the second control signal and/or second A-IoT data that the wireless device receives from the A-IoT device. The Uu link may comprise an uplink, PUCCH, PUSCH, and/or a sidelink

Referring to FIG. 21C and in FIG. 21D, the wireless device may be referred to as an assisting wireless device (e.g., an intermediate wireless device, an assisting device and/or an assisting node), a reader, an interrogator, and/or the like.

For example, the assisting wireless device may receive, from the network (e.g., base station) and via a Uu link comprising a downlink channel (e.g., PDCCH and/or PDSCH), A-IoT data and/or a control signal (A-IoT signaling). The assisting wireless device may convey (relay, forwards, and/or transmits), to the A-IoT device via an R2D link (or channel), the A-IoT data and/or the control signal.

For example, the assisting wireless device may receive, from the A-IoT device and via a D2R link (or channel), A-IoT data and/or a control signal. The assisting wireless device conveys (relays, forwards, and/or transmits), to the network (e.g., base station) and via a Uu link comprising an uplink channel (e.g., PUCCH and/or PUSCH), A-IoT data and/or a control signal.

Referring to FIG. 21C and in FIG. 21D, the link (e.g., Uu link) between the assisting wireless device and the network may comprise an uplink (e.g., PUCCH and/or PUSCH) and/or downlink (e.g., PDCCH and/or PDSCH). The link between the assisting wireless device and the A-IoT device may comprise an R2D link (or channel), a D2R link (or channel), a sidelink, A-IoT link, and/or the like. The assisting wireless device may comprise a wireless device, relay, IAB device, a second cell, a second base station, a reader, an interrogator, an access point, and/or the like. The assisting wireless device may transmit, to the A-IoT device, a signal (e.g., RF signal, energy signal, wireless energy transmission) from which the A-IoT device harvests an energy to be used for A-IoT communication(s).

FIG. 21E illustrate an aspect of example embodiments according to the present disclosure. The topology in FIG. 21E may be for an A-IoT device to a wireless device direct communication. The topology may comprise a communication between an A-IoT device and an Ambient capable wireless device (Wireless device in FIG. 21E) with no network node in the middle. The A-IoT device communicates bidirectionally with the wireless device. The communication between the wireless device and the A-IoT device may comprise the A-IoT data and/or signalling. The communication link between the wireless device and the A-IoT device may comprise a sidelink (e.g., comprising a sidelink channel such as PSFCH, PSSCH, PSCCH, PSDCH, and/or the like), A-IoT link, and/or the like. For example, a channel or link from the wireless device to the A-IoT device may comprise a R2D link or R2D channel. For example, a channel or link from the A-IoT device to the wireless device may comprise a D2R link or D2R channel.

The device-to-device (D2D) communication may comprise A-IoT communications and/or A-IoT topologies. The D2D communication may comprise a communication between a network node and an A-IoT device. The D2D communication may comprise a communication between a wireless device and an A-IoT device.

A link defined, included, and used for the D2D communication may be referred to as a sidelink (SL). The link used for the D2D communication may be referred to as other terminologies, e.g., an IoT link, an A-IoT link, a D2D link, and/or the like.

In the present disclosure, a reader may comprise a network node (e.g., a base station, a base station central unit, a base station distributed unit, a TRP, an IAB node, a cell, and/or a relay). In the present disclosure, a reader may comprise a wireless device (e.g., an assisting wireless device, and/or an intermediate wireless device) that a network assigns as a reader.

The A-IoT communications may comprise an inventory procedure. The inventory procedure may refer to an procedure, a process, and/or an operation by which a reader identifies one or more A-IoT devices. The inventory procedure may be referred to as an inventory process, an inventory operation, A-IoT device population, and/or the like. The inventory procedure may comprise or be referred to as a random access procedure. For example, the inventory procedure may comprise an procedure, a process, and/or an operation initiating a random access of one or more A-IoT devices. For example, each A-IoT device accesses to a network (e.g., reader) using a randomly selected radio resource (e.g., slot and/or frequency).

The inventory procedure may comprise a transmission of one or more commands from a reader to one or more A-IoT devices. A command may be referred to as a message and/or an order. For example, a query command and/or ACK command may be interchangeable with a query message (or order) and/or ACK message (or order), respectively. The one or more commands may comprise a query command (e.g., referred to as Query). The one or more commands may comprise an acknowledge command (e.g., referred to as ACK). The one or more commands may comprise a negative-acknowledge command (e.g., referred to as NACK). The transmission of the one or more commands may comprise a broadcast transmission to one or more A-IoT devices in a proximity area of the reader. For example, the broadcast transmission comprises a query command. The transmission of the one or more commands may comprise a groupcast (or multicast) transmission to one or more A-IoT devices in a proximity area of the reader. For example, the groupcast transmission comprises a query command. The transmission of the one or more command may comprise a unicast transmission to a particular A-IoT device in a proximity area of the reader. For example, the unicast transmission comprises an acknowledge command and/or a negative-acknowledge command.

The inventory procedure may comprise one or more inventory rounds.

For example, an inventory procedure is a single inventory round. For example, in this case, the inventory procedure is interchangeably with an inventory round.

For example, an inventory procedure comprises multiple inventory rounds. For example, in this case, the reader and one or more A-IoT devices may perform the multiple inventory rounds for the same inventory procedure. For example, the reader and one or more A-IoT devices may perform the multiple inventory rounds in response to initiating the inventory procedure until the inventory procedure is completed (e.g., successfully or unsuccessfully).

A reader may transmit a frame comprising query command, e.g., for each of one or more inventory rounds. The query command of the frame may initiate or start an inventory round respective to the query command. The frame comprising the query command may initiate or start an inventory round respective to the query command. The query command may be referred to as Query, an inventory command, and/or an inventory message.

The frame may further comprise a preamble. The preamble of the frame may initiate or start an inventory round respective to the query command. The preamble may be referred to as an R2D preamble. For example, the preamble is a timing acquisition signal for a R2D channel and/or a D2R channel. For example, the frame includes the preamble, e.g., least for timing acquisition and for indicating the start of the R2D transmission (e.g., the start of the frame) in time domain.

An inventory round may be terminated by a subsequent frame after a frame comprising a query command initiating the inventory round. The subsequent frame may comprise one or more subsequent commands. For example, the one or more subsequent commands may comprise a second query command (e.g., another or subsequent query command). The second query command may be different from or subsequent to the query command initiating the inventory round. For example, the subsequent frame may terminate the inventory round. For example, the second query command of the subsequent frame may terminate the inventory round. For example, the subsequent frame may comprise a preamble. The preamble of the subsequent frame may terminate the inventory round.

In the present disclosure, a query command initiating a respective inventory round may be interchangeable with a frame, comprising the query command, initiating the respective inventory round. In the present disclosure, a query command initiating a respective inventory round may be interchangeable with a preamble of a frame, comprising the query command, initiating the respective inventory round.

For example, a reader transmits a first query command to one or more A-IoT devices. The first query command may initiate or start a first inventory round. The reader may receive one or more responses from at least one (e.g., a first A-IoT device) of the one or more A-IoT devices during the first inventory round. The reader may transmit a second query command to the one or more A-IoT devices. The second query command may terminate the first inventory round. The second query command may initiate a second inventory round. The reader may receive one or more second responses from at least one (e.g., a second A-IoT device) of the one or more A-IoT devices during the second inventory round.

For example, the reader may determine the first inventory round is ongoing in response to or after transmitting the first query command initiating the first inventory round. The reader may determine the first inventory round is ongoing until the reader transmits the second query command initiating the second inventory round. The reader may determine the first inventory round is ongoing from a first time to a second time. The first time may be associated with a transmission time of the first query command. The first time may be associated with a transmission time of the second query command.

For example, the one or more A-IoT devices may determine the first inventory round is ongoing in response to or after receiving the first query command initiating the first inventory round. The one or more A-IoT devices may determine the first inventory round is ongoing until the one or more A-IoT devices receive the second query command initiating the second inventory round. The one or more A-IoT devices may determine the first inventory round is ongoing from a first time to a second time. The first time may be associated with a reception time of the first query command. The first time may be associated with a reception time of the second query command.

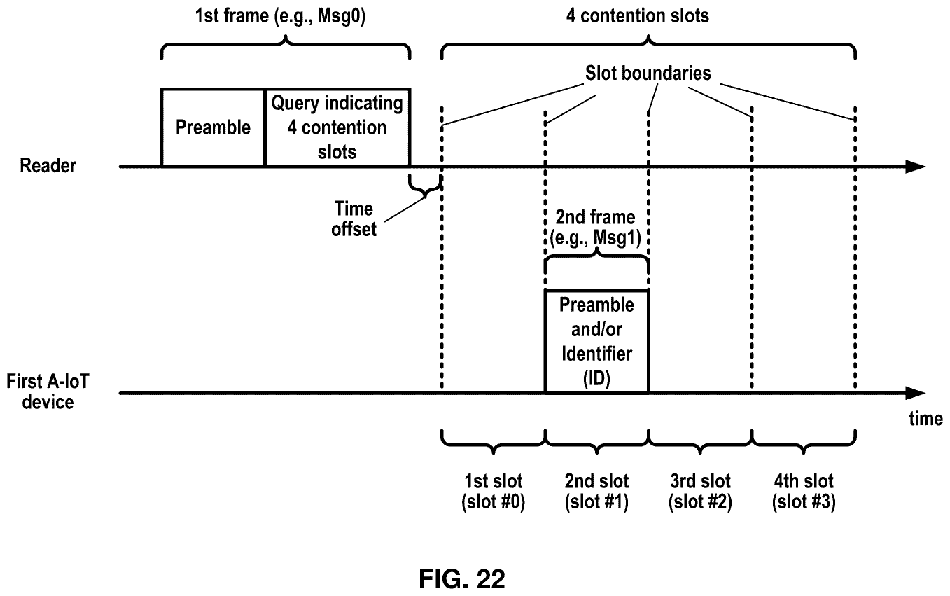

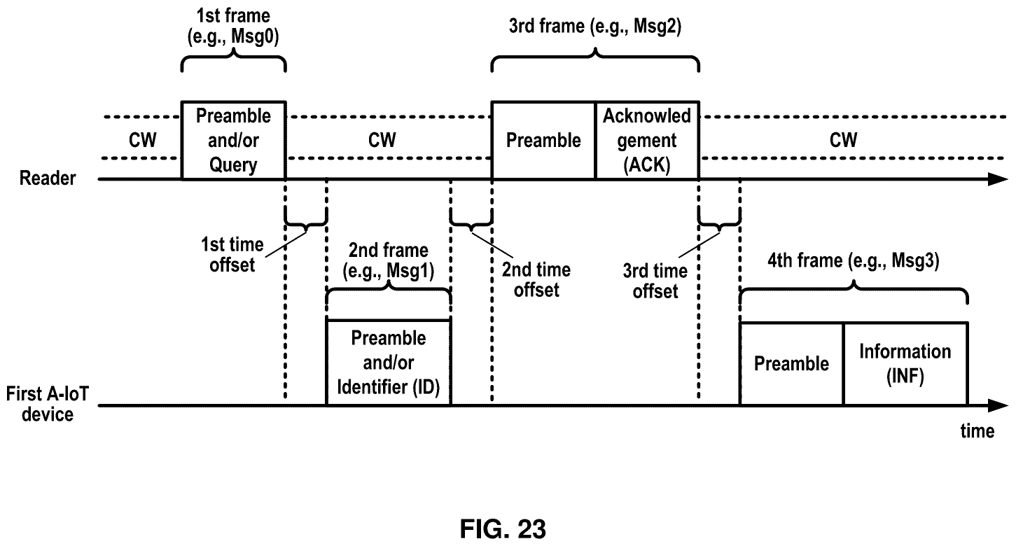

The inventory procedure described in the present disclosure may comprise one or more different slot counting mechanisms (rules, methods, and/or processes). An inventory round and/or an inventory procedure may be different depending on the slot counting. FIG. 22 and FIG. 23 illustrates an aspect of example embodiments of slot counting in an inventory procedure according to the present disclosure.

FIG. 22 illustrate an aspect of example embodiments of an inventory procedure according to the present disclosure. A reader may transmit, via a R2D channel, a first frame to one or more A-IoT devices comprising a first A-IoT device. The first frame may comprise a preamble for synchronization of the inventory round. The first frame may comprise a query command. The first frame, the preamble, and/or the query command may initiate an inventory round or an inventory procedure. The query command may indicate a quantity of contention slots starting after the first frame.

For example, the query command may comprise a field indicating the quantity of contention slots. The quantity of contention slots may be 2°, where Q comprises zero or a positive integer value.

For example, a size of the field, in the query command, indicating the quantity of contention slots may be fixed (e.g., n-bit field). For example, the query command may indicate a size of the field (e.g., n-bit field). For example, the field indicates a value of Q. The quantity of contention slots may be 2^{Q}.

For example, for the case of the field being a 4-bit field, ‘0000’ value of the field may indicate Q=0 in decimal (Q=‘0000’ in binary), which further indicates that the quantity of contention slots is one since 2^{Q}=1 with Q=0 in decimal (Q=‘0000’ in binary). For example, ‘0001’ value of the field may indicate Q=1 in decimal (Q=‘0001’ in binary), which further indicates that the quantity of contention slots is two since 2^{Q}=2 with Q=1 in decimal (Q=‘0001’ in binary). For example, ‘0010’ value of the field may indicate Q=2 in decimal (Q=‘0010’ in binary), which further indicates that the quantity of contention slots is four since 2^{Q}=4 with Q=2 in decimal (Q=‘0010’ in binary), For example, ‘0011’ value of the field may indicate Q=3 in decimal (Q=‘0011’ in binary), which further indicates that the quantity of contention slots is eight since 2^{Q}=8 with Q=3 in decimal (Q=‘0011’ in binary), and so on.

For example, the 4 contention slots in FIG. 22 is an example when a field value of the field in the query command is ‘0010’ (e.g., Q=2 in decimal and/or Q=‘0010’ in binary. In this case, the quantity of contention slots is four since 2^{Q}=4 with Q=2 in decimal (Q=‘0010’ in binary).

Referring to FIG. 22, an earliest slot of the contention slots may start in response to or after the end of the 1st frame with a time offset (e.g., T_{R2Dmin} and/or T_{R2Dmax}) as shown in FIG. 22. The time offset (e.g., T_{R2Dmin} and/or T_{R2Dmax}) may be a time interval or duration from a transmission of the reader to the earliest slot of the contention slots (e.g., to transmission of an A-IoT device response). For example, the time offset (e.g., T_{R2Dmin}) is a minimum time between a transmission (e.g., the 1^{st} frame) from the reader to the A-IoT device via R2D channel and the corresponding transmission (e.g., the 2^{nd} frame) from the A-IoT device to the reader via the earliest slot of the contention slots (e.g., a D2R channel) following it. For example, the time offset (e.g., T_{R2Dmax}) is a maximum time between a transmission (e.g., the 1^{st} frame) from the reader to the A-IoT device via R2D channel and the corresponding transmission (e.g., the 2^{nd} frame) from the A-IoT device to the reader via the earliest slot of the contention slots (e.g., a D2R channel) following it.

For example, the first A-IoT device transmits, to the reader, the second frame (e.g., via an earliest slot of the contention slots) in response to or after T_{R2Dmin} starting from the end of the first frame. For example, the reader receives, from the first A-IoT device, the second frame (e.g., via an earliest slot of the contention slots) in response to or after T_{R2Dmin} starting from the end of the first frame.

For example, the first A-IoT device transmits, to the reader, the second frame (e.g., via an earliest slot of the contention slots) before the end of T_{R2Dmax} starting from the end of the first frame. For example, the reader receives, from the first A-IoT device, the second frame (e.g., via an earliest slot of the contention slots) before the end of T_{R2Dmax} starting from the end of the first frame.

For example, a transmission or reception of the second frame (e.g., via an earliest slot of the contention slots) starts after T_{R2Dmin} starting from the end of the first frame. For example, a transmission or reception of the second frame (e.g., via an earliest slot of the contention slots) starts before the end of T_{R2Dmax} starting from the end of the first frame.

Referring to FIG. 22, the contention slots may be one or more consecutive time slots. For example, in FIG. 22, four contention slots comprise a first slot (with index slot #0), a second slot (with index slot #1), a third slot (with index slot #2), and a fourth slot (with index slot #3). For example, the first slot starts, is located, and/or is present in response to or after the 1^{st} frame, followed by the second slot, followed by the third slot, and followed by the fourth slot.

In FIG. 22, the reader may determine a length of a preamble and/or transmit the preamble. The one or more A-IoT device may receive the preamble. The one or more A-IoT device may determine slot boundaries of contention slots using the preamble (and/or the length of a preamble). For example, the one or more A-IoT device may estimate or detect a length of the preamble, e.g., using an RF envelop detector.

A length of each slot or a time interval between two consecutive slot boundaries may be scaled by the length of the preamble. A length of each slot or a time interval between two consecutive slot boundaries may be the length of the preamble minus one or more time offsets. A length of each slot or a time interval between two consecutive slot boundaries may be the length of the preamble plus one or more time offsets.

In FIG. 22, the reader and/or the one or more A-IoT devices may determine the quantity of the contention slots. In FIG. 22, the reader and/or the one or more A-IoT devices may determine a starting time and/or an end time of each slot of contention slots. In FIG. 22, the reader and/or the one or more A-IoT devices may determine slot boundaries of the contention slots.

For example, each slot of the contention slots may have the same time duration (e.g., the same length or the same size) in a time domain.

The time duration of the each slot of the contention slots may be predefined.

The A-IoT device may determine, select, measure, and/or estimate the time duration of the each slot of the contention slots. For example, The A-IoT device may determine, select, measure, and/or estimate a portion of the 1^{st} frame (in FIG. 22) as the time duration of the each slot of the contention slots.

For example, the time duration of the 1^{st} frame (in FIG. 22) may be the same as the time duration of the each slot of the contention slots. For example, the time duration, of the each slot of the contention slots may be the same as the time duration of the 1^{st} frame (in FIG. 22), scaled by a scaling factor. The scaling factor is predefined. A query command (e.g., Query in the 1^{st} frame) may indicate the scaling factor.

For example, the time duration of a preamble in the 1^{st} frame (in FIG. 22) may be the same as the time duration of the each slot of the contention slots. For example, the time duration of the each slot of the contention slots may be the same as the time duration, of the preamble in the 1^{st} frame (in FIG. 22), scaled by a scaling factor. The scaling factor is predefined. A query command (e.g., Query in the 1^{st} frame) may indicate the scaling factor.

For example, the time duration of a query command in the 1^{st} frame (in FIG. 22) may be the same as the time duration of the each slot of the contention slots. For example, the time duration of the each slot of the contention slots may be the same as the time duration, of the query command in the 1^{st} frame (in FIG. 22), scaled by a scaling factor. The scaling factor is predefined. A query command (e.g., Query in the 1^{st} frame) may indicate the scaling factor.

At least one of the one or more A-IoT devices may receive, via a R2D channel, the first frame. The at least one of the one or more A-IoT devices may be referred to as a first A-IoT device in FIG. 22.

The first A-IoT device may receive, identify, detect, and/or decode a value of Q in the query command of the first frame. The first A-IoT device may determine that there are 2_{Q} contention slot(s) after the first frame.

The first A-IoT device may select one slot (e.g., the second slot in FIG. 22) from the 2_{Q} contention slots. The selected slot by the first A-IoT device may be i-th slot where 1≤i≤2^{Q}.

For example, if a slot index starts from K, an index of the selected slot by the first A-IoT device may be k where K≤k≤2^{Q}+K−1, K may be a zero or a positive integer number, and/or k=i+K−1. For example, if a slot index starts from 0, an index of the selected slot by the first A-IoT device may be k where 0≤k≤2^{Q}−1 and/or k=i−1 as shown in FIG. 22. For example, if a slot index starts from 1, an index of the selected slot by the first A-IoT device may be k where 1≤k≤2^{Q} and/or k=i.

The first A-IoT device may use a counter to determine when to transmit the second frame. The counter may be a count-down counter. The counter may be a count-up counter.

For example, the first A-IoT device may (e.g., randomly) select one of 2^{Q} values. For example, each of 2° values is associated with and/or is mapped to a respective contention slot of the contention slots. For example, in FIG. 22, the first A-IoT device may select a value 1 out of 4 (=2°) values (e.g., with Q=2) in the value range from 0 to 3. The value k is associated with and/or is mapped to the (k+1)-th slot and/or the slot #k in FIG. 22. For example, the value 1 is associated with and/or is mapped to the second slot and/or the slot #1. The first A-IoT device may load or set the selected value 1 into the counter.

The A-IoT device may change the value of the counter, e.g., in response to transitioning from one contention slot to a next contention slot. For example, the A-IoT device may decrease the value of the counter (e.g., count-down counter) by 1, e.g., in response to transitioning from one contention slot to a next contention slot. For example, the A-IoT device may increase the value of the counter (e.g., count-up counter) by 1, e.g., in response to transitioning from one contention slot to a next contention slot.

The A-IoT device may transmit the second frame via a contention slot, e.g., if the value of the counter reach the one representing the selected value (e.g., value 1 in FIG. 22) and/or the selected contention slot (e.g., 2^{nd} slot and/or slot #1 in FIG. 22).

For example, for the count-down counter, the first A-IoT device may transmit the second frame when the value of the counter reaches zero, e.g., if the first A-IoT device starts to decrease a value of the count-down counter from the selected value k, where k is 0≤k≤2^{Q}−1.

For example, for the count-up counter, the first A-IoT device may transmit the second frame when the value of the counter reaches the selected value k, e.g., if the first A-IoT device starts to increase a value of the count-up counter from zero, where k is 0≤k≤2^{Q}−1.

In FIG. 22, the first A-IoT device may select a value 1 (e.g., selected value k=1). For example, the first A-IoT device loads and/or sets a value 1 into the counter. For example, the counter is a count-down counter. For example, the counter starts from the selected value 1. The first A-IoT device may keep the counter value as 1 during the first slot (e.g., slot #0) in FIG. 22. The first A-IoT device may decrease the value of the counter by 1, e.g., after or in response to transitioning from the first slot to the second slot (e.g., slot #1) in FIG. 22. For example, the value of the counter is zero, e.g., after or in response to transitioning to the second slot (e.g., slot #1) in FIG. 22. For example, the value of the counter is zero, e.g., after or in response to decreasing the value of the counter by 1. The first A-IoT device may transmit the second frame via the second slot (e.g., slot #1), e.g., after or in response to the value of the counter is zero.

The first A-IoT device may transmit, via the selected slot, a response (or payload) to the first frame and/or a query command in the first frame. The selected slot may be or comprise a D2R channel. The response may be a second frame. The response and/or the second frame may comprise an identifier of the first A-IoT device. The identifier may be a random number (or pseudo-random number) that the first A-IoT device selects. A size of random number may be fixed or predefined. For example, the random number may be m-bit random number. For example, m is equal to 16. For example, the second frame may comprise a respective preamble for synchronization of timing for the D2R channel.

For example, the second frame may comprise a preamble for timing acquisition from the first A-IoT device to the reader. For example, the second frame comprises the preamble followed by the response in a time domain. The preamble in the second frame may be referred to as a D2R preamble. For example, the preamble in the second frame is a D2R timing acquisition signal. D2R timing acquisition signal. The preamble in the second frame may be for indicating the start of a transmission (e.g., a start of the second frame or the response) from the first A-IoT device to the reader in time domain.

For example, a transmission from an A-IoT device to a reader may occur within a slot. For example, a transmission from an A-IoT device to a reader may not occur across two or more slots. For example, a transmission from an A-IoT device to a reader may not occur across any slot boundaries.

For example, the first A-IoT device may transmit the second frame within the second slot. For example, the transmission of the second frame starts at or after a start time of the second slot. For example, the transmission of the second frame ends at or before an end time of the second slot.

The reader may monitor (or keep monitoring) the contention slots or D2R channels respective to the contention slots. The monitoring the contention slots may be for receiving a response from at least one of the one or more A-IoT devices.

The reader may terminate the (ongoing) inventory round, e.g., if the reader receives the second frame via the second slot. For example, the reader may transmit a third frame comprising another query command. The third frame or the another query command may terminate the (ongoing) inventory round.

The reader may continue the (ongoing) inventory round, e.g., after or if the reader receives the second frame via the second slot. For example, the reader may monitor (or keep monitoring) the contention slots (e.g., a third slot and/or a fourth slot). The reader may receive one or more responses from one or more of the A-IoT devices via the third slot and/or the fourth slot. After of in response to the contention slots (e.g., an end of the fourth slot), the reader and/or the one or more A-IoT devices may determine that the inventory round is terminated.

In FIG. 22, the reader may not receive any response from A-IoT device(s) during the contention slots. The reader may initiate another inventory round or another inventory procedure, e.g., if the reader does not receive any response from A-IoT device(s) during the contention slots. The reader may adjust a quantity of contentions slots of the another inventory round or the another inventory procedure. The reader may adjust or change a transmit power of a query command initiating the another inventory round or the another inventory procedure. For example, the reader may increase the transmit power, e.g., to expand or increase the transmission coverage of the query command. For example, the reader may decrease the transmit power, e.g., to shrink or reduce the transmission coverage of the query command.

In FIG. 22, the inventory round may be completed in response to or after the last slot (of the contention slots) that the query indicates. For example, in FIG. 22, the 4th slot (or slot #3) is the last slot. The reader may transmit a second 1^{st} frame in response to or after the last slot and/or the inventory round being completed. The second 1^{st} frame may have the same field format as the 1^{st} frame in FIG. 22, e.g., with a different Q value or the same Q value. the second 1^{st} frame may initiate a respective inventory round and/or procedure as described in FIG. 22. For example, the inventory round may be completed in response to or after receiving the second 1^{st} frame.

The inventory procedure described in the present disclosure may comprise one or more different slot counting mechanisms (rules, methods, and/or processes). An inventory round and/or an inventory procedure may be different depending on the slot counting.

FIG. 23 illustrates an aspect of example embodiments of slot counting in an inventory procedure according to the present disclosure. The slot counting mechanisms described in FIG. 23 may be that the A-IoT device decreases (e.g., for count-down counter) or increases (e.g., for count-up counter) a slot counter by one when the A-IoT device receive a query command.

In an example, an inventory procedure described in the present disclosure (e.g., FIG. 23) may have more than one type of query commands. A first type query command may initiate an inventory procedure or round. A second type query command may indicate the continuation of the inventory procedure or round initiated by the first type query command. For example, the A-IoT device may determine a slot out of one or more contention slots (e.g., 2^{Q} slots indicated by the first type query command), e.g., in response to or after receiving the first type query command. The A-IoT device may decrease (e.g., for count-down counter) or increase (e.g., for count-up counter) a slot counter by one when the A-IoT device receive a second type query command. The A-IoT device may transmit the 2^{nd} frame to the reader, e.g., in response to or after the slot counter indicates the selected slot out of the one or more contention slots.

For example, the first type query command comprises at least one field indicating a number of contention slots. For example, the at least one field in the first type query command indicating a new number of contention slots. For example, an A-IoT device may initiate a new inventory procedure with the new number of contention slots in response to or receiving the first type query command comprising the at least one field.

For example, the at least one field in the first type query command indicating a change of a number of contention slots indicated by a previous first type query command. For example, an A-IoT device receives a first type query command comprising at least one field indicating a first number (e.g., new number) of contention slots. The A-IoT device may receive a second first type query command comprising at least one field indicating a change of the first number. The at least one field in the second first type query command may indicate an increasing number (e.g., increase by X slot(s) of slots from the first number of contention slots. For example, the changed number of contention slots may be the first number plus X. The at least one field in the second first type query command may indicate a decreasing number (e.g., decrease by Y slot(s) of slots from the first number of contention slots. For example, the changed number of contention slots may be the first number minus Y. For example, the A-IoT device may initiate a new inventory procedure with the changed number of contention slots in response to or receiving the second first type query command.

For example, the A-IoT device may transmit the second frame via a contention slot, e.g., if the value of the slot counter reach the one representing the selected value (e.g., value 1 in FIG. 22) and/or the selected slot (e.g., where the A-IoT device transmit the 2^{nd} frame in FIG. 23).

For example, for the count-down counter, the first A-IoT device may transmit the second frame when the value of the counter reaches zero, e.g., if the first A-IoT device starts to decrease a value of the count-down counter from the selected value k, where k is 0≤k≤2^{Q}−1.

For example, for the count-up counter, the first A-IoT device may transmit the second frame when the value of the counter reaches the selected value k, e.g., if the first A-IoT device starts to increase a value of the count-up counter from zero, where k is 0≤k≤2^{Q}−1.

Referring to FIG. 23, a reader may transmit, via a R2D channel, a first frame to one or more A-IoT devices comprising a first A-IoT device. The first frame in FIG. 23 may be the same as the first frame in FIG. 22. For example, the first frame in FIG. 23 comprises a preamble for synchronization of the inventory round. The first frame may comprise a query command (e.g., the first type query command). The first frame, the preamble, and/or the query command may initiate an inventory round or an inventory procedure. The query command may indicate a quantity of contention slots starting after the first frame.

The query command in FIG. 23 may comprise a field (e.g., command identification/indication field) indicating that the command in the 1^{st} frame is the query command initiating the inventory procedure or an inventory round.

The query command in FIG. 23 may comprise a field indicating the quantity of contention slots. The quantity of contention slots may be 2°, where Q comprises zero or a positive integer value.

A size of the field, in the query command in FIG. 23, indicating the quantity of contention slots may be fixed (e.g., as a n-bit field). For example, the query command in FIG. 23 may indicate a size of the field (e.g., as a n-bit field). For example, the field indicates a value of Q. The quantity of contention slots may be 2^{Q}.

For simplicity, a 4-bit field in the query command is assumed for description of the inventory procedure in FIG. 23.

For example, for the case of the field being a 4-bit field, ‘0000’ value of the field in the query command may indicate Q=0 in decimal (Q=‘0000’ in binary), which further indicates that the quantity of contention slots is one since 2^{Q}=1 with Q=0 in decimal (Q=‘0000’ in binary). For example, ‘0001’ value of the field in the query command of FIG. 23 may indicate Q=1 in decimal (Q=‘0001’ in binary), which further indicates that the quantity of contention slots is two since 2^{Q}=2 with Q=1 in decimal (Q=‘0001’ in binary). For example, ‘0010’ value of the field in the query command of FIG. 23 may indicate Q=2 in decimal (Q=‘0010’ in binary), which further indicates that the quantity of contention slots is four since 2^{Q}=4 with Q=2 in decimal (Q=‘0010’ in binary), For example, ‘0011’ value of the field in the query command of FIG. 23 may indicate Q=3 in decimal (Q=‘0011’ in binary), which further indicates that the quantity of contention slots is eight since 2^{Q}=8 with Q=3 in decimal (Q=‘0011’ in binary), and so on.

For example, the 4 contention slots is an example when a field value of the field in the query command is ‘0010’ (e.g., Q=2 in decimal and/or Q=‘0010’ in binary. In this case, the quantity of contention slots is four since 2^{Q}=4 with Q=2 in decimal (Q=‘0010’ in binary).

In an example, a reader in FIG. 23 transmits, via an R2D channel, a first frame to one or more A-IoT device. For example, in FIG. 23, the query command in the first frame indicates a quantity of contention slots.

An A-IoT device of the one or more A-IoT devices that receive and/or decode the first frame successfully from the reader may determine to join and/or initiate the inventory round (or procedure) indicated by the query command in the first frame. The A-IoT device may select one of the contention slots indicated by the query command in the first frame. The A-IoT device may set a slot counter to initiate, trigger, and/or transmit a transmission of 2^{nd} frame via the selected slot (e.g., a D2R channel) to the reader.

For example, the slot counter may be a count-down counter. The A-IoT device may decrement the slot counter in response to or after receiving the second type query command indicating the continuation of the inventory procedure or round initiated by the first type query command. For example, an A-IoT device with a value 0 of the count-down counter may initiate, trigger, and/or transmit a transmission of 2^{nd} frame via the selected slot (e.g., a D2R channel) to the reader.

In an example, a first A-IoT device of the one or more A-IoT devices may receive and/or decode the first frame successfully. The first A-IoT device may determine to join and/or initiate the inventory round (or procedure) indicated by the query command in the first frame.

In an example, among the one or more A-IoT devices, a second A-IoT device and/or a third A-IoT device may receive and/or decode the first frame successfully. The second A-IoT device and/or the third A-IoT device may determine to join and/or initiate the inventory round (or procedure) indicated by the query command in the first frame.

In an example, the first A-IoT device may select one of the contention slots indicated by the query command in the first frame. The first A-IoT device may set a slot counter to initiate, trigger, and/or transmit a transmission of 2^{nd} frame via the selected slot (e.g., a D2R channel) to the reader.

In FIG. 23, the first A-IoT device may select the earliest slot among the contention slots. The earliest slot may be a slot scheduled or located earliest in the time domain among the contention slots indicated by the query command. The first A-IoT device may set the slot counter to initiate, trigger, and/or transmit a transmission of 2^{nd} frame, via the earliest slot and to the reader.

For example, the first A-IoT device may set the slot counter (e.g., count-down counter) with a value 0 indicating to initiate, trigger, and/or transmit a transmission of 2^{nd} frame, via the earliest slot (e.g., firstly present slot among the contention slots) and to the reader.

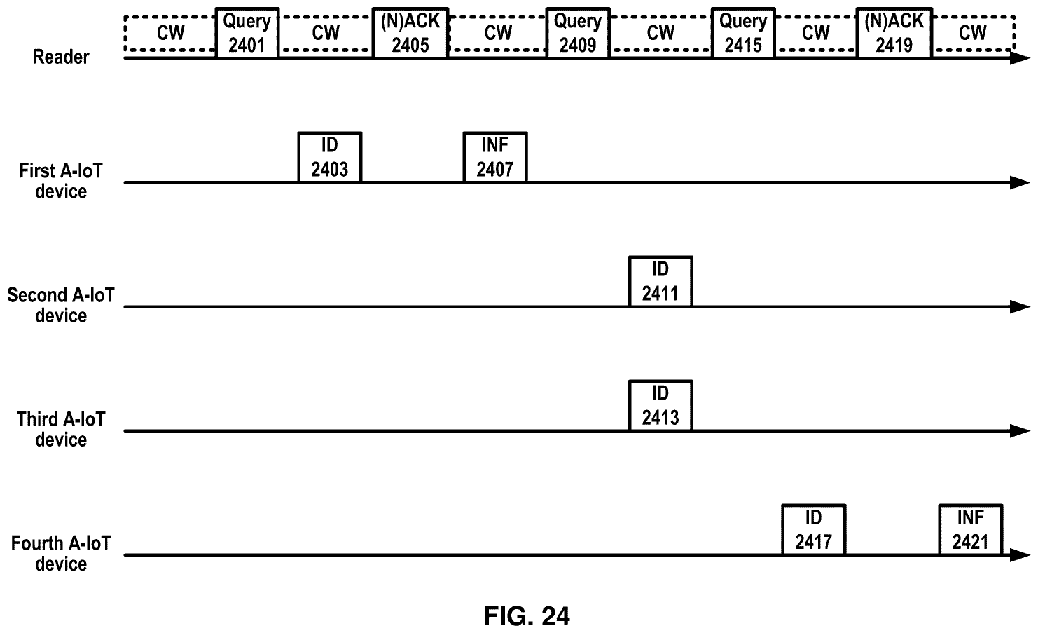

The second A-IoT device may select one of the contention slots indicated by the query command in the first frame (e.g., not shown in FIG. 23 but in FIG. 24). The second A-IoT device may set a slot counter to initiate, trigger, and/or transmit a transmission of 2^{nd} frame via the selected slot (e.g., a D2R channel) to the reader. The third A-IoT device may select one of the contention slots indicated by the query command in the first frame (e.g., not shown in FIG. 23 but in FIG. 24). The third A-IoT device may set a slot counter to initiate, trigger, and/or transmit a transmission of 2^{nd} frame via the selected slot (e.g., a D2R channel) to the reader.

For example, the second A-IoT device and/or the third A-IoT device may select the second earliest slot among the contention slots. The second earliest slot may be a slot scheduled or located second-earliest in the time domain among the contention slots indicated by the query command. The first A-IoT device may set the slot counter to initiate, trigger, and/or transmit a transmission of 2^{nd} frame, via the second earliest slot and to the reader.

For example, the second A-IoT device and/or the third A-IoT device may set the slot counter (e.g., count-down counter) with a value 1 indicating to initiate, trigger, and/or transmit a transmission of 2^{nd} frame, via the second earliest slot (e.g., firstly present slot among the contention slots) and to the reader. Each of the second A-IoT device and/or the third A-IoT device may decrement its slot counter in response to or after receiving the second type query command indicating the continuation of the inventory procedure or round initiated by the first type query command. For example, the second A-IoT device and/or the third A-IoT device may initiate, trigger, and/or transmit a transmission of 2^{nd} frame via the selected slot (e.g., a D2R channel) to the reader, e.g., in response to or after the count-down counter being a value 0.

Referring to FIG. 23, an earliest slot of the contention slots may start in response to or after the end of the 1^{st} frame with a 1^{st} time offset (e.g., T_{R2Dmin} and/or T_{R2Dmax}) as shown in FIG. 23. The 1^{st} time offset (e.g., T_{R2Dmin} and/or T_{R2Dmax}) may be a time interval or duration from a transmission of the reader to an A-IoT device response. For example, the 1^{st} time offset (e.g., T_{R2Dmin}) is a minimum time between a transmission (e.g., the 1^{st} frame) from the reader to the A-IoT device via R2D channel and the corresponding transmission (e.g., the 2^{nd} frame) from the A-IoT device to the reader via a D2R channel following it. For example, the 1^{st} time offset (e.g., T_{R2Dmax}) is a maximum time between a transmission (e.g., the 1^{st} frame) from the reader to the A-IoT device via R2D channel and the corresponding transmission (e.g., the 2^{nd} frame) from the A-IoT device to the reader via a D2R channel following it.

For example, the first A-IoT device transmits, to the reader, the second frame (e.g., via an earliest slot of the contention slots) in response to or after T_{R2Dmin} starting from the end of the first frame. For example, the reader receives, from the first A-IoT device, the second frame (e.g., via an earliest slot of the contention slots) in response to or after T_{R2Dmin} starting from the end of the first frame.

For example, the first A-IoT device transmits, to the reader, the second frame (e.g., via an earliest slot of the contention slots) before the end of T_{R2Dmax} starting from the end of the first frame. For example, the reader receives, from the first A-IoT device, the second frame (e.g., via an earliest slot of the contention slots) before the end of T_{R2Dmax} starting from the end of the first frame.

For example, a transmission or reception of the second frame (e.g., via an earliest slot of the contention slots) starts after T_{R2Dmin} starting from the end of the first frame. For example, a transmission or reception of the second frame (e.g., via an earliest slot of the contention slots) starts before the end of T_{R2Dmax} starting from the end of the first frame.

In FIG. 23, the reader and/or the one or more A-IoT devices may determine the quantity of the contention slots. In FIG. 23, the reader and/or the one or more A-IoT devices may determine a starting time and/or an end time of each slot of contention slots. In FIG. 23, the reader and/or the one or more A-IoT devices may determine a slot boundary of each slot of the contention slots.

In FIG. 23, the reader may determine a length of a preamble and/or transmit the preamble. The one or more A-IoT device may receive the preamble. The one or more A-IoT device may determine, using the preamble (and/or the length of a preamble), a length, time duration, and/or a slot boundary of each slot of contention slots. For example, the one or more A-IoT device may estimate or detect a length of the preamble, e.g., using an RF envelop detector. A length (e.g., and/or time duration, and/or a slot boundary) of each slot may be scaled by the length of the preamble. A length (e.g., and/or time duration, and/or a slot boundary) of each slot may be the length of the preamble minus one or more time offsets. A length (e.g., and/or time duration, and/or a slot boundary) of each slot may be the length of the preamble plus one or more time offsets.

For example, each slot of the contention slots may have the same time duration (e.g., the same length or the same size) in a time domain.

The time duration of the each slot of the contention slots may be predefined.

The A-IoT device may determine, select, measure, and/or estimate the time duration of the each slot of the contention slots. For example, The A-IoT device may determine, select, measure, and/or estimate a portion of the 1^{st} frame (in FIG. 23) as the time duration of the each slot of the contention slots.

For example, the time duration of the 1^{st} frame (in FIG. 23) may be the same as the time duration of the each slot of the contention slots. For example, the time duration, of the each slot of the contention slots may be the same as the time duration of the 1^{st} frame (in FIG. 23), scaled by a scaling factor. The scaling factor is predefined. A query command (e.g., Query in the 1^{st} frame) may indicate the scaling factor.

For example, the time duration of a preamble in the 1^{st} frame (in FIG. 23) may be the same as the time duration of the each slot of the contention slots. For example, the time duration of the each slot of the contention slots may be the same as the time duration, of the preamble in the 1^{st} frame (in FIG. 23), scaled by a scaling factor. The scaling factor is predefined. A query command (e.g., Query in the 1^{st} frame) may indicate the scaling factor.

For example, the time duration of a query command in the 1^{st} frame (in FIG. 23) may be the same as the time duration of the each slot of the contention slots. For example, the time duration of the each slot of the contention slots may be the same as the time duration, of the query command in the 1^{st} frame (in FIG. 23), scaled by a scaling factor. The scaling factor is predefined. A query command (e.g., Query in the 1^{st} frame) may indicate the scaling factor.

The first A-IoT device may receive, identify, detect, and/or decode a value of Q in the query command of the first frame. The first A-IoT device may determine that there are 2^{Q} contention slot(s) after the first frame. The first A-IoT device may select one slot (e.g., the earliest slot in FIG. 23) from the 2^{Q} contention slots. The selected slot by the first A-IoT device may be i-th slot where 1≤i≤2^{Q}. For example, the slot where the first A-IoT device transmits the 2^{nd} frame in FIG. 23 is the 1^{st} slot. For example, the slot where the second A-IoT device (or the third A-IoT device) transmits the 2^{nd} frame in FIG. 24 is the 2^{nd} slot.

In an example, if a slot index starts from K, an index of the selected slot by the first A-IoT device may be k where K≤k≤2^{Q}+K−1, K may be a zero or a positive integer number, and/or k=i+K−1. For example, if a slot index starts from 0, an index of the selected slot by the first A-IoT device may be k where 0≤k≤2^{Q}−1 and/or k=i−1 as shown in FIG. 22. For example, if a slot index starts from 1, an index of the selected slot by the first A-IoT device may be k where 1≤k≤2^{Q} and/or k=i.

In FIG. 23, the first A-IoT device may transmit, via the D2R channel of the selected slot (e.g., the earliest slot among the contention slots) and to the reader, the second frame. The second frame may comprise a respective preamble and an identifier (ID). For example, the identifier may be a random number that the first A-IoT device selects. The identifier may be a temporary identifier to proceed, with the reader, transmissions/receptions of a third frame and/or a fourth frame in FIG. 23.

The first A-IoT device may transmit, via the selected slot, a response (or payload) to the first frame and/or a query command in the first frame. The selected slot may be or comprise a D2R channel. The second frame in FIG. 23 may comprise the response. The response and/or the second frame may comprise an identifier of the first A-IoT device. The identifier may be a random number (or pseudo-random number) that the first A-IoT device selects. A size of random number may be fixed or predefined. For example, the random number may be m-bit random number. For example, m is equal to 16. For example, the second frame may comprise a respective preamble for synchronization of timing for the D2R channel.

In FIG. 23, the second frame may comprise a preamble for timing acquisition from the first A-IoT device to the reader. For example, the second frame comprises the preamble followed by the response in a time domain. The preamble in the second frame may be referred to as a D2R preamble. For example, the preamble in the second frame is a D2R timing acquisition signal. D2R timing acquisition signal. The preamble in the second frame may be for indicating the start of a transmission (e.g., a start of the second frame or the response) from the first A-IoT device to the reader in time domain.

The reader may monitor (or keep monitoring) the contention slots or D2R channels respective to the contention slots. The monitoring the contention slots may be for receiving a response from at least one of the one or more A-IoT devices.

In FIG. 23, the reader may receive, from the first A-IoT device and via a D2R channel, the second frame. The reader may determine, acquire, and/or adjust a timing of a transmission/reception of the second frame. The reader may identify and/or decode, using the timing, a payload part in the second frame. The reader may identify and/or receive the identifier (ID) that the first A-IoT device transmits via the second frame.

FIG. 23 shows one or more subsequent transmission/reception after or in response to the 2nd frame. For example, the one or more subsequent transmission/reception comprise the third frame (3rd frame) and/or the fourth frame (4th frame) in FIG. 23.

In an example, the one or more subsequent transmission/reception after or in response to the 2nd frame in FIG. 23 may be applicable to the inventory procedure in FIG. 22 as one or more subsequent transmission/reception after or in response to the 2^{nd} frame in FIG. 22.

In an example, the reader may transmit the 3rd frame described in FIG. 23 in response to or after the end of the last slot (e.g., 4th slot of the contention slots) in FIG. 22. For example, the 2^{nd} time offset in FIG. 23 may be applied to the end of the last slot (e.g., 4th slot of the contention slots) in FIG. 22. For example, the start of the 2^{nd} time offset in FIG. 23 may be in response to or after the end of the last slot (e.g., 4th slot of the contention slots) in FIG. 22. For example, the first A-IoT device in FIG. 22 that receives the 3rd frame from the reader transmits the 4th frame. For example, the 4th frame that the first A-IoT device transmits in FIG. 22 may be the same as the 4th frame in FIG. 23. For example, a time offset between the 3rd frame and the 4th frame in FIG. 22 may be the same as the 3rd time offset described in FIG. 23.

In FIG. 23, the reader may fail to successfully decode the second frame. For example, the reader detect and/or receive the second frame. The redear may fail to acquire timing of a transmission/reception of the second frame, e.g., from the preamble of the second frame. The redear may fail to decode the payload part in the second frame. In at least one of these case, the reader may not transmit any response or command after or in response to the second frame. Alternatively, in at least one of these case, the reader may transmit a negative-acknowledgement (NACK) command (e.g., ACK is replaced with NACK in FIG. 23).

The NACK command may be a response to the second frame. The NACK command may be a response to the identifier in the second frame. The NACK command may indicate a unsuccessful reception (e.g., decoding failure, fail to decode, and/or the like) of the second frame by the reader.

The reader may terminate, to one or more A-IoT devices comprising the first A-IoT device, the inventory round and/or the inventory procedure initiated by the first frame after or in response to transmitting the NACK command. The A-IoT device may terminate the inventory round and/or the inventory procedure initiated by the first frame after or in response to receiving the NACK command.

The reader may transmit, to the first A-IoT device, an acknowledgement (ACK) command (e.g., ACK in FIG. 23), e.g., after or in response to receiving the identifier. The reader may construct a third frame, e.g., after or in response to receiving the identifier. The third frame may comprise a respective preamble and the ACK command. The preamble in the third frame may be a timing acquisition signal for (or of) the third frame transmitted by the reader via a R2D channel. The ACK command may comprise the identifier that the reader receives in the second frame.

In FIG. 23, the reader may transmit the third frame after or in response to receiving the second frame. The time interval or duration between the (reception time of) second frame and the (transmission time of) third frame may be at least a second time offset (e.g., T_{D2Rmin} and/or T_{D2Rmax}). For example, the second time offset is predefined. For example, the time interval or duration may be equal to or longer (larger) than the second time offset. For example, the second time offset (e.g., T_{D2Rmin}) is a minimum time between a D2R transmission (e.g., the 2nd frame) and the corresponding R2D transmission (e.g., the 3rd frame) following it. For example, the second time offset (e.g., T_{D2Rmax}) is a maximum time between a D2R transmission (e.g., the 2^{nd} frame) and the corresponding R2D transmission (e.g., the 3rd frame) following it. For example, the D2R transmission comprises a transmission of the second frame via a respective D2R channel. For example, the R2D transmission comprises a transmission of the third frame via a respective R2D channel.

For example, the reader transmits, to the first A-IoT device, the third frame in response to or after T_{D2Rmin} starting from the end of the second frame. For example, the first A-IoT device receives, from the reader, the third frame in response to or after T_{D2Rmin} starting from the end of the second frame.

For example, the reader transmits, to the first A-IoT device, the third frame before the end of T_{D2Rmax} starting from the end of the second frame. For example, the first A-IoT device receives, from the reader, the third frame before the end of T_{D2Rmax} starting from the end of the second frame.

For example, a transmission or reception of the third frame starts after T_{D2Rmin} starting from the end of the second frame. For example, a transmission or reception of the third frame starts before the end of T_{D2Rmax} starting from the end of the second frame.

For example, the 2^{nd} time offset in FIG. 23 may be applied to FIG. 22. For example, the reader in FIG. 22 transmits, to the first A-IoT device, the third frame in response to or after T_{D2Rmin} starting from the end of the last slot (e.g., 4^{th} slot or slot #3) of the contention slots in FIG. 22. For example, the first A-IoT device receives, from the reader, the third frame in response to or after T_{D2Rmin} starting from the end of the last slot (e.g., 4^{th} slot or slot #3) of the contention slots in FIG. 22.

In FIG. 22, for example, the reader transmits, to the first A-IoT device, the third frame before the end of T_{D2Rmax} starting from the end of the last slot (e.g., 4^{th} slot or slot #3) of the contention slots in FIG. 22. For example, the first A-IoT device receives, from the reader, the third frame before the end of T_{D2Rmax} starting from the end of the last slot (e.g., 4^{th} slot or slot #3) of the contention slots in FIG. 22.

In FIG. 22, for example, a transmission or reception of the third frame starts after T_{D2Rmin} Starting from the end of the last slot (e.g., 4^{th} slot or slot #3) of the contention slots in FIG. 22. For example, a transmission or reception of the third frame starts before the end of T_{D2Rmax} starting from the end of the last slot (e.g., 4^{th} slot or slot #3) of the contention slots in FIG. 22.

In FIG. 23, the ACK command may be a response to the second frame. The ACK command may be a response to the identifier in the second frame. The ACK command may indicate a successful reception of the second frame by the reader. The ACK command may initiate a transmission, by the first A-IoT device, of a fourth frame subsequent to the third frame.

In FIG. 23, the first A-IoT device may receive the third frame. The first A-IoT device may detect the preamble in the third frame. The first A-IoT device may determine a length or size of the third frame based on the length of the preamble detected as a part of the third frame. For example, the length or the size of the third frame may be proportional to the length of the preamble in the third frame. For example, the length or the size of the third frame may be the length of the preamble, in the third frame, minus one or more time offset. For example, the length or the size of the third frame may be the length of the preamble, in the third frame, plus one or more time offset.

In FIG. 23, the first A-IoT device decode a payload part of the third frame. The preamble may be followed by a payload part in the third frame. The payload part of the third frame may comprise a field whose corresponding value indicating that the payload comprise an ACK command. For example, the value corresponding to the field in the third frame is an identifier identifying the ACK command among one or more commands. The ACK command may comprise a field whose corresponding field value indicating a value.

The ACK command may comprise an identifier (ID) field. The ID field may indicate that the ACK command is a response to a particular second frame. For example, a value in the ID field may indicate an ID that the reader receive in the second frame.

The third frame described in FIG. 23 may be applied to FIG. 22. For example, the first A-IoT device in FIG. 22 may receive the third frame in response to or after transmitting the second frame.

The first A-IoT device (e.g., in FIG. 22 and/or FIG. 23) may determine whether the value in the ID field in the ACK command is the same as (or matched with) the identifier (ID) that the first A-IoT device transmits in the second frame. The first A-IoT device may determine the ACK command is valid for or as the response (and/or ID) in the second frame if the value in the ID field in the ACK command is the same as (or matched with) the ID that the first A-IoT device transmits in the second frame. The first A-IoT device may determine the ACK command is not valid (or is invalid) for or as the response (and/or ID) in the second frame, e.g., if the value in the ID field in the ACK command is not the same as (or is not matched with) the identifier (ID) that the first A-IoT device transmits in the second frame.

The first A-IoT device (e.g., in FIG. 22 and/or FIG. 23) may not transmit a response to the third frame (and/or the ACK command), e.g., if the first A-IoT device determines the ACK command is not valid (or is invalid) for or as the response (and/or ID) in the second frame. The first A-IoT device may not transmit a response to the third frame (and/or the ACK command), e.g., if the value in the ID field in the ACK command is not the same as (or is not matched with) the identifier (ID) that the first A-IoT device transmits in the second frame.

The first A-IoT device (e.g., in FIG. 22 and/or FIG. 23) may transmit a response to the third frame (and/or the ACK command), e.g., if the first A-IoT device determines the ACK command is valid for or as the response (and/or ID) in the second frame. The first A-IoT device may not transmit a response to the third frame (and/or the ACK command), e.g., if the value in the ID field in the ACK command is the same as (or is matched with) the identifier (ID) that the first A-IoT device transmits in the second frame.

The response to the third frame may be the fourth frame in FIG. 23. For example, the third frame may initiate a transmission of the fourth frame. For example, the first A-IoT device may transmit, to the reader via a D2R channel, the fourth frame as the response to the third frame (or the ACK command).

The fourth frame described in FIG. 23 may be applied to FIG. 22. For example, the first A-IoT device in FIG. 22 may transmit the fourth frame as a response to the third frame, e.g., in response to or after receiving the third frame.

In FIG. 23 (and/or in FIG. 22), the first A-IoT device may transmit, via a D2R channel, the fourth frame after or in response to receiving the third frame. In FIG. 23 (and/or in FIG. 22), the redear may receive, via the D2R channel, the fourth frame after or in response to transmitting the third frame.

The time interval or duration between the (reception time of) third frame and the (transmission time of) fourth frame may be at least a third time offset. For example, the third time offset is predefined. For example, the time interval or duration may be equal to or longer (larger) than the third time offset.

For example, the third time offset is the same as (or is equal to) the first time offset in FIG. 23. For example, the first time offset and/or the third time offset (T_{R2Dmin}) is a minimum time between a R2D transmission and the corresponding R2D transmission following it. For example, the first time offset and/or the third time offset (T_{R2Dmax}) is a maximum time between a R2D transmission and the corresponding R2D transmission following it. For example, the R2D transmission comprises a transmission of the first frame via a respective R2D channel. For example, the R2D transmission comprises a transmission of the third frame via a respective R2D channel. For example, the D2R transmission comprises a transmission of the second frame via a respective D2R channel. For example, the D2R transmission comprises a transmission of the fourth frame via a respective D2R channel.

For example, the third time offset is different from the first time offset in FIG. 23. For example, the third time offset is the first time offset plus an time offset value. For example, the third time offset is the first time offset minus an time offset value. For example, the third time offset is predefined separately from the first time offset. For example, the third time offset is configured separately from the first time offset.

For example, the first A-IoT device transmits, to the reader, the fourth frame in response to or after T_{R2Dmin} starting from the end of the third frame. For example, the reader receives, from the first A-IoT device, the fourth frame in response to or after T_{R2Dmin} starting from the end of the third frame.

For example, the first A-IoT device transmits, to the reader, the fourth frame before the end of T_{R2Dmax} starting from the end of the third frame. For example, the reader receives, from the first A-IoT device, the fourth frame before the end of T_{R2Dmax} starting from the end of the third frame.

For example, a transmission or reception of the fourth frame starts after T_{R2Dmin} starting from the end of the third frame. For example, a transmission or reception of the fourth frame starts before the end of T_{R2Dmax} starting from the end of the third frame.

In FIG. 23, the fourth frame may comprise a preamble and an information (INF) field.

The INF field may comprise a value indicating a second ID of the first A-IoT device.

For example, the second ID is a uniquely assigned ID for the first A-IoT device. For example, the reader or network allocates or assigns the second ID to the first A-IoT device, e.g., before the inventory procedure (and/or round). For example, the reader or network writes the second ID on the first A-IoT device, e.g., before the inventory procedure (and/or round). For example, the reader or network sends or transmits the second ID on the first A-IoT device, e.g., before the inventory procedure (and/or round).

The fourth frame in FIG. 23 may comprise a message comprising the INF field. The message may be a NAS message.

For example, the second ID is a device ID identifying the first A-IoT device. For example, the second ID may be an ID used in an application layer of the first A-IoT device (and/or of the reader/network). For example, the second ID is an ID, of the first A-IoT device, registered to the reader or the network. For example, the second ID is a global ID used in the network for identifying the first A-IoT device. For example, the second ID is a physical ID used in the network for identifying the first A-IoT device.

For example, the second ID may be an International Mobile Equipment Identifier (IMEI), e.g., assigned to the first A-IoT device at the time of manufacturing.

For example, the second ID may be an International Mobile Subscriber Identity (IMSI), e.g., assigned to the first A-IoT device by a service provider or telecom carrier. For example, the second ID is stored on a SIM card.

For example, the second ID may be a Temporary Mobile Subscriber Identity (TMSI), e.g., assigned to the first A-IoT device by a network entity (e.g., Visitor Location Register).

For example, the ID in the second frame is a temporary ID. For example, the ID in the second frame is an ID that the first A-IoT device selects for the inventory procedure (and/or round). For example, the ID in the second frame is different from the second ID. For example, a size of field indicating the ID in the second frame is different from a size of field indicating the second ID in the fourth frame.

One or more A-IoT devices may select the same ID as the one to be included in the second frame during the inventory procedure. For example, each of the one or more A-IoT devices has a respective second ID that is different from other A-IoT devices' second IDs.

For example, the second ID may be hard-coded (e.g., (pre-) programmed) to the first A-IoT device. For example, the first A-IoT device stores the ID in the second frame in a first A-IoT device memory. The first A-IoT device and/or the reader may change information stored in the first A-IoT device memory. The first A-IoT device may overwrite or replace the ID with another ID (e.g., selected in a different inventory procedure or round) in the first A-IoT device memory. For example, the first A-IoT device stores the second ID in the fourth frame in a second A-IoT device memory. The first A-IoT device and/or the reader may not change information stored in the second A-IoT device memory.

In FIG. 23, the A-IoT device may receive one or more continuous wave (or referred to as a continuous waveform) (CW). The CW may be for energy harvesting of (e.g., may be for energizing) one or more A-IoT devices comprising the first A-IoT device. The reader may transmit the CW. A separate device (e.g., RF transmitter/emitter) other than the reader may transmit the CW.

The first A-IoT may harvest an energy from the CW. For example, the A-IoT may be energized in response to receiving the CW. The CW may comprise the transmission of the first frame. The CW may comprise the transmission of the third frame. The CW may comprise a CW before the transmission of the first frame in FIG. 23. The CW may comprise a CW between the transmissions of the first frame and the third frame in FIG. 23. The CW may comprise a CW after the transmission of the third frame in FIG. 23.

The transmission from the first A-IoT device may be a backscatter modulated information signal described in FIG. 17, FIG. 18, and/or FIG. 19. The backscatter modulated information signal may be referred to as a backscatter signal. For example, the first A-IoT device may generate, amplify, and/or transmit the backscatter signal using the stored energy harvested from the CW.

For example, the transmission of the second frame comprises a backscatter modulated information signal using the stored energy harvested from the CW before or prior to the transmission of the second frame. For example, the transmission of the fourth frame comprises a backscatter modulated information signal using the stored energy harvested from the CW before or prior to the transmission of the fourth frame.

The reader may receive, from the first A-IoT device, the fourth frame via the D2R channel. The reader may successfully decode the received fourth frame. The reader may fail to (may unsuccessfully) decode the received fourth frame.

The reader may terminate the initiated inventory procedure or round in FIG. 23, e.g., after or in response to receiving the fourth frame. The reader may terminate the initiated inventory procedure or round in FIG. 23, e.g., after or in response to successfully decode the received fourth frame. The reader may terminate the initiated inventory procedure or round in FIG. 23, e.g., after or in response to failing to decode the received fourth frame.

The reader may repeat the inventory round described in FIG. 23 for other A-IoT devices in a proximity area of the reader. Each inventory round may be a inventory procedure. One inventory procedure may comprise one or more inventory rounds, each inventory round being described in FIG. 23.

The reader may transmit a second query command. The second query command may be a second type query command indicating the continuation of the inventory procedure or round initiated by the first type query command. The second query command may comprise a field indicating that the second query command is the second type query command.

An A-IoT device that receives the second query command may decrement its slot counter by one, e.g., if the A-IoT device does receives the first query command (e.g., 1^{st} frame in FIG. 23) and/or if the A-IoT device has not transmit the 2nd frame until receiving the second query command. The detailed description will be in FIG. 24.

FIG. 24 illustrate an aspect of example embodiments according to the present disclosure. FIG. 24 shows an inventory procedure between the reader and three A-IoT devices. FIG. 24 may refer to signaling, a command structure, and/or reader/A-IoT behaviors described in FIG. 22 and/or FIG. 23.

For example, the query command in the first frame (1st frame) in FIG. 22 and/or FIG. 23 comprises the Query 2401 (and/or Query 2409 and/or Query 2415) in FIG. 24. The Query 2401 (and/or Query 2409 and/or Query 2415) in FIG. 24 may be the simplified description of the first frame and/or the query command in the first frame in FIG. 22 and/or FIG. 23 for sake of simplicity in the drawing. For example, each of the Query 2401, Query 2409, and/or Query 2415 in FIG. 24 may comprise a respective preamble and/or a respective query command as shown in the first frame in FIG. 22 and/or FIG. 23.

For example, the first frame (2nd frame) and/or ID in the second frame in FIG. 22 and/or FIG. 23 comprises ID 2403 (and/or ID 2411, ID 2413, and/or ID 2417) in FIG. 24. The ID 2403 (and/or ID 2411, ID 2413, and/or ID 2417) in FIG. 24 may be the simplified description of the second frame and/or the ID in the second frame in FIG. 22 and/or FIG. 23 for sake of simplicity in the drawing. For example, each of the ID 2403 (and/or ID 2411, ID 2413, and/or ID 2417) in FIG. 24 may be in a respective frame comprising a respective preamble as shown in FIG. 22 and/or FIG. 23.

For example, the third frame (3rd frame) and/or ACK in the third frame in FIG. 23 comprises (N)ACK 2405 (and/or (N)ACK 2419) in FIG. 24. The (N)ACK 2405 (and/or (N)ACK 2419) in FIG. 24 may be the simplified description of the third frame and/or the ACK in the third frame in FIG. 23 for sake of simplicity in the drawing. For example, each of the (N)ACK 2405 (and/or (N)ACK 2419) in FIG. 24 may be in a respective frame comprising a respective preamble as shown in FIG. 23.

For example, the fourth frame (4th frame) and/or INF in the fourth frame in FIG. 23 comprises INF 2407 (and/or INF 2421) in FIG. 24. The INF 2407 (and/or INF 2421) in FIG. 24 may be the simplified description of the fourth frame and/or the INF in the fourth frame in FIG. 23 for sake of simplicity in the drawing. For example, each of INF 2407 (and/or INF 2421) in FIG. 24 may be in a respective frame comprising a respective preamble as shown in FIG. 23.

For example, in FIG. 24, Query 2401, ID 2403, (N)ACK 2405, and INF 2407 are representing the 1st frame, the 2nd frame, the 3rd frame, and the 4th frame, respectively. For example, in FIG. 24, Query 2401, ID 2403, (N)ACK 2405, and INF 2407 represent the Query, the ID, the ACK, and the INF, respectively.

For example, Query 2401, ID 2403, (N)ACK 2405, and INF 2407 in FIG. 24 are the simplified drawing and/or representing, respectively, the 1^{st} frame, 2^{nd} frame, 3^{rd} frame, and the 4^{th} frame in FIG. 23.

For example, in FIG. 24, the signalings in and/or after Query 2409 may be the subsequent signalings after or in response to the inventory procedure or round described in FIG. 23. For example, the reader in FIG. 23 continues the inventory procedure by transmitting/sending one or more query commands (e.g., Query 2409 and/or Query 2415).

For example, the Query 2401 may comprise a first field indicating a first quantity of contention slots as described in FIG. 22 and/or FIG. 23. Q₁ and 2^{Q}^{₁}, respectively, denote a value of the first field and the first quantity of the first contention slots indicated by the value of the first field.

The Query 2401 may comprise another field indicating that the Query 2401 is the first type query command initiating an inventory procedure or round.

In FIG. 24, one or more A-IoT devices receives the Query 2401. Each of the one or more A-IoT devices may select one respective slot out of the first contention slots (e.g., 2^{Q}^{₁} slots), e.g., in response to receiving the Query 2401. Each of the one or more A-IoT devices may select one respective slot out of the first contention slots (e.g., 2^{Q}^{₁} slots), e.g., in response to the Query 2401 being the first type query command initiating an inventory procedure or round.

Each of the one or more A-IoT devices may set a respective slot counter to a value corresponding to the selected slot. The present description considers a count-down counter as an example implementation of the slot counter that each of the one or more A-IoT devices are using. For example, an A-IoT device may initiate, trigger, and/or transmit the 2^{nd} frame (e.g., in FIG. 23), e.g., in response to or after the count-down counter being with a value 0.

For example, in FIG. 24, the first A-IoT device selects an earliest slot (e.g., firstly present slot) among the first contention slots (e.g., 2^{Q}^{₁} slots), e.g., in response to receiving the Query 2401. The first A-IoT devices may set a respective slot counter to a value of 0, which corresponds to the earliest slot.

For example, in FIG. 24, the second A-IoT device selects a second earliest slot (e.g., secondly present slot) among the first contention slots (e.g., 2^{Q}^{₁} slots), e.g., in response to receiving the Query 2401. The second A-IoT devices may set a respective slot counter to a value of 1, which corresponds to the second earliest slot.

For example, in FIG. 24, the third A-IoT device selects a second earliest slot (e.g., secondly present slot) among the first contention slots (e.g., 2^{Q}^{₁} slots), e.g., in response to receiving the Query 2401. The third A-IoT devices may set a respective slot counter to a value of 1, which corresponds to the second earliest slot.

For example, in FIG. 24, the fourth A-IoT device selects a third earliest slot (e.g., thirdly present slot) among the first contention slots (e.g., 2^{Q}^{₁} slots), e.g., in response to receiving the Query 2401. The fourth A-IoT devices may set a respective slot counter to a value of 2, which corresponds to the third earliest slot.

For example, in FIG. 24, counting the first contention slots starts in response to or after receiving Query 2401. The earliest slot among the first contention slots may be present in response to or after receiving Query 2401.

In FIG. 24, in response to or after receiving Query 2401 and according to the example embodiments of the present disclosure, slot counter values of the slot counters of the first A-IoT device, the second A-IoT device, the third A-IoT device, and the fourth A-IoT device are 0, 1, 1, 2, respectively.

In FIG. 24, the first A-IoT device may transmit, to the reader, ID 2403 (e.g., the second frame in FIG. 23) in response to a slot counter, of the first A-IoT device, being with a value 0. The reader may receive ID 2403.

In FIG. 24, the reader may transmit, to the first A-IoT device, (N)ACK 2405 (e.g., the third frame in FIG. 23), e.g., in response to or after receiving the ID 2403. The first A-IoT device may receive, from the reader, (N)ACK 2405.

In FIG. 24, the first A-IoT device may transmit, to the reader, INF 2407 (e.g., the fourth frame in FIG. 23), e.g., in response to or after receiving (N)ACK 2405. The reader may receive, from the first A-IoT device, INF 2407.

After or in response to receiving INF 2407, the reader may determine to continue the inventory procedure or round initiated by Query 2401. The reader may transmit, to one or more A-IoT devices, Query 2409.

Query 2409 in FIG. 24 may be a second type query command. For example, Query 2409 may comprise a field indicating that the Query 2409 is the second type query command. Query 2409 may not comprise a field indicating any quantity of contention slots, e.g., in response to the Query 2409 being the second type query command.

An A-IoT device may decrement a respective slot counter by 1, e.g., in response to or after receiving the second type query command. For example, one or more A-IoT devices in FIG. 24 may decrement their respective slot counters by 1, e.g., in response to or after receiving the Query 2409 and/or determining that the Query 2409 is the second type query command.

For example, an A-IoT device that transmits ID (e.g., ID 2403, ID 2411, ID 2413, and/or ID 2417) as a response to Query (e.g., Query 2401, Query 2409, and/or Query 2415) and/or that transmits, to the reader, INF (e.g., INF 2407 and/or INF 2421) may not decrement a respective slot counter and/or disable to transmit ID as a response to a next Query received from the reader during a same inventory procedure or round.

For example, an A-IoT device that transmits ID (e.g., ID 2403, ID 2411, ID 2413, and/or ID 2417) as a response to Query (e.g., Query 2401, Query 2409, and/or Query 2415) and/or that transmits, to the reader, INF (e.g., INF 2407 and/or INF 2421) may set a respective slot counter with a large value. The large value may be larger than a number of contention slots indicated by Query 2401 (e.g., the first type query command). For example, the large value may be 7FFF in hexadecimal. Setting the respective slot counter with the large value may prevent subsequent replies during the same inventory procedure or round.

In FIG. 24, the second A-IoT device, the third A-IoT device, and the fourth A-IoT device may decrement their respective slot counters by one.

For example, in response to or after receiving Query 2409 and according to the example embodiments of the present disclosure, slot counter values of the slot counters of the second A-IoT device, the third A-IoT device, and the fourth A-IoT device are 0, 0, 1, respectively. For example, the slot counter value 0 of the slot counters of the second A-IoT device and the third A-IoT device may result in transmitting ID (e.g., ID 2411 and/or ID 2413).

In FIG. 24, the second A-IoT device may transmit ID 2411, e.g., in response to or after receiving Query 2409. For example, the second A-IoT device transmits ID 2411, e.g., in response to or after a respective slot counter being with the value 0. The format of the ID 2411 may be the same as the third frame in FIG. 23. For example, ID 2411 may comprise a preamble and/or a payload part comprising a field indicating an identifier (ID, e.g., temporary identifier) of the second A-IoT device.

In FIG. 24, the third A-IoT device may transmit ID 2413, e.g., in response to or after receiving Query 2409. For example, the third A-IoT device transmits ID 2413, e.g., in response to or after a respective slot counter being with the value 0. The format of the ID 2413 may be the same as the third frame in FIG. 23. For example, ID 2413 may comprise a preamble and/or a payload part comprising a field indicating an identifier (ID, e.g., temporary identifier) of the third A-IoT device.

In FIG. 24, a transmission of ID 2411 from the second A-IoT device may overlap at least in part with a transmission of ID 2413 in time domain. Overlapping between the transmission of ID 2411 and the transmission of ID 2413 may result from the same slot (e.g., second earliest slot among the one or more contention slots) selected by the second A-IoT device and the third A-IoT device.

In FIG. 24, the reader may not receive and/or decode successfully both ID 2411 and ID 2413. The reader may not respond to ID 2411 and/or ID 2413, e.g., in response to or after not receiving and/or not decoding successfully ID 2411 and/or ID 2413. The reader may detect or determine a conflict among one or more transmissions of IDs (e.g., comprising ID 2411 and/or ID 2413) from one or more A-IoT devices (e.g., comprising the second A-IoT device and/or the third A-IoT device).

In FIG. 24, the second A-IoT device and/or the third A-IoT device may wait for a response (from the reader) to ID 2411 and/or ID 2413. For example, the second A-IoT device and/or the third A-IoT device may wait for a response (from the reader) to ID 2411 and/or ID 2413 during the 2^{nd} time offset (e.g., T_{D2Rmin} or T_{D2Rmax}) described in FIG. 23. The second A-IoT device and/or the third A-IoT device may determine that a reception of a response (from the reader) to ID 2411 and/or ID 2413 is failed or is not successful, e.g., in response to or after not receiving the response during the 2^{nd} time offset (e.g., T_{D2Rmin} or T_{D2Rmax}) that starts from the end of the ID 2411 and/or ID 2413.

As described in the present disclosure, the second A-IoT device and/or the third A-IoT device that transmits ID (e.g., ID 2403, ID 2411, ID 2413, and/or ID 2417) as a response to Query (e.g., Query 2401, Query 2409, and/or Query 2415) may not decrement a respective slot counter and/or disable to transmit ID as a response to a next Query received from the reader during a same inventory procedure or round.

For example, in response to or after transmitting ID (e.g., ID 2411 and/or ID 2413) and/or determining a reception of a response (to ID 2411 and/or ID 2413) failed or not successful, the second A-IoT device and/or the third A-IoT device may set their respective slot counters with a large value (e.g., being larger than a number of contention slots indicated by Query 2401 and/or being 7FFF in hexadecimal).

In FIG. 24, the reader may continue the inventory procedure or round initiated by Query 2401, e.g., after transmitting Query 2409 and/or after failing receiving or decoding ID 2411 (and/or ID 2413). The reader may transmit Query 2415. Query 2415 may be the second type query command.

For example, one or more A-IoT devices in FIG. 24 may decrement their respective slot counters by 1, e.g., in response to or after receiving the Query 2415 and/or determining that the Query 2415 is the second type query command. In FIG. 24, the fourth A-IoT device may decrement a respective slot counter by one.

For example, in response to or after receiving Query 2415 and according to the example embodiments of the present disclosure, a slot counter value of the slot counter of the fourth A-IoT device is 0. For example, the slot counter value 0 of the slot counters of the fourth A-IoT device may result in transmitting ID (e.g., ID 2417).

In FIG. 24, the fourth A-IoT device may transmit ID 2417, e.g., in response to or after receiving Query 2415. For example, the fourth A-IoT device transmits ID 2417, e.g., in response to or after a respective slot counter being with the value 0. The format of the ID 2417 may be the same as the third frame in FIG. 23. For example, ID 2417 may comprise a preamble and/or a payload part comprising a field indicating an identifier (ID, e.g., temporary identifier) of the fourth A-IoT device.

In FIG. 24, the reader may receive ID 2417 from the fourth A-IoT device. The reader may transmit, to the fourth A-IoT device, (N)ACK 2419 (e.g., the third frame in FIG. 23), e.g., in response to or after receiving the ID 2417. The fourth A-IoT device may receive, from the reader, (N)ACK 2419.

(N)ACK 2419 may comprise the identifier (ID, e.g., temporary identifier) that the fourth A-IoT device include ID 2417. The fourth A-IoT device may determine that an (N)ACK 2419 is a response to ID 2417, e.g., in response to an identifier in (N)ACK 2419 being the same as the identifier in ID 2417.

In FIG. 24, the fourth A-IoT device may transmit, to the reader, INF 2421 (e.g., the fourth frame in FIG. 23), e.g., in response to or after receiving (N)ACK 2419. The reader may receive, from the first A-IoT device, INF 2421. INF 2421 may comprise a second ID of the fourth A-IoT device. For example, the second ID is a unique ID (e.g., TMSI, IMSI, IMEI, and/or the like) assigned to the fourth A-IoT device at the time of manufacturing, by a service provider and/or by a network entity.

In FIG. 24, after or in response to receiving INF 2421, the reader transmit another second type query command, e.g., to continue the inventory procedure or round initiated by Query 2401.

In FIG. 24, after or in response to receiving INF 2421, the reader may not transmit any command, e.g., if the reader determines to terminate the inventory procedure or round initiated by Query 2401.

In FIG. 24, after or in response to receiving INF 2421, the reader may transmit a first type query command, e.g., if the reader determines to initiate a new inventory procedure or round different from the one initiated by Query 2401.

In FIG. 24, the A-IoT device may receive one or more continuous wave (or referred to as a continuous waveform) (CW). The CW may be for energy harvesting of (e.g., may be for energizing) one or more A-IoT devices comprising at least one of the first A-IoT device, the second A-IoT device, or the third A-IoT device. The reader may transmit the CW as described in FIG. 23. A separate device (e.g., RF transmitter/emitter) other than the reader may transmit the CW as described in FIG. 23.

The at least one of the first A-IoT device, the second A-IoT device, the third A-IoT device, or the fourth A-IoT device may harvest an energy from the CW. For example, the at least one of the first A-IoT device, the second A-IoT device, the third A-IoT device, or the fourth A-IoT device may be energized in response to receiving the CW. The CW may comprise the transmission of at least one of Query 2401, (N)ACK 2405, Query 2409, Query 2415, or (N)ACK 2419. The CW may comprise a CW in FIG. 24 before any transmission of the at least one of Query 2401, (N)ACK 2405, Query 2409, Query 2415, or (N)ACK 2419. In FIG. 24, the CW may comprise a CW between any two transmissions of the at least one of Query 2401, (N)ACK 2405, Query 2409, Query 2415, or (N)ACK 2419. The CW may comprise a CW after any transmission of at least one of Query 2401, (N)ACK 2405, Query 2409, Query 2415, or (N)ACK 2419.

The transmission from at least one of the first A-IoT device, the second A-IoT device, the third A-IoT device, or the fourth A-IoT device may be a backscatter modulated information signal described in FIG. 17, FIG. 18, FIG. 19, and/or FIG. 20. The backscatter modulated information signal may be referred to as a backscatter signal. For example, the at least one of the first A-IoT device, the second A-IoT device, the third A-IoT device, or the fourth A-IoT device may generate, amplify, and/or transmit the backscatter signal using the stored energy harvested from the CW.

In the present disclosure, Q or 2^{Q} may indicate a quantity of contention slots. For example, a quantity of contention slots may be 2^{Q}. For example, indicating, determining, comprising a value indicating Q may comprise and/or may be interchangeable with indicating, determining, comprising a quantity of contention slots, 2^{Q}. For example, indicating, determining, comprising a value indicating 2^{Q} may comprise and/or may be interchangeable with indicating, determining, comprising a quantity of contention slots, 2^{Q}.

The inventory procedure or round described from FIG. 22 to FIG. 24 may comprise a four message transmissions, e.g., to identify an A-IoT device.

For example, the four message transmissions may comprise a first transmission of a first frame (e.g., referred to as Msg0) in FIG. 22 and/or FIG. 23. The first transmission of a first frame (e.g., referred to as Msg0) may comprise Query 2401, Query 2409, and/or Query 2415 in FIG. 24.

For example, the four message transmissions may comprise a second transmission of a second frame (e.g., referred to as Msg1) in FIG. 23. The second transmission of a second frame (e.g., referred to as Msg1) may comprise ID 2403, ID 2411, ID 2413, and/or ID 2417 in FIG. 24.

For example, the four message transmissions may comprise a third transmission of a third frame (e.g., referred to as Msg2) in FIG. 23. The third transmission of a third frame (e.g., referred to as Msg2) may comprise (N)ACK 2405 and/or (N)ACK 2419 in FIG. 24.

For example, the four message transmissions may comprise a fourth transmission of a fourth frame (e.g., referred to as Msg3) in FIG. 22 and/or FIG. 23. The fourth transmission of a fourth frame (e.g., referred to as Msg3) may comprise INF 2407 and/or INF 2421 in FIG. 24.

In the present disclosure, an inventory procedure (or round) based on the four message transmissions may be referred to as a first type of inventory procedure, an inventory procedure using/with/based on the first type. For example, the first type may indicate the four message transmissions to identify an A-IoT device during an inventory procedure.

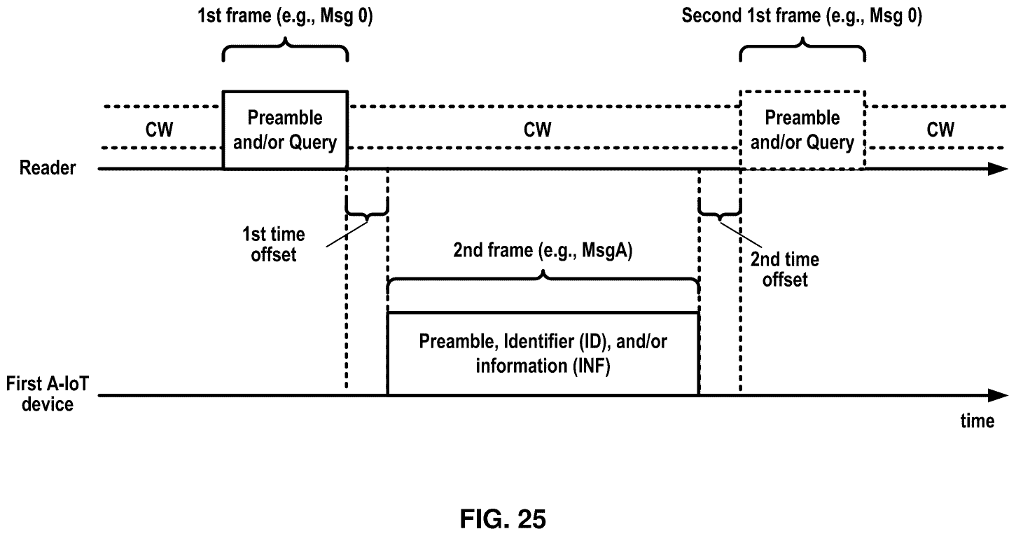

FIG. 25 illustrates an example as per an aspect of an embodiment of the present disclosure. The inventory procedure or round described in FIG. 25 may comprise a two message transmissions, e.g., to identify an A-IoT device. In the present disclosure, an inventory procedure (or round) based on the two message transmissions may be referred to as a second type of inventory procedure, an inventory procedure using/with/based on the second type. For example, the second type may indicate the two message transmissions to identify an A-IoT device during an inventory procedure.

For example, the two message transmissions may comprise a first transmission of a first frame (e.g., referred to as Msg0) in FIG. 25. The first frame in FIG. 25 may be the same as the first frame in FIG. 22 and/or FIG. 23.

For example, the first frame in FIG. 25 may comprise a preamble and/or a payload part. The payload part may carry or comprise a query command. The query command may be the first type query command. The query command may initiate an inventory procedure comprising a two message transmissions described in FIG. 25. The query command may be the second type query command. The query command may continue an inventory procedure (comprising a two message transmissions to identify an A-IoT device) initiated by a previous query command.

For example, the query command in FIG. 25 comprises a field indicating a number of contention slots (e.g., 2° slots). The field may indicate a value Q or a value 2^{Q}. The number of contention slots may be 2^{Q} slots.

For example, the reader in FIG. 25 transmits the first frame to one or more A-IoT devices. At least one A-IoT device among the one or more A-IoT devices may receive the first frame. For example, the at least one A-IoT device comprises a first A-IoT device in FIG. 25.

Each of the one or more A-IoT devices may determine or select one slot out of the contention slots indicated by the query command in FIG. 25. Each of the one or more A-IoT devices may set a respective slot counter with a value indicating the selected slot out of the contention slots.

In FIG. 25, the first A-IoT device may select an earliest slot among the contention slots. The first A-IoT device may set its slot counter with a value 0 indicating the earliest slot among the contention slots.

For the case of slot counter being a count-down counter, each of the one or more A-IoT devices may decrement a respective slot counter by 1, e.g., in response to or after receiving another query command (e.g., the second type query command) indicating to continue the ongoing inventory procedure or round initiated by the first frame (or query in the first frame) in FIG. 25.

For the case of slot counter being a count-down counter, each of the one or more A-IoT devices may initiate, trigger, and/or transmit a second frame, e.g., in response to or after a respective slot counter being with a value 0.

In FIG. 25, the first A-IoT device may transmit, to the reader, a second frame. The second frame may be referred to as Message A, A-IoT message A, MsgA, and/or the like. The second frame in FIG. 25 may comprise at least one of a preamble, a first identifier (ID) of the first A-IoT device, and information (INF) of the first A-IoT device.

For example, a preamble in the second frame in FIG. 25 is for the timing acquisition (or time synchronization) by the reader to receive, detect, and/or decode the second frame.

For example, the first ID in the second frame in FIG. 25 may be the same as the ID in the second frame in FIG. 22 and/or FIG. 23. For example, the first ID in the second frame in FIG. 25 may be the same as ID 2403, ID 2411, ID 2413, and/or ID 2417 in FIG. 24. For example, the first ID in the second frame in FIG. 25 may be a temporary ID for contention resolution among the one or more A-IoT devices. For example, the first ID may be an ID generated by a physical layer or an MAC layer of the first A-IoT device.

For example, the INF in the second frame in FIG. 25 may be the same as the INF in the fourth frame in FIG. 23. For example, the INF in the second frame in FIG. 25 may be the same as INF 2407 and/or INF 2421 in FIG. 24.

For example, the INF in the second frame in FIG. 25 may comprise a second ID of the first A-IoT device to be used by a network (e.g., reader, core network) for identifying the first A-IoT device. For example, the second ID is a unique ID (e.g., TMSI, IMSI, IMEI, and/or the like) assigned to the first A-IoT device at the time of manufacturing, b a service provider and/or by a network entity. The INF may comprise an NAS message. The NAS message may comprise and/or indicate the second ID.

In FIG. 25, the first A-IoT device may transmit, to the reader, the second frame, e.g., in response to or after the end of a first time offset (e.g., T_{R2Dmin} and/or T_{R2Dmax}) that starts in response to or after the end of the first frame in FIG. 25.

The first time offset (e.g., T_{R2Dmin} and/or T_{R2Dmax}) in FIG. 25 may be a time interval or duration from a transmission of the reader to an A-IoT device response. For example, the first time offset may be the same as the time offset in FIG. 22 and/or the first time offset in FIG. 23.

For example, the first time offset (e.g., T_{R2Dmin}) in FIG. 25 is for the second type inventory procedure. The first time offset (e.g., T_{R2Dmin}) in FIG. 25 may be a minimum time between a transmission (e.g., the first frame) from the reader to the A-IoT device via R2D channel and the corresponding transmission (e.g., the second frame) from the A-IoT device to the reader via a D2R channel following it.

For example, the first time offset (e.g., T_{R2Dmax}) in FIG. 25 is for the second type inventory procedure. The first time offset (e.g., T_{R2Dmax}) in FIG. 25 may be a maximum time between a transmission (e.g., the first frame) from the reader to the A-IoT device via R2D channel and the corresponding transmission (e.g., the second frame) from the A-IoT device to the reader via a D2R channel following it.

For example, the first A-IoT device may start the transmission of the second frame in FIG. 25 at least after the end of T_{R2Dmin} and/or at least before the end of T_{R2Dmax}.

An A-IoT that transmits a respective second frame (e.g., MsgA) may not decrement a respective slot counter and/or disable to another second frame as a response to a next Query received from the reader during the same second type inventory procedure or round.

For example, the first A-IoT device may set a respective slot counter with a large value, e.g., in response to or after transmitting the second frame (e.g., MsgA) in FIG. 25. The large value may be larger than a number of contention slots indicated by the first frame (and/or query command in the first frame). For example, the large value may be 7FFF in hexadecimal. Setting the respective slot counter with the large value may prevent subsequent replies during the same second type inventory procedure or round.

In FIG. 25, the reader may receive, from the first A-IoT device, the second frame. The reader may successfully decode the second frame. In response to or after receiving the second frame, the reader may continue the same second type inventory procedure initiated by the first frame in FIG. 25. In response to or after receiving the second frame, the reader may terminate, abort, or stop the second type inventory procedure initiated by the first frame in FIG. 25. In response to or after receiving the second frame, the reader may initiate a new inventory procedure that is different from the second type inventory procedure initiated by the first frame in FIG. 25.

In FIG. 25, the reader may transmit a second first frame, e.g., in response to or after the second frame. The reader may start to transmit the second first frame, e.g., in response to or after the end of the second time offset starting from the end of the second frame as described in FIG. 25.

The second first frame may comprise a first type query command. For example, the second first frame may comprise a first type query command indicating a new number of contention slots. Each of one or more A-IoT devices that select their respective slots out of the contention slots indicated by the first frame may select a new slot out of the new number of contention slots indicated by the second first frame. Each of one or more A-IoT devices that select their respective slots out of the contention slots indicated by the first frame may set a respective slot counter to a value indicating the newly selected slot.

The second first frame may comprise a second type query command. For example, the second first frame may comprise a second type query command indicating to continue the same second type inventory procedure initiated by the first frame. Each of one or more A-IoT devices, that set a respective slot counter in response to receiving the first type query command in the first frame in FIG. 25, may decrement the slot counter by one, e.g., in response to or after receiving the second type query command in the second first frame.

An A-IoT device may be limited capability.

In an example, an A-IoT device may comprise at least one of a PHY layer or an MAC layer. An A-IoT device may not comprise at least one of an RLC layer, a PDCP layer, or an RRC layer. For example, an A-IoT device may not be configured with a configuration parameters without the RRC layer.

In an example, an A-IoT device may be capable of and/or may support a half-duplex. In an example, an A-IoT device may not be capable of and/or may not support a full duplex. For example, the A-IoT device may not be capable of transmission and reception at the same time. For example, the A-IoT device may be capable of either transmission or reception at a time.

Due to the limited capability of the A-IoT device, a reader may include or indicate one or more configuration parameters to be used for an inventory procedure. For example, the reader may include or indicate the one or more configuration parameters in the PHY or MAC message (e.g., query command). For example, a reader may include or indicate, using a first frame comprising a query command (e.g., a first type query command and/or a second type query command), the one or more configuration parameters. For example, a length of a preamble in the first frame, a length of a payload part comprising the query command of the first frame, a length of the first frame, and/or one or more fields in the query command of the first frame, and/or any combination thereof may indicate (and/or may be used for indicating) the one or more configuration parameters.

In an example, the one or more configuration parameters may comprise a D2R frequency used by an A-IoT device to transmit a response to the query command. In the present disclosure, the D2R frequency may refer to a reference radio frequency for transmitting, by an A-IoT device, a signal (e.g., the response to the query command) to the reader via a D2R channel. In the present disclosure, the D2R frequency is denoted by f_{D2R}.

For example, a transmission of the signal via the D2R may occupy, reside, span, and/or be configured within a respective frequency range, e.g., from a first frequency to a second frequency. A bandwidth of the transmission may be the second frequency minus the first frequency. In the present disclosure, the bandwidth of the transmission by the A-IoT device via an D2R channel may be referred to as D2R bandwidth. The D2R bandwidth may be an occupied bandwidth that includes one or more guard bands. The D2R bandwidth may be a transmission bandwidth that excludes one or more guard bands.

In an example, in the present disclosure, the D2R frequency of the one or more configuration parameters may be the lowest frequency (e.g., the first frequency) of the frequency range. The A-IoT device may up-convert a base band signal (the response) to the frequency range starting from the first frequency (e.g., D2R frequency) until the second frequency that is the D2R frequency plus the D2R bandwidth.

In an example, in the present disclosure, the D2R frequency of the one or more configuration parameters may be the highest frequency (e.g., the second frequency) of the frequency range. The A-IoT device may up-convert a base band signal (the response) to the frequency range starting from the first frequency (e.g., that is the D2R frequency minus the D2R bandwidth) until the second frequency (e.g., D2R frequency).

In an example, in the present disclosure, the D2R frequency of the one or more configuration parameters may be a center frequency. The center frequency may be in the middle of the frequency range. For example, the center frequency may be (the first frequency+the second frequency)/2. The A-IoT device may up-convert a base band signal (the response) to the frequency range such that a half of the D2R bandwidth starts upward from the center frequency (e.g., D2R frequency) and the other half of the D2R bandwidth starts downward from the center frequency (e.g., D2R frequency).

A reader may transmit a signal via an R2D channel to one or more A-IoT devices. An R2D frequency may refer to a reference radio frequency used by the reader to transmit, via an R2D channel, a signal to one or more A-IoT devices. to the query command. In the present disclosure, the R2D frequency is denoted by f_{R2D}.

A transmission of a signal via the R2D may occupy, reside, span, and/or be configured within a respective frequency range, e.g., from a first frequency to a second frequency. A bandwidth of the transmission may be the second frequency minus the first frequency. In the present disclosure, the bandwidth of the transmission by the A-IoT device via an R2D channel may be referred to as R2D bandwidth. The R2D bandwidth may be an occupied bandwidth that includes one or more guard bands. The R2D bandwidth may be a transmission bandwidth that excludes one or more guard bands.

In an example, in the present disclosure, the R2D frequency may be the lowest frequency (e.g., the first frequency) of the frequency range. The reader may up-convert a base band signal (the response) to the frequency range starting from the first frequency (e.g., R2D frequency) until the second frequency that is the R2D frequency plus the R2D bandwidth.

In an example, in the present disclosure, the R2D frequency of the one or more configuration parameters may be the highest frequency (e.g., the second frequency) of the frequency range. The reader may up-convert a base band signal (the response) to the frequency range starting from the first frequency (e.g., that is the R2D frequency minus the R2D bandwidth) until the second frequency (e.g., R2D frequency).

In an example, in the present disclosure, the R2D frequency of the one or more configuration parameters may be a center frequency. The center frequency may be in the middle of the frequency range. For example, the center frequency may be (the first frequency+the second frequency)/2. The reader may up-convert a base band signal (the response) to the frequency range such that a half of the R2D bandwidth starts upward from the center frequency (e.g., R2D frequency) and the other half of the R2D bandwidth starts downward from the center frequency (e.g., R2D frequency).

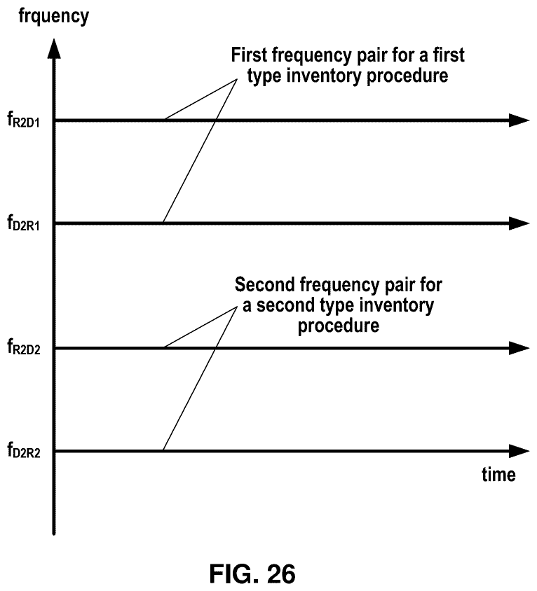

FIG. 26 illustrates an example as per an aspect of an embodiment of the present disclosure. There may be one or more frequency pairs. Each frequency pair of the one or more frequency pair may comprise a R2D frequency and a respective D2R frequency. A frequency pair may be configured for (or per) an inventory procedure.

For example, once a reader initiates an inventory procedure using a R2D frequency, a transmission via an R2D channel from the reader to one or more A-IoT devices may span over a frequency range based on the R2D frequency as the reference frequency during the initiated inventory procedure. One or more A-IoT devices may receive the signal from the reader via the R2D channel over the frequency range determined based on the R2D frequency as the reference frequency.

For example, once a reader initiates an inventory procedure and/or indicate (or configure) a D2R frequency, a transmission via an D2R channel from an A-IoT device to the reader may span over a frequency range based on the D2R frequency as the reference frequency during the initiated inventory procedure. The reader may receive the signal from the A-IoT device via the D2R channel over the frequency range determined based on the D2R frequency as the reference frequency.

For example, in FIG. 26, a first frequency pair may comprise a first R2D frequency (e.g., f_{R2D1}) and a first D2R frequency (e.g., f_{D2R1}). The first R2D frequency may be a reference frequency (e.g., lowest, highest, or center frequency) to be used by a reader to transmit a message or a frame to one or more A-IoT devices for a first inventory procedure. The first D2R frequency may be another reference frequency (e.g., lowest, highest, or center frequency) to be used by an A-IoT device to transmit a response to the message or the frame to the reader for the first inventory procedure.

For example, in FIG. 26, a second frequency pair may comprise a second R2D frequency (e.g., f_{R2D2}) and a second D2R frequency (e.g., f_{D2R2}). The second R2D frequency may be a reference frequency (e.g., lowest, highest, or center frequency) to be used by a reader to transmit a message or a frame to one or more A-IoT devices for a second inventory procedure. The second D2R frequency may be another reference frequency (e.g., lowest, highest, or center frequency) to be used by an A-IoT device to transmit a response to the message or the frame to the reader for the second inventory procedure.

In FIG. 26, a first frequency pair may be configured for a first type inventory procedure. For example, a second frequency pair may be configured for a second type inventory procedure. Each of the first type inventory procedure and the second type inventory procedure has a respective advantage and disadvantage.

For example, the first type inventory procedure may comprise at least 4 message transmissions to identify an A-IoT device as described from FIG. 22 to FIG. 24. The second type inventory procedure may comprise two message transmissions as described in FIG. 25. This may result in the first type inventory procedure taking a longer time to identify an A-IoT device, comprising with the second type inventory procedure.

For example, a response message (e.g., 2^{nd} frame in FIG. 25) of the second type inventory procedure is longer or has a larger size than a response message (e.g., 2^{nd} frame and/or 4^{th} frame from FIG. 22 to FIG. 24) of the first type inventory procedure. An A-IoT device performing the second type inventory procedure may maintain the timing acquisition longer for the large size of the response message, e.g., comparing with performing the first type inventory procedure. An A-IoT device performing the second type inventory procedure may use a larger amount power to transmit the large size of the response message, e.g., comparing with performing the first type inventory procedure.

In existing technologies, an A-IoT device may not be capable of receiving and/or decoding two query commands at the same time due to the limited capability of the A-IoT device, e.g., if transmissions of the two query commands are overlapped at least in part in the time domain. In existing technologies, an A-IoT device may not selectively select one of the first type inventory procedure and the second type inventory procedure. For example, if the A-IoT device receives and/or decode a query command, the A-IoT device may initiates, starts, and/or joins a respective inventory procedure (e.g., any of the first type inventory procedure and the second type inventory procedure).

Thus, the implementation based on the existing technologies is a random type selection of inventory procedure.

For example, the implementation based on the existing technologies results in an A-IoT device, located far away from the reader, selecting the second type inventory procedure. The A-IoT device may not be capable of maintaining the timing acquisition longer for the large size of the response message. The A-IoT device may not have enough energy (or power) harvested for a larger amount power to transmit the large size of the response message during the second inventory procedure. Selecting the second type inventory procedure in this case results in a failure of identifying, by the reader, the A-IoT device.

For example, the implementation based on the existing technologies results in an A-IoT device, located close to the reader, selecting the first type inventory procedure. The A-IoT device may be capable of maintaining the timing acquisition longer for the large size of the response message. The A-IoT device may have enough energy (or power) harvested for a larger amount power to transmit the large size of the response message. Selecting the first type inventory procedure in this case results in longer time to identify, by the reader, the A-IoT device, e.g., comparing with selecting the second type inventory procedure.

Embodiments of the present disclosure are related to an approach for solving the problems described above. These and other features of the present disclosure are described further below.

In an example embodiment, a reader may transmit, to one or more A-IoT devices a query command. The query command may initiate at least one of the first type inventory procedure or the second type inventory procedure. An A-IoT device of the one or more A-IoT devices may select one of the first type inventory procedure and the second type inventory procedure based on one or more criteria.

For example, the one or more criteria comprise whether a received signal power (and/or received signal strength) measured on the query command (and/or a frame comprising the query command) is higher than a threshold value or not.

For example, the one or more criteria comprise whether an amount of energy harvest and/or stored as the A-IoT device is higher than a threshold value or not.

For example, the one or more criteria comprise whether an available power to use the inventory procedure (e.g., for transmission a response (e.g., ID and/or INF) to the reader) is higher than a threshold value or not.

In an example embodiment, a single query command may initiate, trigger, and/or start the first inventory procedure and the second inventory procedure.

Example embodiments of the present disclosure solve the improper type selection of inventory procedure. For example, the example embodiments result in an A-IoT device, that is located far away from the reader and/or that is not capable of maintaining the timing acquisition longer, selecting the first type inventory procedure. For example, the example embodiments result in an A-IoT device, located close to the reader and/or capable of maintaining the timing acquisition longer, selecting the second type inventory procedure. For example, the example embodiments result in the A-IoT device, that does not have enough energy (or power) harvested, selecting the first type inventory procedure. For example, the example embodiments result in the A-IoT device, that has enough energy (or power) harvested, selecting the second type inventory procedure. Implementation of a type selection of inventory procedure prevents a failure of identifying, by the reader, the A-IoT device.

In the existing technologies, a single D2R frequency is paired with a R2D frequency. For example, an A-IoT device in the existing technologies determine a single D2R frequency using a measured length of a preamble of a first frame comprising a query command and/or using a value indicated by a field of the query command. For example, the single D2R frequency is referred to as a backscatter(ing) link frequency (BLF) in the existing technologies. In the existing technologies, the BLF may be BLF=DR/TRcal, where DR (division ratio) is the value indicated by the field of the query command and TRcal (tag-to-reader calibration) is a portion of the length of preamble.

In the existing technologies, a single query (or a frame comprising the single query) does not indicate two D2R frequencies. Thus, the implementation based on the existing technologies has a problem to indicate and/or configure two D2R frequencies.

In an example embodiment, an R2D frequency is associated with a first D2R frequency for the first type inventory procedure and a second D2R frequency for the second type inventory procedure. For example, in an example embodiment, an A-IoT device determines a first D2R frequency for the first type inventory procedure and a second D2R frequency for the second type inventory procedure.

Example embodiments of the present disclosure solve a single query command not indicating two (or more) D2R frequencies. For example, the example embodiments result in a single query command indicating first type inventory procedure and the second type inventory procedure and/or indicating a first D2R frequency of the first type inventory procedure and a second D2R frequency of the second type inventory procedure.

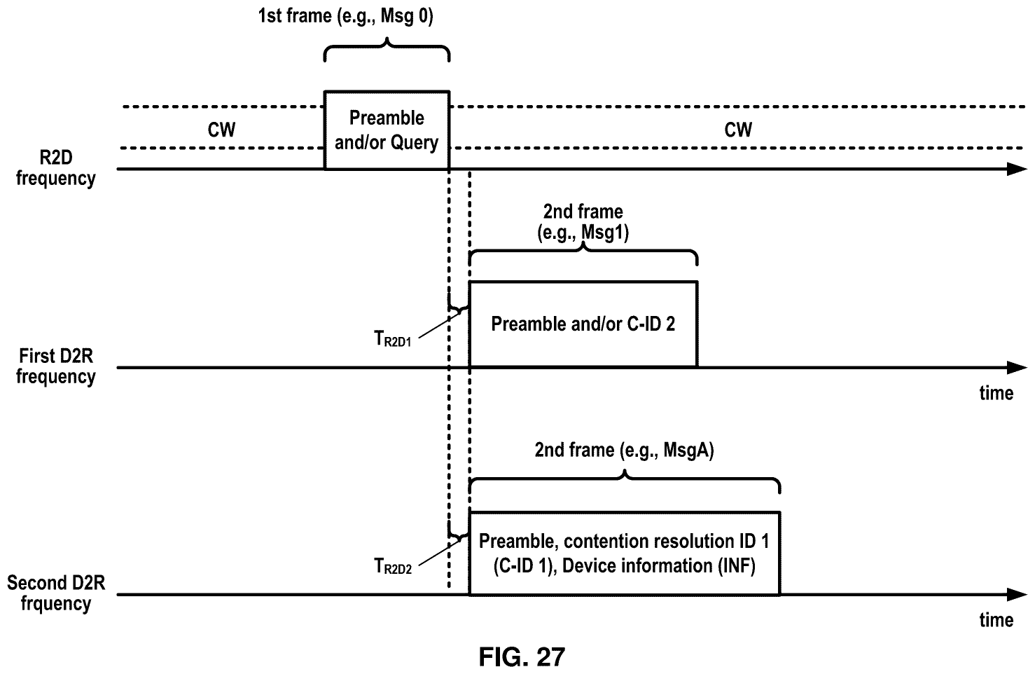

FIG. 27 illustrates an example as per an aspect of an embodiment of the present disclosure.

In FIG. 27, an R2D frequency may be a reference frequency of a frequency range via which the reader transmits a frame (e.g., comprising Msg0 and/or Msg2) to one or more A-IoT devices. A first D2R frequency may be a reference frequency of a frequency range via which an A-IoT device of the one or more A-IoT devices transmits a frame (e.g., comprising Msg1 and/or Msg3) to the reader according to the first type inventory procedure, e.g., described from FIG. 22 to FIG. 24. A second D2R frequency may be a reference frequency of a frequency range via which an A-IoT device of the one or more A-IoT devices transmits a frame (e.g., comprising MsgA) to the reader according to the second type inventory procedure, e.g., described in FIG. 25.

In FIG. 27, a frame on the line of the R2D frequency may be a frame that the reader transmits to one or more A-IoT devices.

In FIG. 27, a frame on the line of the first D2R frequency may be a frame that a first A-IoT device (of one or more A-IoT devices) to the reader, e.g., in response to or after selecting, by the first A-IoT device, the first type inventory procedure.

In FIG. 27, a frame on the line of the second D2R frequency may be a frame that a second A-IoT device (of one or more A-IoT devices) to the reader, e.g., in response to or after selecting, by the second A-IoT device, the second type inventory procedure.

In FIG. 27, a reader may transmit, to one or more A-IoT devices, a first frame (e.g., comprising a query command (e.g., a single query command) via an R2D channel on the R2D frequency.

For example, the first frame may comprise a preamble and a payload part. The payload part may comprise a query command. The query command may initiate, trigger, and/or start at least one of the first type inventory procedure or the second type inventory procedure. For example, a field in the query command may indicate that the query command initiates, triggers, and/or starts at least one of the first type inventory procedure or the second type inventory procedure.

In FIG. 27, there may be one or more A-IoT devices in the proximity of the reader. The one or more A-IoT devices may receive the first frame from the reader via the R2D channel on the R2D frequency. For example, a first A-IoT device among the one or more A-IoT devices may receive the first frame. For example, a second A-IoT device among the one or more A-IoT devices may receive the first frame.

In FIG. 27, each of the one or more A-IoT devices may determine which inventory procedure among the first type inventory procedure and the second type inventory procedure, it initiates, triggers, joins, and/or starts.

In FIG. 27, the first A-IoT device among the one or more A-IoT devices determine to initiate, trigger, join, and/or start the first type inventory procedure.

In FIG. 27, the second A-IoT device among the one or more A-IoT devices determine to initiate, trigger, join, and/or start the second type inventory procedure.

In FIG. 27, the query command may indicate a number of contention slots. The contention slots may be for at least one of the first inventory procedure or the second inventory procedure. For example, the first A-IoT device may select one slot among the contention slots for proceeding the first type inventory procedure. For example, the second A-IoT device may select one slot among the contention slots for proceeding the second type inventory procedure.

In FIG. 27, for the sake of the simplicity, the first A-IoT device and the second A-IoT device may select an earliest slot among the contention slots. For example, other A-IoT devices may select a different slot (e.g., second earliest, third earliest, etc) among the number of contention slots. A procedure to select a slot among the contention slots may be the same as the one described in the present disclosure for the first type inventory procedure (e.g., from FIG. 22 to FIG. 24) and/or the second type inventory procedure (e.g., in FIG. 25).

In the present disclosure, a channel spanned on a frequency may indicate that the channel is spanned over a frequency range determined based on the frequency as a reference frequency of the frequency range. Likewise, a transmission on, via, and/or over a frequency may indicate that the transmission on, via, and/or over a frequency range determined based on the frequency as a reference frequency of the frequency range. For example, the frequency range may be from a first frequency to a second frequency. The frequency may indicate the first frequency (e.g., the lowest frequency in the frequency range). The frequency may indicate the second frequency (e.g., the highest frequency in the frequency range). The frequency may indicate a center frequency of the frequency range.

The first A-IoT device may transmit, to the reader via a D2R channel spanned on a first D2R frequency, a second frame (e.g., Msg1) as a part of the first type inventory procedure. The second frame may comprise a preamble and ID (e.g., temporary ID) of the first A-IoT device, the second frame transmitted by the first A-IoT device over the first D2R frequency may be the same as the 2nd frame in FIG. 22 and FIG. 23, and/or the same as ID 2403, ID 2411, ID 2413, and/or ID 2417 in FIG. 24.

The second A-IoT device may transmit, to the reader via a D2R channel spanned on a second D2R frequency, a second frame (e.g., MsgA) as a part of the second type inventory procedure. The second frame may comprise a preamble and ID (e.g., temporary ID) of the first A-IoT device, and/or information (INF) of the second A-IoT device. The second frame transmitted by the second A-IoT device over the second D2R frequency may be the same as the 2nd frame (e.g., MsgA) in FIG. 25.

In FIG. 27, the selection of the type of the inventory procedure may be based on a measurement results. For example, the measurement results may comprise a received signal strength, of the 1^{st} frame (e.g., Msg 0), measured by an A-IoT device. For example, the 1^{st} frame may comprise a preamble and a payload part that comprises the query command. For example, the measurement results may comprise a received signal strength, of the preamble in the 1^{st} frame (e.g., Msg 0), measured by an A-IoT device. For example, the measurement results may comprise a received signal strength, of the payload part in the 1^{st} frame (e.g., Msg 0), measured by an A-IoT device. For example, the measurement results may comprise a received signal strength, of the preamble and the payload part in the 1^{st} frame (e.g., Msg 0), measured by an A-IoT device.

In FIG. 27, an A-IoT device may determine the measurement results, e.g., in response to or based on the receive 1^{st} frame. The A-IoT device may determine (or select) one of the first type inventory procedure and the second type inventory procedure by comprising the measurement results with a respective threshold value. For example, the respective threshold value may be predefined. For example, the query command in the 1^{st} frame may further indicate the respective threshold value.

In FIG. 27, the first A-IoT device may determine (or select) the first type inventory procedure, e.g., in response to a first measurement result (e.g., measured by the first A-IoT device) being lower than (or lower than or equal to) the threshold value. In response to determining the first type inventory procedure, the first A-IoT device may determine a respective D2R frequency (e.g., the first D2R frequency) on which the first A-IoT device transmits, to the reader via a D2R channel, a response (e.g., 2^{nd} frame and/or Msg1) to the 1^{st} frame.

In FIG. 27, the second A-IoT device may determine (or select) the second type inventory procedure, e.g., in response to a second measurement result (e.g., measured by the second A-IoT device) being higher than or equal to (or higher than) the threshold value. In response to determining the second type inventory procedure, the second A-IoT device may determine a respective D2R frequency (e.g., the second D2R frequency) on which the second A-IoT device transmits, to the reader via a D2R channel, a response (e.g., 2^{nd} frame and/or MsgA) to the 1^{st} frame.

In FIG. 27, the selection of the type of the inventory procedure may be based on an amount of power and/or energy available/harvest/stored at an A-IoT device. For example, the amount of power and/or energy may indicate whether the A-IoT device has enough power or energy to transmit a 2^{nd} frame (e.g., MsgA) of the second type inventory procedure. For example, an A-IoT device may determine (or select) the first type inventory procedure, e.g., if the amount of power and/or energy is small than (or smaller than or equal to) a respective threshold value. For example, an A-IoT device may determine (or select) the second type inventory procedure, e.g., if the amount of power and/or energy is larger than or equal to (or larger than) a respective threshold value. For example, the respective threshold value may be predefined. For example, the query command in the 1^{st} frame may further indicate the respective threshold value.

In an example, an A-IoT device may harvest and/or store an energy to be used for transmit power of a transmission to the reader. For example, the CW described in the present disclosure (e.g., from FIG. 22 to FIG. 27) may be an energy source from which an A-IoT device harvests an energy. There may be other energy sources for an A-IoT device as described in the present disclosure.

An A-IoT device may store the harvested energy (e.g., in the energy storage from FIG. 17 to FIG. 20). An A-IoT device may convert an amount of harvested energy to a transmit power for transmission to the reader.

In FIG. 27, the first A-IoT device may determine (or select) the first type inventory procedure, e.g., in response to a first amount of power and/or energy (e.g., at the first A-IoT device) being lower than (or lower than or equal to) the threshold value. In response to determining the first type inventory procedure, the first A-IoT device may determine a respective D2R frequency (e.g., the first D2R frequency) on which the first A-IoT device transmits, to the reader via a D2R channel, a response (e.g., 2^{nd} frame and/or Msg1) to the 1^{st} frame.

In FIG. 27, the second A-IoT device may determine (or select) the second type inventory procedure, e.g., in response to a second amount of power and/or energy (e.g., at the first A-IoT device) being higher than or equal to (or higher than) the threshold value. In response to determining the second type inventory procedure, the second A-IoT device may determine a respective D2R frequency (e.g., the second D2R frequency) on which the second A-IoT device transmits, to the reader via a D2R channel, a response (e.g., 2^{nd} frame and/or MsgA) to the 1^{st} frame.

In FIG. 27, the selection of the type of the inventory procedure may be based on a device type. A first device type (e.g., Device 1 and/or device having an block diagram in FIG. 18) may not amplify a transmit power and/or may not have enough power or energy to perform the second type inventory procedure. A second device type (e.g., Device 2a, Device 2b, and/or device having an block diagram in FIG. 18 or FIG. 19) may amplify a transmit power and/or may have enough power or energy to perform the second type inventory procedure.

In FIG. 27, the first A-IoT device may determine (or select) the first type inventory procedure, e.g., in response to the first A-IoT device being the first type device (e.g., Device 1 and/or device having an block diagram in FIG. 18). In response to determining the first type inventory procedure, the first A-IoT device may determine a respective D2R frequency (e.g., the first D2R frequency) on which the first A-IoT device transmits, to the reader via a D2R channel, a response (e.g., 2^{nd} frame and/or Msg1) to the 1^{st} frame.

In FIG. 27, the second A-IoT device may determine (or select) the second type inventory procedure, e.g., in response to the second A-IoT device being the second device type (e.g., Device 2a, Device 2b, and/or device having an block diagram in FIG. 18 or FIG. 19). In response to determining the second type inventory procedure, the second A-IoT device may determine a respective D2R frequency (e.g., the second D2R frequency) on which the second A-IoT device transmits, to the reader via a D2R channel, a response (e.g., 2^{nd} frame and/or MsgA) to the 1^{st} frame.

In FIG. 27, the first A-IoT device may transmit, to the reader via a slot that the first A-IoT device select and over the first D2R frequency, a response (e.g., 2^{nd} frame and/or Msg1) to the 1^{st} frame. For example, the first A-IoT device may select the earliest slot among the contention slots indicated by the 1^{st} frame. The first A-IoT device may transmit, to the reader via the earliest slot and over the first D2R frequency, a response (e.g., 2^{nd} frame and/or Msg1) to the 1^{st} frame as described in FIG. 27.

In FIG. 27, the second A-IoT device may transmit, to the reader via a slot that the second A-IoT device select and over the second D2R frequency, a response (e.g., 2^{nd} frame and/or MsgA) to the 1^{st} frame. For example, the second A-IoT device may select the earliest slot among the contention slots indicated by the 1^{st} frame. The second A-IoT device may transmit, to the reader via the earliest slot and over the second D2R frequency, a response (e.g., 2^{nd} frame and/or MsgA) to the 1^{st} frame as described in FIG. 27.

In FIG. 27, T_{R2D1} is a time offset (e.g., T_{R2D1min} and/or T_{R2D1max}), a time interval, and/or a time duration from a transmission of the reader to the earliest slot of the contention slots (e.g., to transmission of an A-IoT device response) for the first type inventory procedure. For example, T_{R2D1} (e.g., T_{R2D1min}) is a minimum time between a transmission (e.g., the 1^{st} frame) from the reader to the first A-IoT device via R2D channel and the corresponding transmission (e.g., the 2^{nd} frame) for the first type inventory procedure from the first A-IoT device to the reader via the earliest slot. For example, T_{R2D1} (e.g., T_{R2D1max}) is a maximum time between a transmission (e.g., the 1^{st} frame) from the reader to the first A-IoT device via R2D channel and the corresponding transmission (e.g., the 2^{nd} frame) for the first type inventory procedure from the first A-IoT device to the reader via the earliest slot of the contention slots.

For example, the first A-IoT device transmits, to the reader, the second frame (e.g., via an earliest slot of the contention slots) in response to or after T_{R2D1min} starting from the end of the first frame, e.g., if the first A-IoT device determines the first type inventory procedure. For example, the reader receives, from the first A-IoT device, the second frame (e.g., via an earliest slot of the contention slots) in response to or after T_{R2D1min} starting from the end of the first frame, e.g., if the first A-IoT device determines the first type inventory procedure.

For example, the first A-IoT device transmits, to the reader, the second frame (e.g., via an earliest slot of the contention slots) before the end of T_{R2D1max} starting from the end of the first frame, e.g., if the first A-IoT device determines the first type inventory procedure. For example, the reader receives, from the first A-IoT device, the second frame (e.g., via an earliest slot of the contention slots) before the end of T_{R2D1max} starting from the end of the first frame, e.g., if the first A-IoT device determines the first type inventory procedure.

For example, a transmission or reception of the second frame (e.g., via an earliest slot of the contention slots) for the first type inventory procedure starts after T_{R2D1min} starting from the end of the first frame. For example, a transmission or reception of the second frame (e.g., via an earliest slot of the contention slots) starts before the end of T_{R2D1max} starting from the end of the first frame.

For example, T_{R2D1} (e.g., T_{R2D1min} and/or T_{R2D1max}) may be predefined (hard-coded to the A-IoT device). For example, a message, signaling, and/or a command received from the reader indicate T_{R2D1} (e.g., T_{R2D1min} and/or T_{R2D1max}).

In FIG. 27, T_{R2D2} is a time offset (e.g., T_{R2D2min} and/or T_{R2D2max}), a time interval, and/or a time duration from a transmission of the reader to the earliest slot of the contention slots (e.g., to transmission of an A-IoT device response) for the second type inventory procedure. For example, T_{R2D2} (e.g., T_{R2D2min}) is a minimum time between a transmission (e.g., the 1^{st} frame) from the reader to the second A-IoT device via R2D channel and the corresponding transmission (e.g., the 2^{nd} frame) for the second type inventory procedure from the second A-IoT device to the reader via the earliest slot. For example, T_{R2D2} (e.g., T_{R2D2max}) is a maximum time between a transmission (e.g., the 1^{st} frame) from the reader to the second A-IoT device via R2D channel and the corresponding transmission (e.g., the 2^{nd} frame) for the second type inventory procedure from the second A-IoT device to the reader via the earliest slot of the contention slots.

In FIG. 27, for example, the second A-IoT device transmits, to the reader, the second frame (e.g., via an earliest slot of the contention slots) in response to or after T_{R2D2min} starting from the end of the first frame, e.g., if the second A-IoT device determines the second type inventory procedure. For example, the reader receives, from the second A-IoT device, the second frame (e.g., via an earliest slot of the contention slots) in response to or after T_{R2D2min} starting from the end of the first frame, e.g., if the second A-IoT device determines the second type inventory procedure.

In FIG. 27, for example, the second A-IoT device transmits, to the reader, the second frame (e.g., via an earliest slot of the contention slots) before the end of T_{R2D2max} starting from the end of the first frame, e.g., if the second A-IoT device determines the second type inventory procedure. For example, the reader receives, from the second A-IoT device, the second frame (e.g., via an earliest slot of the contention slots) before the end of T_{R2D2max} starting from the end of the first frame, e.g., if the second A-IoT device determines the second type inventory procedure.

In FIG. 27, for example, a transmission or reception of the second frame (e.g., via an earliest slot of the contention slots) for the second type inventory procedure starts after T_{R2D2min} starting from the end of the first frame. For example, a transmission or reception of the second frame (e.g., via an earliest slot of the contention slots) starts before the end of T_{R2D2max} starting from the end of the first frame.

In FIG. 27, for example, T_{R2D2} (e.g., T_{R2D2min} and/or T_{R2D2max}) is predefined (hard-coded to the A-IoT device). For example, a message, signaling, and/or a command received from the reader indicate T_{R2D2} (e.g., T_{R2D2min} and/or T_{R2D2max}).

In FIG. 27, for example, T_{R2D1} (e.g., T_{R2D1min} and/or T_{R2D1max}) is the same as T_{R2D2} (e.g., T_{R2D2min} and/or T_{R2D2max}). For example, T_{R2D1} is the same as T_{R2D2}. For example, T_{R2D1min} is the same as T_{R2D2min}. For example, T_{R2D1max} is the same as T_{R2D2max}.

In FIG. 27, for example, T_{R2D1} (e.g., T_{R2D1min} and/or T_{R2D1max}) is different from T_{R2D2} (e.g., T_{R2D2min} and/or T_{R2D2max}). For example, T_{R2D1} is different from T_{R2D2}. For example, T_{R2D1min} is different from T_{R2D2min}. For example, T_{R2D1max} is different from T_{R2D2max}.

In FIG. 27, for example, T_{R2D} may be defined and/or configured per a type of an inventory procedure.

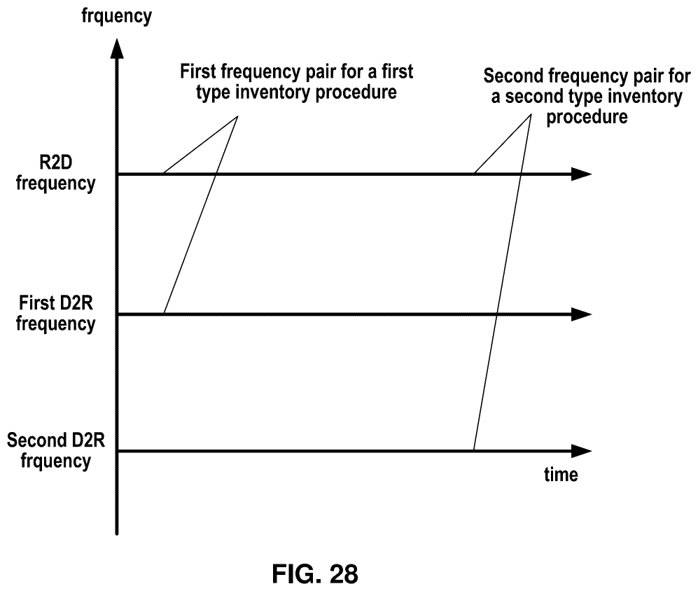

FIG. 28 illustrates an example as per an aspect of an embodiment of the present disclosure. FIG. 28 may be an example of frequency assignment of the first type inventory procedure and the second type inventory procedure described in FIG. 27.

For example, in FIG. 28, an R2D frequency may be a reference frequency of a frequency range via which the reader transmits a frame (e.g., comprising Msg0 and/or Msg2) to one or more A-IoT devices. A first D2R frequency may be a reference frequency of a frequency range via which an A-IoT device of the one or more A-IoT devices transmits a frame (e.g., comprising Msg1 and/or Msg3) to the reader according to the first type inventory procedure, e.g., described from FIG. 22 to FIG. 24. A second D2R frequency may be a reference frequency of a frequency range via which an A-IoT device of the one or more A-IoT devices transmits a frame (e.g., comprising MsgA) to the reader according to the second type inventory procedure, e.g., described in FIG. 25.

In FIG. 28, a first frequency pair may comprise a R2D frequency and a first D2R frequency. The first frequency pair may be for the first type inventory procedure.

In FIG. 28, a second frequency pair may comprise a R2D frequency and a second D2R frequency. The first frequency pair may be for the second type inventory procedure.

In FIG. 28, the positions (or values) of the R2D frequency, the first D2R frequency, the second D2R frequency may be an example. For example, the R2D frequency may be higher than the first D2R frequency and/or the second D2R frequency. For example, the first D2R frequency may be higher than the R2D frequency and/or the second D2R frequency. For example, the second D2R frequency may be higher than the R2D frequency and/or the first D2R frequency.

In FIG. 28 (e.g., referring to FIG. 27), an A-IoT device (e.g., the first A-IoT device and/or the second A-IoT device) determines the first D2R frequency and/or the second D2R frequency.

In FIG. 28 (e.g., referring to FIG. 27), a single query command (e.g., in the first frame in FIG. 27) may comprise a first field indicating a first DR and/or a second field indicating a second DR. The A-IoT device may determine a first D2R frequency (e.g., first BLF) as first BLF=first DR/TRcal for the first type inventory procedure, where TRcal (tag-to-reader calibration) is a portion of the length of preamble (e.g., in the first frame in FIG. 27). The A-IoT device may determine a second D2R frequency (e.g., second BLF) as second BLF=second DR/TRcal for the second type inventory procedure, where TRcal (tag-to-reader calibration) is a portion of the length of preamble (e.g., in the first frame in FIG. 27).

In FIG. 28 (e.g., referring to FIG. 27), a single query command (e.g., in the first frame in FIG. 27) may comprise a first field indicating a first DR. The A-IoT device may determine a first D2R frequency (e.g., first BLF) as first BLF=first DR/TRcal for the first type inventory procedure, where TRcal (tag-to-reader calibration) is a portion of the length of preamble (e.g., in the first frame in FIG. 27). The A-IoT device may determine a second D2R frequency (e.g., second BLF) as second BLF=first BLF+frequency offset (or second BLF=first BLF-frequency offset), where the frequency offset may be predefined (e.g., hard-coded to the A-IoT device) and/or indicated by the single query command.

In FIG. 28 (e.g., referring to FIG. 27), a single query command (e.g., in the first frame in FIG. 27) may comprise a first field indicating a first DR. The A-IoT device may determine a first D2R frequency (e.g., first BLF) as first BLF=first DR/TRcal for the first type inventory procedure, where TRcal (tag-to-reader calibration) is a portion of the length of preamble (e.g., in the first frame in FIG. 27). The A-IoT device may determine a second D2R frequency (e.g., second BLF) as second BLF=second DR/TRcal, where the second DR may be predefined (e.g., hard-coded to the A-IoT device). For example, the second DR is paired with the first DR. For example, the second DR is the first DR+DR offset (or the second DR is the first DR-DR offset). The DR offset may be predefined (e.g., hard-coded to the A-IoT device) and/or indicated by the single query command.

In FIG. 28 (e.g., referring to FIG. 27), a single query command (e.g., in the first frame in FIG. 27) may comprise a second field indicating a second DR. The A-IoT device may determine a second D2R frequency (e.g., second BLF) as second BLF=second DR/TRcal for the second type inventory procedure, where TRcal (tag-to-reader calibration) is a portion of the length of preamble (e.g., in the first frame in FIG. 27). The A-IoT device may determine a first D2R frequency (e.g., first BLF) as first BLF=second BLF+frequency offset (or first BLF=second BLF-frequency offset), where the frequency offset may be predefined (e.g., hard-coded to the A-IoT device) and/or indicated by the single query command.

In FIG. 28 (e.g., referring to FIG. 27), a single query command (e.g., in the first frame in FIG. 27) may comprise a second field indicating a second DR. The A-IoT device may determine a second D2R frequency (e.g., second BLF) as second BLF=second DR/TRcal for the second type inventory procedure, where TRcal (tag-to-reader calibration) is a portion of the length of preamble (e.g., in the first frame in FIG. 27). The A-IoT device may determine a first D2R frequency (e.g., first BLF) as first BLF=first DR/TRcal, where the first DR may be predefined (e.g., hard-coded to the A-IoT device). For example, the first DR is paired with the second DR. For example, the first DR is the second DR+DR offset (or the first DR is the second DR-DR offset). The DR offset may be predefined (e.g., hard-coded to the A-IoT device) and/or indicated by the single query command.

In FIG. 28 (e.g., referring to FIG. 27), a single query command (e.g., in the first frame in FIG. 27) may comprise a first field indicating a first D2R frequency (e.g., first BLF) for the first type inventory procedure. The signal query command my further comprise a second field indicating a second D2R frequency (e.g., second BLF) for the second type inventory procedure.

For example, there is a multiple entries (e.g., each entry may be associated with a respective row in a table). Each entry of the multiple entries comprise a respective index and a respective D2R frequency. A field in the single query command may indicate a D2R frequency of a particular entry of the multiple entries, e.g., if the field may indicate an index of the particular entry.

For example, the first field may indicate a first index of a first entry of the multiple entries. The first field may indicate a first D2R frequency (e.g., first BLF) of the first entry of the multiple entries, e.g., if the first field may indicate the first index of the first entry. For example, the second field may indicate a second index of a second entry of the multiple entries. The second field may indicate a second D2R frequency (e.g., second BLF) of the second entry of the multiple entries, e.g., if the second field may indicate the second index of the second entry.

In FIG. 28 (e.g., referring to FIG. 27), a single query command (e.g., in the first frame in FIG. 27) may comprise a first field indicating a first D2R frequency (e.g., first BLF) for the first type inventory procedure. The A-IoT device may determine a second D2R frequency (e.g., second BLF) as second BLF=first BLF+frequency offset (or second BLF=first BLF-frequency offset), where the frequency offset may be predefined (e.g., hard-coded to the A-IoT device) and/or indicated by the single query command.

In FIG. 28 (e.g., referring to FIG. 27), a single query command (e.g., in the first frame in FIG. 27) may comprise a second field indicating a second D2R frequency (e.g., second BLF) for the second type inventory procedure. The A-IoT device may determine a first D2R frequency (e.g., second BLF) as first BLF=second BLF+frequency offset (or first BLF=second BLF-frequency offset), where the frequency offset may be predefined (e.g., hard-coded to the A-IoT device) and/or indicated by the single query command.

In FIG. 28 (e.g., referring to FIG. 27), the selection and/or determination of the D2R frequency to perform an inventory procedure may be based on a measurement results. For example, the measurement results may comprise a received signal strength, of the 1^{st} frame (e.g., Msg 0), measured by an A-IoT device. For example, the 1^{st} frame may comprise a preamble and a payload part that comprises the query command. For example, the measurement results may comprise a received signal strength, of the preamble in the 1^{st} frame (e.g., Msg 0), measured by an A-IoT device. For example, the measurement results may comprise a received signal strength, of the payload part in the 1^{st} frame (e.g., Msg 0), measured by an A-IoT device. For example, the measurement results may comprise a received signal strength, of the preamble and the payload part in the 1^{st} frame (e.g., Msg 0), measured by an A-IoT device.

In FIG. 28 (e.g., referring to FIG. 27), an A-IoT device may determine the measurement results, e.g., in response to or based on the receive 1^{st} frame. The A-IoT device may determine (or select) one of the first D2R frequency and the second D2R frequency by comprising the measurement results with a respective threshold value. For example, the respective threshold value may be predefined. For example, the query command in the 1^{st} frame may further indicate the respective threshold value.

In FIG. 28 (e.g., referring to FIG. 27), the first A-IoT device may determine (or select) the first D2R frequency, e.g., in response to a first measurement result (e.g., measured by the first A-IoT device) being lower than (or lower than or equal to) the threshold value. In response to determining the first D2R frequency, the first A-IoT device may transmit, to the reader via a D2R channel spanned over the first D2R frequency, a response (e.g., 2^{nd} frame and/or Msg1) to the 1^{st} frame.

In FIG. 28 (e.g., referring to FIG. 27), the second A-IoT device may determine (or select) the second D2R frequency, e.g., in response to a second measurement result (e.g., measured by the second A-IoT device) being higher than or equal to (or higher than) the threshold value. In response to determining the second D2R frequency, the second A-IoT device may transmit, to the reader via a D2R channel spanned over the second D2R frequency, a response (e.g., 2^{nd} frame and/or MsgA) to the 1^{st} frame.

In FIG. 28 (e.g., referring to FIG. 27), the determination and/or selection of a D2R frequency may be based on an amount of power and/or energy available/harvest/stored at an A-IoT device. For example, the amount of power and/or energy may indicate whether the A-IoT device has enough power or energy to transmit a 2^{nd} frame (e.g., MsgA) of the second type inventory procedure via the second D2R frequency. For example, an A-IoT device may determine (or select) the first D2R frequency, e.g., if the amount of power and/or energy is small than (or smaller than or equal to) a respective threshold value. For example, an A-IoT device may determine (or select) the second D2R frequency, e.g., if the amount of power and/or energy is larger than or equal to (or larger than) a respective threshold value. For example, the respective threshold value may be predefined. For example, the query command in the 1^{st} frame may further indicate the respective threshold value.

In FIG. 28 (e.g., referring to FIG. 27), the first A-IoT device may determine (or select) the first D2R frequency, e.g., in response to a first amount of power and/or energy (e.g., at the first A-IoT device) being lower than (or lower than or equal to) the threshold value. In response to determining the first D2R frequency, the first A-IoT device may transmit, to the reader via a D2R channel spanned over the first D2R frequency, a response (e.g., 2^{nd} frame and/or Msg1) to the 1^{st} frame.

In FIG. 28 (e.g., referring to FIG. 27), the second A-IoT device may determine (or select) the second D2R frequency, e.g., in response to a second amount of power and/or energy (e.g., at the first A-IoT device) being higher than or equal to (or higher than) the threshold value. In response to determining the second D2R frequency, the second A-IoT device may transmit, to the reader via a D2R channel spanned over the second D2R frequency, a response (e.g., 2^{nd} frame and/or MsgA) to the 1^{st} frame.

In FIG. 28, the determination and/or selection of a D2R frequency may be based on a device type.

In FIG. 28 (e.g., referring to FIG. 27), the first A-IoT device may determine (or select) the first D2R frequency, e.g., in response to the first A-IoT device being the first type device (e.g., Device 1 and/or device having an block diagram in FIG. 18). In response to determining the first D2R frequency, the first A-IoT device may transmit, to the reader via a D2R channel spanned over the first D2R frequency, a response (e.g., 2^{nd} frame and/or Msg1) to the 1^{st} frame.

In FIG. 28 (e.g., referring to FIG. 28), the second A-IoT device may determine (or select) the second D2R frequency, e.g., in response to the second A-IoT device being the second device type (e.g., Device 2a, Device 2b, and/or device having an block diagram in FIG. 18 or FIG. 19). In response to determining the second D2R frequency, the second A-IoT device may transmit, to the reader via a D2R channel spanned over the second D2R frequency, a response (e.g., 2^{nd} frame and/or MsgA) to the 1^{st} frame.

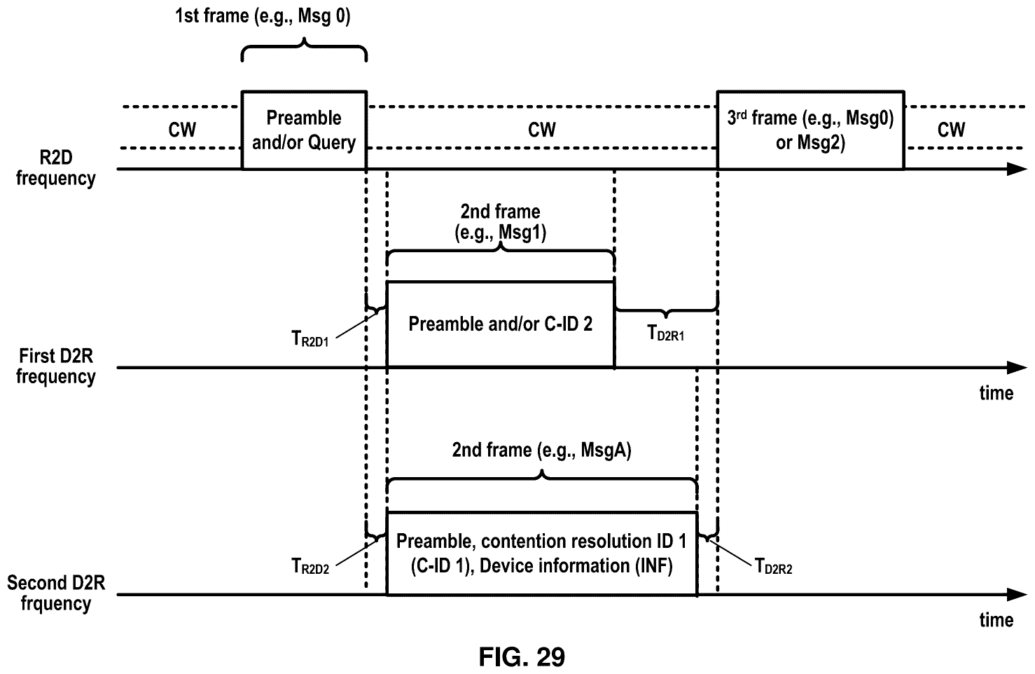

FIG. 29 illustrates an example as per an aspect of an embodiment of the present disclosure.

FIG. 29 may be an example of procedure in response to or after the procedure described in FIG. 27. For example, the 1^{st} frame in FIG. 29 may be the same as the 1^{st} frame in FIG. 27. For example, the 2^{nd} frame in FIG. 29 may be the same as the 2^{nd} frame in FIG. 27. For example, the T_{R2D1} in FIG. 29 may be the same as the T_{R2D1} in FIG. 27. For example, the T_{D2R1} in FIG. 29 may be the same as the T_{D2R1} in FIG. 27.

In FIG. 29 (e.g., by referring to FIG. 27), at least one of the first A-IoT device or the second A-IoT device may transmit a respective 2^{nd} frame. For example, the first A-IoT device transmits the 2^{nd} frame (e.g., Msg1) via the first D2R frequency. For example, the second A-IoT device transmits the 2^{nd} frame (e.g., MsgA) via the second D2R frequency.

In FIG. 29 (e.g., by referring to FIG. 27), the reader may receive, from the at least one of the first A-IoT device or the second A-IoT device, the respective 2^{nd} frame. For example, the reader receives, from the first A-IoT device, the 2^{nd} frame (e.g., Msg1) via the first D2R frequency. For example, the reader receives, from the second A-IoT device, the 2^{nd} frame (e.g., MsgA) via the second D2R frequency.

In FIG. 29, the reader may transmit a 3rd frame, e.g., in response to or after receiving at least one of the 2^{nd} frame (e.g., Msg1) from the first A-IoT device. and/or the 2^{nd} frame (e.g., MsgA) from the second A-IoT device.

In FIG. 29, for example, the 3rd frame may be a part of the first type inventory procedure. For example, the 3rd frame may be a response to the 2^{nd} frame (e.g., Msg1) received by the reader from the first A-IoT device. In FIG. 29, for example, the 3rd frame may be a response to the 2^{nd} frame (e.g., Msg1) received by the reader from the first A-IoT device. For example, in this case, the 3rd frame in FIG. 29 is the same as the 3rd frame (e.g., Msg2) in FIG. 23, (N)ACK 2405 in FIG. 24, and/or (N)ACK 2419 in FIG. 24.

In FIG. 29, for example, the 3rd frame may be a part of the second type inventory procedure. For example, the 3rd frame may be a response to the 2^{nd} frame (e.g., MsgA) received by the reader from the second A-IoT device. For example, the 3rd frame may be a fallback command that the reader transmits to the second A-IoT device, e.g., when or if the reader receives and/or decode the temporary ID of the 2^{nd} frame (e.g., MsgA) but fails to receive and/or decode the information (INF) of the 2^{nd} frame (e.g., MsgA). In this case, the 3rd frame may comprise a field indicating the temporary ID of the 2^{nd} frame (e.g., MsgA) that the second A-IoT device transmits.

In FIG. 29, for example, the 3rd frame may be the same as the 1^{st} frame (e.g., Msg 0) in FIG. 29. For example, the 3rd frame may comprise a first type query command initiating a new inventory procedure or round.

In FIG. 29, for example, the 3rd frame may comprise a second type query command. Each of the one or more A-IoT devices that receive the 3rd frame in FIG. 29 may decrement its respective slot counter. An A-IoT devices of the one or more A-IoT devices may select one of the first type inventory procedure and/or the second type inventory procedure, e.g., in response the respective slot counter being a value 0. An A-IoT devices of the one or more A-IoT devices may transmit 2^{nd} frame (e.g., Msg1) or 2^{nd} frame (e.g., MsgA) according to the selected type inventory procedure, e.g., in response the respective slot counter being a value 0.

In FIG. 29, the time interval or duration between the (reception time of) second frame (e.g., Msg 1) of the first type inventory procedure and the (transmission time of) third frame may be at least T_{D2R1} (e.g., T_{D2R1min} and/or T_{D2R1max}). For example, T_{D2R1} (e.g., T_{D2R1min}) is a minimum time between a transmission (e.g., the 2^{nd} frame for the first type inventory procedure) from the first A-IoT device to the reader via D2R channel and the corresponding transmission (e.g., the 3rd frame) from to the reader to the first A-IoT device via the R2D channel. For example, T_{D2R1} (e.g., T_{D2R1max}) is a maximum time between a transmission (e.g., the 2nd frame for the first type inventory procedure) from the first A-IoT device to the reader via D2R channel and the corresponding transmission (e.g., the 3rd frame) from to the reader to the first A-IoT device via the R2D channel.

In FIG. 29, for example, the reader transmits, to one or more A-IoT devices (e.g., the first A-IoT device and/or a second A-IoT device), the third frame in response to or after T_{D2R1min} starting from the end of the second frame (e.g., Msg1), e.g., if the reader receives the second frame (e.g., Msg1) from the first A-IoT device and/or if the third frame is a response to the 2^{nd} frame (e.g., Msg1). For example, the first A-IoT device receives, from the reader, the third frame in response to or after T_{D2R1min} starting from the end of the second frame.

In FIG. 29, for example, the reader transmits, to one or more A-IoT devices (e.g., the first A-IoT device and/or a second A-IoT device), the third frame before the end of T_{D2R1max} starting from the end of the second frame (e.g., Msg1), e.g., if the reader receives the second frame (e.g., Msg1) from the first A-IoT device and/or if the third frame is a response to the 2^{nd} frame (e.g., Msg1). For example, the first A-IoT device receives, from the reader, the third frame before the end of T_{D2R1min} starting from the end of the second frame.

In FIG. 29, for example, a transmission or reception of the third frame in FIG. 29 starts after T_{D2R1min} starting from the end of the second frame (e.g., Msg1) in FIG. 29. For example, a transmission or reception of the third frame starts before the end of T_{D2R1max} starting from the end of the second frame (e.g., Msg1).

In FIG. 29, for example, T_{D2R1} (e.g., T_{D2R1min} and/or T_{D2R1max}) may be predefined (hard-coded to the A-IoT device). For example, a message, signaling, and/or a command received from the reader indicate T_{D2R1} (e.g., T_{D2R1} min and/or T_{D2R1max}).

In FIG. 29, the time interval or duration between the (reception time of) second frame (e.g., Msg A) of the second type inventory procedure and the (transmission time of) third frame may be at least T_{D2R2} (e.g., T_{D2R2min} and/or T_{D2R2max}). For example, T_{D2R2} (e.g., T_{D2R2min}) is a minimum time between a transmission (e.g., the 2^{nd} frame for the second type inventory procedure) from the second A-IoT device to the reader via D2R channel and the corresponding transmission (e.g., the 3rd frame) from to the reader to the second A-IoT device via the R2D channel. For example, T_{D2R2} (e.g., T_{D2R2max}) is a maximum time between a transmission (e.g., the 2^{nd} frame for the second type inventory procedure) from the second A-IoT device to the reader via D2R channel and the corresponding transmission (e.g., the 3rd frame) from to the reader to the second A-IoT device via the R2D channel.

In FIG. 29, for example, the reader transmits, to one or more A-IoT devices (e.g., the first A-IoT device and/or a second A-IoT device), the third frame in response to or after T_{D2R2min} starting from the end of the second frame (e.g., MsgA), e.g., if the reader receives the second frame (e.g., MsgA) from the second A-IoT device and/or if the third frame is a response to the 2^{nd} frame (e.g., MsgA). For example, the first A-IoT device receives, from the reader, the third frame in response to or after T_{D2R2min} starting from the end of the second frame (e.g., MsgA).

In FIG. 29, for example, the reader transmits, to one or more A-IoT devices (e.g., the first A-IoT device and/or a second A-IoT device), the third frame before the end of T_{D2R2max} starting from the end of the second frame (e.g., MsgA), e.g., if the reader receives the second frame (e.g., MsgA) from the second A-IoT device and/or if the third frame is a response to the 2^{nd} frame (e.g., MsgA). For example, the second A-IoT device receives, from the reader, the third frame before the end of T_{D2R2min} starting from the end of the second frame (e.g., MsgA).

In FIG. 29, for example, a transmission or reception of the third frame in FIG. 29 starts after T_{D2R2min} starting from the end of the second frame (e.g., MsgA) in FIG. 29. For example, a transmission or reception of the third frame starts before the end of T_{D2R2max} starting from the end of the second frame (e.g., MsgA).

In FIG. 29, for example, T_{D2R2} (e.g., T_{D2R2min} and/or T_{D2R2max}) may be predefined (hard-coded to the A-IoT device). For example, a message, signaling, and/or a command received from the reader indicate T_{D2R2} (e.g., T_{D2R2} min and/or T_{D2R2max}).

In FIG. 29, for example, T_{D2R1} (e.g., T_{D2R1min} and/or T_{D2R1max}) is the same as T_{D2R2} (e.g., T_{D2R2min} and/or T_{D2R2max}). For example, T_{D2R1} is the same as T_{D2R2}. For example, T_{D2R1min} is the same as T_{D2R2min}. For example, T_{D2R1max} is the same as T_{D2R2max}.

In FIG. 29, for example, T_{D2R1} (e.g., T_{D2R1min} and/or T_{D2R1max}) is different from T_{D2R2} (e.g., T_{D2R2min} and/or T_{D2R2max}). For example, T_{D2R1} is different from T_{D2R2}. For example, T_{D2R1min} is different from T_{D2R2min}. For example, T_{D2R1max} is different from T_{D2R2max}.

In FIG. 29, for example, T_{D2R} may be defined and/or configured per a type of an inventory procedure.

Referring from FIG. 22 to FIG. 29, a query command may comprise a first field indicating whether an inventory procedure initiated (e.g., triggered, started by the query command) is the first type inventory procedure or not.

Referring from FIG. 22 to FIG. 29, a query command may comprise a second field indicating whether an inventory procedure initiated (e.g., triggered, started by the query command) is the second type inventory procedure or not.

Referring from FIG. 22 to FIG. 29, a query command may comprise a third field indicating whether an inventory procedure initiated (e.g., triggered, started by the query command) is the first type inventory procedure (e.g., when a value of the third field is a first value) or a second type inventory procedure (e.g., when a value of the third field is a second value).

Referring from FIG. 22 to FIG. 29, if the query command indicates a type of the inventory procedure (e.g., among the first type inventory procedure and the second type inventory procedure), an A-IoT device receiving the query command may determine and/or select a respective D2R frequency (e.g., among the first D2R frequency and the second D2R frequency).

For example, referring from FIG. 22 to FIG. 29, if the query command indicates the first type inventory procedure, an A-IoT device receiving the query command may determine and/or select the first D2R frequency.

For example, referring from FIG. 22 to FIG. 29, if the query command indicates the second type inventory procedure, an A-IoT device receiving the query command may determine and/or select the second D2R frequency.

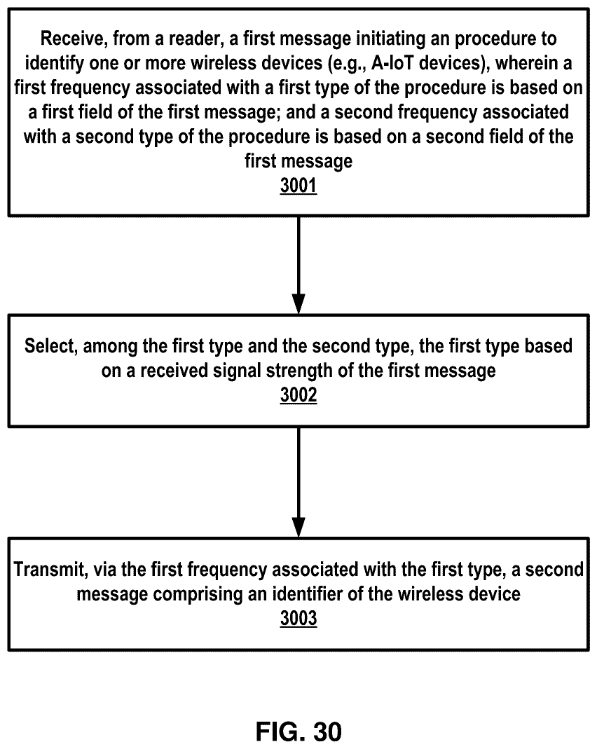

FIG. 30 illustrates an example as per an aspect of an embodiment of the present disclosure.

At 3001, a wireless device (e.g., A-IoT device) may receive, from a reader, a first message initiating an procedure to identify one or more wireless devices (e.g., A-IoT devices). For example, the first message comprises a first field and a second field. For example, a first frequency associated with a first type of the procedure is based on the first field. For example, a second frequency associated with a second type of the procedure is based on the second field. At 3002, the wireless device may select, among the first type and the second type, the first type based on a received signal strength of the first message. At 3003, the wireless device may transmit, via the first frequency associated with the first type, a second message comprising an identifier of the wireless device.

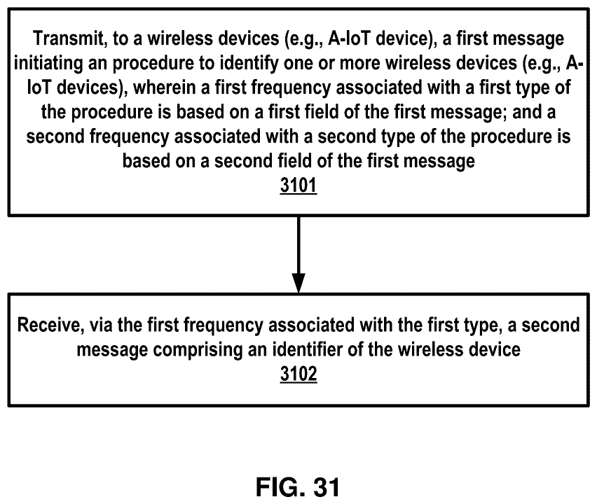

FIG. 31 illustrates an example as per an aspect of an embodiment of the present disclosure. At 3101, a reader may transmit, to a wireless device (e.g., A-IoT device) a first message initiating an procedure to identify one or more wireless devices (e.g., A-IoT devices). For example, the first message comprises a first field and a second field. For example, a first frequency associated with a first type of the procedure is based on the first field. For example, a second frequency associated with a second type of the procedure is based on the second field. At 3102, the reader may receive, from the wireless device and via the first frequency associated with the first type, a second message comprising an identifier of the wireless device.

Referring to FIG. 30 and FIG. 31, for example, the first message comprises the first frame in FIG. 22, in FIG. 23, in FIG. 25, in FIG. 27, and/or in FIG. 29.

Referring to FIG. 30 and FIG. 31, for example, the first message comprises a query command of the first frame in FIG. 22, in FIG. 23, in FIG. 25, in FIG. 27, and/or in FIG. 29. For example, the first message comprises Query 2401, Query 2409, and/or Query 2415 in FIG. 24.

Referring to FIG. 30 and FIG. 31, for example, the procedure comprises an inventory procedure described in the present disclosure.

Referring to FIG. 30 and FIG. 31, for example, the first type of the procedure comprises the first type inventory procedure. For example, the first type of the procedure comprises the second type inventory procedure. For example, the second type of the procedure comprises the first type inventory procedure. For example, the second type of the procedure comprises the second type inventory procedure

Referring to FIG. 30 and FIG. 31, for example, the first frequency associated with the first type of the procedure comprises a first D2R frequency (e.g., in FIG. 28). For example, the first frequency associated with the first type of the procedure comprises a second D2R frequency (e.g., in FIG. 28).

Referring to FIG. 30 and FIG. 31, for example, the second frequency associated with the second type of the procedure comprises a first D2R frequency (e.g., in FIG. 28). For example, the second frequency associated with the second type of the procedure comprises a second D2R frequency (e.g., in FIG. 28).

Referring to FIG. 30 and FIG. 31, for example, the second message comprises the second frame (e.g., Msg1) in FIG. 22, in FIG. 23, in FIG. 25, in FIG. 27, and/or in FIG. 29. For example, the second message comprises the second frame (e.g., MsgA) in FIG. 22, in FIG. 23, in FIG. 25, in FIG. 27, and/or in FIG. 29.

Referring to FIG. 30 and FIG. 31, for example, the second message comprises ID 2403, ID 2411, ID 2413, and/or ID 2417 in FIG. 24.

Referring to FIG. 30 and FIG. 31, for example, the second message comprises the fourth frame (e.g., Msg3) in FIG. 22, in FIG. 23, in FIG. 25, in FIG. 27, and/or in FIG. 29.

Referring to FIG. 30 and FIG. 31, for example, the second message comprises INF 2407 and/or INF 2421 in FIG. 24.

Referring to FIG. 30 and FIG. 31, for example, the identifier of the wireless device comprises a temporary ID of the wireless device.

Referring to FIG. 30 and FIG. 31, for example, the identifier of the wireless device comprises the second ID (e.g., described in the present disclosure) and/or a unique ID (e.g., TMSI, IMSI, IMEI, and/or the like) assigned to the fourth A-IoT device at the time of manufacturing, by a service provider and/or by a network entity.

In an example, a wireless device (e.g., A-IoT device) may receive, from a reader, a first message indicating: an initiation of a procedure to identify one or more wireless devices (e.g., A-IoT devices); and a first frequency associated with a first type of the procedure. For example, a second frequency associated with a second type of the procedure is based on the first frequency and a frequency offset. The wireless device may select, among the first type and the second type, the first type based on a received signal strength of the first message. The wireless device may transmit, via the first frequency associated with the selected first type, a second message comprising an identifier of the wireless device.

In an example, a wireless device (e.g., A-IoT device) may receive, from a first network node, one or more continuous wave signals for energy harvesting. The wireless device may receive, from a second network node, a first message initiating a (e.g., inventory) procedure to identify one or more wireless devices (e.g., A-IoT devices), wherein the procedure comprises a first type of the procedure and the second type of the procedure. The wireless device may select, among the first type and the second type, the first type based on an amount of available energy harvested from the one or more continuous wave (CW) signals. The wireless device may transmit, based on the selected first type, a second message comprising an identifier of the wireless device.

In an example, a wireless device (e.g., A-IoT device) may receive, from a reader, a first message initiating a (e.g., inventory) procedure to identify one or more wireless devices (e.g., A-IoT devices), wherein the first message comprises: a first field indicating whether the procedure is based on a first type or a second type; and a second field indicating a frequency for transmitting, a response to the first message, based on the type indicated by the first field. The wireless device may transmit, via the frequency, the response message based on the type indicated by the first field.

Either alone or in combination with any of the above or below features, for example, the first message comprises the first frame in FIG. 22, in FIG. 23, in FIG. 25, in FIG. 27, and/or in FIG. 29.

Either alone or in combination with any of the above or below features, for example, the first message comprises a query command of the first frame in FIG. 22, in FIG. 23, in FIG. 25, in FIG. 27, and/or in FIG. 29. For example, the first message comprises Query 2401, Query 2409, and/or Query 2415 in FIG. 24.

Either alone or in combination with any of the above or below features, for example, the procedure comprises an inventory procedure described in the present disclosure.

Either alone or in combination with any of the above or below features, for example, the first type of the procedure comprises the first type inventory procedure. For example, the first type of the procedure comprises the second type inventory procedure. For example, the second type of the procedure comprises the first type inventory procedure. For example, the second type of the procedure comprises the second type inventory procedure

Either alone or in combination with any of the above or below features, for example, the first frequency associated with the first type of the procedure comprises a first D2R frequency (e.g., in FIG. 28). For example, the first frequency associated with the first type of the procedure comprises a second D2R frequency (e.g., in FIG. 28).

Either alone or in combination with any of the above or below features, for example, the second frequency associated with the second type of the procedure comprises a first D2R frequency (e.g., in FIG. 28). For example, the second frequency associated with the second type of the procedure comprises a second D2R frequency (e.g., in FIG. 28).

Either alone or in combination with any of the above or below features, for example, the second message comprises the second frame (e.g., Msg1) in FIG. 22, in FIG. 23, in FIG. 25, in FIG. 27, and/or in FIG. 29. For example, the second message comprises the second frame (e.g., MsgA) in FIG. 22, in FIG. 23, in FIG. 25, in FIG. 27, and/or in FIG. 29.

Either alone or in combination with any of the above or below features, for example, the second message comprises ID 2403, ID 2411, ID 2413, and/or ID 2417 in FIG. 24.

Either alone or in combination with any of the above or below features, for example, the second message comprises the fourth frame (e.g., Msg3) in FIG. 22, in FIG. 23, in FIG. 25, in FIG. 27, and/or in FIG. 29.

Either alone or in combination with any of the above or below features, for example, the second message comprises INF 2407 and/or INF 2421 in FIG. 24.

Either alone or in combination with any of the above or below features, for example, the identifier of the wireless device comprises a temporary ID of the wireless device.

Either alone or in combination with any of the above or below features, for example, the identifier of the wireless device comprises the second ID (e.g., described in the present disclosure) and/or a unique ID (e.g., TMSI, IMSI, IMEI, and/or the like) assigned to the fourth A-IoT device at the time of manufacturing, by a service provider and/or by a network entity.

What is claimed is:

1. A wireless device comprising:
one or more processors; and
memory storing instructions that, when executed, cause the wireless device to:
receive, from a reader, a first message comprising one or more fields indicating:
a first frequency associated with a first type of inventory procedure; and
a second frequency associated with a second type of inventory procedure;
select, based on a received signal strength of the first message, the first type of inventory procedure among the first type of inventory procedure and the second type of inventory procedure; and
transmit, via the first frequency associated with the first type of inventory procedure, a second message comprising an identifier of the wireless device.

2. The wireless device of claim 1, wherein the first message further comprises one or more fields indicating an initiation of an inventory procedure.

3. The wireless device of claim 1, wherein the one or more fields indicates at least one of:
a first frequency offset; or
a second frequency offset.

4. The wireless device of claim 3, wherein:
the first frequency is based on the first frequency offset and a frequency that the first message is received; and
the second frequency is based on the second frequency offset and a frequency that the first message is received.

5. The wireless device of claim 1, wherein the first type of inventory procedure comprises a 2-step inventory procedure.

6. The wireless device of claim 5, where, in response to the first type of inventory procedure being the 2-step inventory procedure, the second message further comprises a random identifier.

7. The wireless device of claim 1, wherein the first type of inventory procedure comprises a 4-step inventory procedure.

8. The wireless device of claim 7, wherein the instructions further cause the wireless device to, in response to the first type of inventory procedure being the 4-step inventory procedure:
transmit a third message comprising a random identifier that the wireless device selects; and
receive a fourth message comprising the random identifier, wherein transmitting the second message is based on receiving the fourth message.

9. A method comprising:
receiving, by a wireless device from a reader, a first message comprising one or more fields indicating:
a first frequency associated with a first type of inventory procedure; and
a second frequency associated with a second type of inventory procedure;
selecting, based on a received signal strength of the first message, the first type of inventory procedure among the first type of inventory procedure and the second type of inventory procedure; and
transmitting, via the first frequency associated with the first type of inventory procedure, a second message comprising an identifier of the wireless device.

10. The method of claim 9, wherein the first message further comprises one or more fields indicating an initiation of an inventory procedure.

11. The method of claim 9, wherein the one or more fields indicates at least one of:
a first frequency offset; or
a second frequency offset.

12. The method of claim 11, wherein:
the first frequency is based on the first frequency offset and a frequency that the first message is received; and
the second frequency is based on the second frequency offset and a frequency that the first message is received.

13. The method of claim 9, wherein the first type of inventory procedure comprises a 2-step inventory procedure.

14. The method of claim 13, where, in response to the first type of inventory procedure being the 2-step inventory procedure, the second message further comprises a random identifier.

15. The method of claim 9, wherein the first type of inventory procedure comprises a 4-step inventory procedure.

16. The method of claim 15, in response to the first type of inventory procedure being the 4-step inventory procedure, further comprising:
transmitting a third message comprising a random identifier that the wireless device selects; and
receiving a fourth message comprising the random identifier, wherein the transmitting the second message is based on the receiving the fourth message.

17. A non-transitory computer-readable medium comprising instructions that, when executed by one or more processors of a wireless device, cause the wireless device to:
receive, from a reader, a first message comprising one or more fields indicating:
a first frequency associated with a first type of inventory procedure; and
a second frequency associated with a second type of inventory procedure;
select, based on a received signal strength of the first message, the first type of inventory procedure among the first type of inventory procedure and the second type of inventory procedure; and
transmit, via the first frequency associated with the first type of inventory procedure, a second message comprising an identifier of the wireless device.

18. The non-transitory computer-readable medium of claim 17, wherein the first message further comprises one or more fields indicating an initiation of an inventory procedure.

19. The non-transitory computer-readable medium of claim 17, wherein the one or more fields indicates at least one of:
a first frequency offset, or
a second frequency offset.

20. The non-transitory computer-readable medium of claim 19, wherein:
the first frequency is based on the first frequency offset and a frequency that the first message is received; and
the second frequency is based on the second frequency offset and a frequency that the first message is received.
